(19) United States
(12) Patent Application Publication
(10) Pub. No.: US 2025/0313443 A1
(43) Pub. Date: Oct. 9, 2025

(54) LIFT DEVICE WITH DISCONNECT INTERFACE

(71) Applicant: Oshkosh Corporation, Oshkosh, WI (US)

(72) Inventor: Devin Rosencrance, Oshkosh, WI (US)

(21) Appl. No.: 19/087,402

(22) Filed: Mar. 21, 2025

Related U.S. Application Data
(60) Provisional application No. 63/574,574, filed on Apr. 4, 2024.
(60) Provisional application No. 63/712,790, filed on Oct. 28, 2024.
(60) Provisional application No. 63/712,871, filed on Oct. 28, 2024.
(60) Provisional application No. 63/712,765, filed on Oct. 28, 2024.
(60) Provisional application No. 63/713,018, filed on Oct. 28, 2024.
(60) Provisional application No. 63/713,016, filed on Oct. 28, 2024.
(60) Provisional application No. 63/741,596, filed on Jan. 3, 2025.

(51) Int. Cl. B66F 17/00; B60P 1/34; B66F 9/075

(52) U.S. Cl. CPC B66F 17/00; B66F 9/0755; B66F 17/003; B66F 17/006; B60P 1/34

(57) ABSTRACT

A lift device includes a chassis, an implement interface configured to be removably coupled to an implement, and a lift assembly coupled to the chassis and the implement interface. The lift assembly is configured to raise the implement interface relative to the chassis. The lift device includes an implement sensor coupled to the implement interface and configured to detect whether the implement is coupled to the implement interface. The lift device includes a controller operatively coupled to the lift assembly and the implement sensor. The controller is configured to adjust operation of the lift device in response to the implement sensor detecting that the implement is coupled to the implement interface.

### CROSS-REFERENCE TO RELATED PATENT APPLICATION

This application claims the benefit of and priority to (a) U.S. Provisional Patent Application 63/712,790, filed on Oct. 28, 2024, (b) U.S. Provisional Patent Application 63/712,871, filed on Oct. 28, 2024, (c) U.S. Provisional Patent Application 63/713,016, filed on Oct. 28, 2024, (d) U.S. Provisional Patent Application 63/713,018, filed on Oct. 28, 2024, (e) U.S. Provisional Patent Application 63/741,596, filed on Jan. 3, 2025, (f) U.S. Provisional Patent Application 63/574,574, filed on Apr. 4, 2024, and (g) U.S. Provisional Patent Application 63/712,765, filed on Oct. 28, 2024, each of which is incorporated herein by reference in its entirety.

### BACKGROUND

The present disclosure relates generally to vehicles and/or work machines. More specifically, the present disclosure relates to vehicles that may be utilized at a jobsite or vocational vehicles. The present disclosure also relates to a fork alignment system for work machines.

Vehicles are utilized to transport personnel and equipment between different areas. Vehicles may utilize a drivetrain that consumes power from an onboard energy storage device to operate one or more tractive elements to propel the vehicle. The vehicles may include one or more sensors that facilitate navigation or other operation of the vehicles.

Lift devices include a lift assembly that raises a load above the ground. The lift device may raise the load by inserting a lift fork into the load. An alignment system may position the lift fork near a desired area of the load.

### SUMMARY

At least one embodiment relates to a lift device. The lift device includes a chassis, an implement interface configured to be removably coupled to an implement, and a lift assembly coupled to the chassis and the implement interface. The lift assembly is configured to raise the implement interface relative to the chassis. The lift device includes an implement sensor coupled to the implement interface and configured to detect whether the implement is coupled to the implement interface. The lift device includes a controller operatively coupled to the lift assembly and the implement sensor. The controller is configured to adjust operation of the lift device in response to the implement sensor detecting that the implement is coupled to the implement interface.

Another embodiment relates to an implement interface for a lift device. The implement interface includes an implement sensor configured to detect whether an implement is coupled to the implement interface or a type of the implement coupled to the implement interface. The implement interface includes an alignment member configured to limit movement of the implement relative to the implement interface and a lock assembly configured to selectively fixedly couple the implement to the implement interface.

Another embodiment relates to a lift device. The lift device includes a chassis, an implement interface configured to be removably coupled to an implement, a lift assembly coupled to the chassis and the implement interface. The lift assembly is configured to raise the implement interface relative to the chassis. The lift device includes a plurality of implement sensors coupled to the implement interface and configured to detect at least one of whether the implement is coupled to the implement interface or a type of implement coupled to the implement interface. The implement interface includes a controller operatively coupled to the lift assembly and the plurality of implement sensors. The controller is configured to adjust operation of the lift device in response to the implement sensors.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a block diagram of a lift device, according to an exemplary embodiment.

FIG. 2 is a perspective view of the lift device of FIG. 1 configured as a boom lift, according to an exemplary embodiment.

FIG. 3 is a side view of an implement assembly and an implement interface of the lift device of FIG. 1, according to an exemplary embodiment.

FIG. 4 is a front view of the implement interface of FIG. 3.

FIG. 5 is a rear view of the implement assembly of FIG. 3.

FIG. 6 is a block diagram of a method of operating a lift device, according to an exemplary embodiment.

FIG. 7 is a side view of operating ranges of the lift device of FIG. 1.

FIG. 8 is a block diagram of a method of operating a lift device, according to an exemplary embodiment.

FIG. 9 is a block diagram of a command system of the lift device of FIG. 1, according to an exemplary embodiment.

FIG. 10 is a block diagram of a process of visual indication for the lift device of FIG. 3, according to an exemplary embodiment.

FIG. 11 is a diagram of a method of operating a semi-autonomous work machine, according to an exemplary embodiment.

FIG. 12 is a block diagram of a lift device, according to an exemplary embodiment.

FIG. 13 is a side view of a base assembly of the lift device of FIG. 1, according to an exemplary embodiment.

FIG. 14 is a top view of a base assembly of the lift device of FIG. 1, according to another exemplary embodiment.

FIG. 15 is a side view of a base assembly of the lift device of FIG. 1, according to another exemplary embodiment.

FIG. 16 is a perspective view of the lift device of FIG. 1 configured as a scissor lift, according to an exemplary embodiment.

FIG. 17 is a side view of the lift device of FIG. 1 configured as a vertical mast lift, according to an exemplary embodiment.

FIG. 18 is a side view of the lift device of FIG. 1 including a robotic arm, according to an exemplary embodiment.

FIG. 19 is a side view of the lift device of FIG. 1, according to an exemplary embodiment.

FIG. 20 is a front view of the lift device of FIG. 1 in a transport configuration, according to an exemplary embodiment.

FIG. 21 is a side view of the lift device of FIG. 16.

FIG. 22 is a side view of the lift device of FIG. 16 including a trailer, according to an exemplary embodiment.

FIG. 23 is a front view of the lift device of FIG. 1 configured as a personnel lift, according to an exemplary embodiment.

FIG. 24 is a perspective view of the lift device of FIG. 1 including a robotic arm, according to an exemplary embodiment.

FIG. 25 is a perspective view of the robotic arm of FIG. 24.

FIG. 26 is a perspective view of a lift device, according to an exemplary embodiment.

FIG. 27 is a perspective view of an implement that is coupled to the lift device of FIG. 26, according to an exemplary embodiment.

FIG. 28 is a perspective view of an implement interface for the lift device of FIG. 26, according to an exemplary embodiment.

FIG. 29 is a block diagram of a control system that is used to operate the lift device of FIG. 1, according to an exemplary embodiment.

FIG. 30 is a flow diagram of a process for operating the lift device of FIG. 26, according to an exemplary embodiment.

FIG. 31 is a perspective view of the lift device of FIG. 26, according to an exemplary embodiment.

FIG. 32 is a perspective view of the lift device of FIG. 26, according to an exemplary embodiment.

FIG. 33 is a perspective view of the lift device of FIG. 26, according to an exemplary embodiment.

FIG. 34 is a perspective view of an implement that is coupled to the lift device of FIG. 26, according to an exemplary embodiment.

FIG. 35 is a perspective view of the lift device of FIG. 26, according to an exemplary embodiment.

FIG. 36 is a perspective view of an implement that is coupled to the lift device of FIG. 1, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overview

Referring generally to the figures, a lift device includes a base assembly, a lift assembly, an implement interface, and an implement assembly. The implement interface facilitates removably coupling the implement assembly to the lift assembly. The implement interface permits communication of data, electrical energy, and pressurized fluids between the base assembly and the implement assembly. The implement interface may have a universal layout, such that different implement assemblies for different applications (e.g., painting, pressure washing, welding, drywall finishing, etc.) may each be connected to the lift device through a common implement interface.

The implement assembly may include an implement controller that controls motion of an implement, and the base assembly may include a base controller that controls operation of the base assembly and the lift assembly. Throughout operation, the implement controller may control movement of the implement as required to complete a desired task. If the implement controller is unable to move the implement to a desired position without operating the lift assembly and/or the base assembly, the implement controller may indicate a desired path for the implement interface to the base controller. The base controller 40 may translate the desired path into specific actions of the base assembly and/or the lift assembly to reposition the implement interface. This control method greatly simplifies the process of controlling the lift device relative to a system where one controller is required determine how to control each actuator of a lift device individually. An organization that manufactures implement assemblies may utilize a lift device with minimal development devoted toward the lift assembly or the base assembly, freeing up resources to focus on developing an implement assembly for a specific application (e.g., paint spraying, sand blasting, welding, drywall finishing, etc.).

### Lift Device

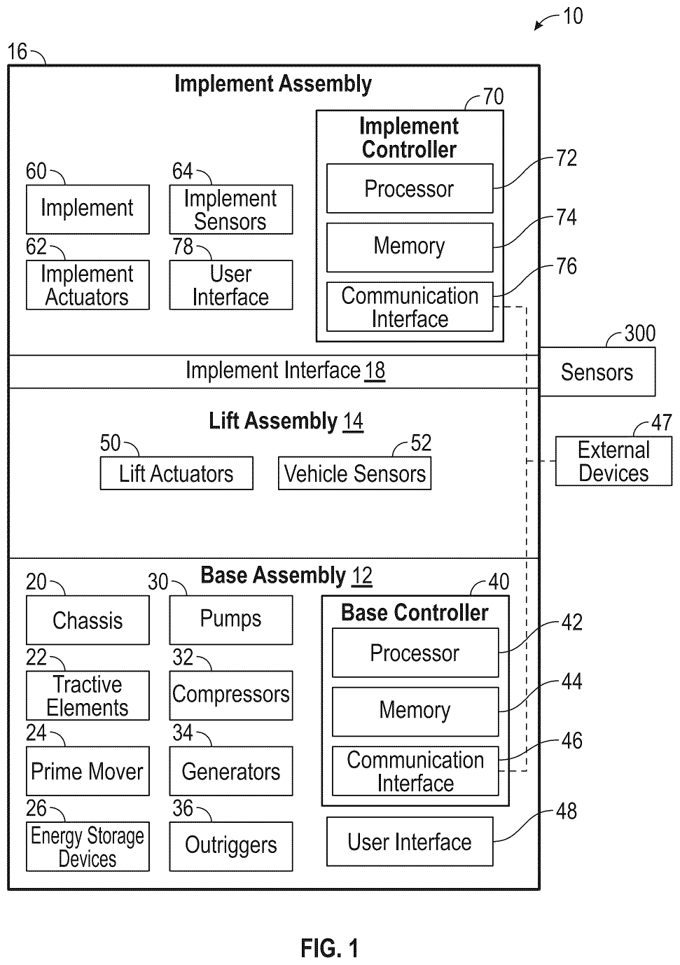

Referring to FIG. 1, a vehicle, work machine, lifting apparatus, or lift device is shown as lift device 10 according to an exemplary embodiment. By way of example, the lift device may be or include a mobile elevating work platform (MEWP), a telehandler, a boom lift, a vertical lift, a scissor lift, a firetruck, or any other type of machine capable of moving (e.g., lifting) material or people to a desired position. The lift device 10 may be human operated, partially autonomous, or completely autonomous.

As shown, the lift device 10 includes a base assembly 12 (e.g., a base, a support assembly, a drivable support assembly, a support structure, a chassis, etc.), a lift assembly 14 (e.g., a boom, a boom lift assembly, a lifting apparatus, an articulated arm, a scissor lift, a ladder, a telescoping assembly, etc.), and an end effector assembly or implement assembly 16 (e.g., a tool, a manipulator, a platform, etc.). A coupler or end effector interface, shown as implement interface 18, couples the implement assembly 16 to the lift assembly 14.

The base assembly 12 is configured to support the other components of the lift device 10 and propel the lift device 10 on the ground. The lift assembly 14 is configured to move (e.g., lift, translate, pivot, rotate, etc.) the implement interface 18 and the corresponding implement assembly 16 relative to the base assembly 12. The implement assembly 16 is configured to perform one or more tasks (e.g., moving material, manipulating material by welding, cutting, etc., supporting one or more operators, etc.).

As shown in FIG. 1, the base assembly 12 includes a frame or chassis, shown as chassis 20, that supports the other components of the base assembly 12. A series of tractive elements (e.g., wheels, tracks, etc.), shown as tractive elements 22, are coupled to the chassis 20. The tractive elements 22 engage a support surface (e.g., the ground) to support the lift device 10. One or more actuators, shown as prime mover 24, are configured to drive the tractive elements 22 to steer and/or propel the lift device 10. By way of example, the prime mover 24 may be or include an electric motor and/or an internal combustion engine (e.g., a gasoline or diesel engine) that receives stored energy and provides rotational mechanical energy to operate various functions of the lift device 10. The base assembly 12 further includes one or more energy storage devices 26 coupled to the chassis 20. The energy storage devices 26 may include batteries, capacitors, fuel tanks, fuel cells, and/or other energy storage devices. The energy storage devices 26 are configured to store energy (e.g., chemically) and provide the stored energy to the prime mover 24 and/or other components of the lift device 10.

Referring still to FIG. 1, the base assembly 12 includes one or more pumps 30, compressors 32, and/or generators 34 coupled to the chassis 20. The pumps 30 may receive rotational mechanical energy (e.g., from the prime mover 24) and provide a supply of pressurized liquid (e.g., hydraulic oil, water, etc.). The compressors 32 may receive rotational mechanical energy (e.g., from the prime mover 24) and provide a supply of pressurized gas (e.g., air, refrigerant, etc.). The generators 34 may receive rotational mechanical energy (e.g., from the prime mover 24) and provide a supply of electrical energy (e.g., to be stored in an energy storage device 26). The pressurized liquid, the pressurized gas, and/or the electrical energy may be supplied to various components of the lift device 10 to facilitate operation of the lift device 10.

The base assembly 12 further includes one or more deployable supports (e.g., outriggers, downriggers, etc.), shown as outriggers 36, coupled to the chassis 20. The outriggers 36 may be selectively repositionable between a stored position and a deployed position. In the stored position, the outriggers 36 are retracted toward the chassis 20 and away from a support surface (e.g., the ground). In the deployed position, the outriggers 36 extend outward and engage the support surface and support the base assembly 12. The outriggers 36 may be used to level the chassis 20 and/or increase the stability of the vehicle (e.g., when the lift assembly 14 is extended).

The base assembly 12 further includes a control circuit or processing circuit, shown as base controller 40, coupled to the chassis 20. The base controller 40 is operatively coupled to (e.g., in communication with) components of the base assembly 12 and the lift assembly 14. The base controller 40 may control operation of the components of the base assembly 12 and the lift assembly 14 directly. The base controller 40 may control operation of the implement assembly 16 indirectly (e.g., through the implement controller 70). Alternatively, the implement controller 70 may be omitted, and the base controller 40 may control operation of the entire lift device 10. The base controller 40 includes a processor 42 and a memory device, shown as memory 44. The memory 44 is configured to store instructions thereon that, when executed by the processor 42, cause the base controller 40 to perform the various functions described herein.

The base controller 40 further includes a network interface, shown as communication interface 46. The communication interface 46 is configured to send and receive information (e.g., data, commands, signals, etc.). The communication interface 46 may communicated through a wired connection (e.g., a CAN bus, an ethernet connection, etc.) and/or wirelessly (e.g., using Bluetooth, radio, Wi-Fi, cellular networks, etc.). The communication interface 46 may communicate with the other components of the lift device 10.

The communication interface 46 may communicate with components outside of the lift device 10, shown as external devices 47. By way of example, the communication interface 46 may facilitate wireless communication with the external devices 47 (e.g., direct wireless communication, communication over a cellular network, communication over a wide area network (e.g., the Internet, etc.). The external devices 47 may include user devices such as smartphones or laptops, servers, or other devices. By way of example, the external devices 47 may include one or more devices that operate a vehicle telematics platform that collects, analyzes, and transmits data from multiple lift devices 10 and/or other work machines.

The base assembly 12 further includes an input/output device, shown as user interface 48, coupled to the chassis 20 and operatively coupled to the base controller 40. The user interface 48 may be positioned to be accessible by a user positioned on the ground and/or on the base assembly 12. The user interface 48 may be configured to receive information (e.g., commands) from the user. By way of example, the user interface may include touch screens, buttons, switches, knobs, or other input devices. The user interface 48 may be configured to provide information (e.g., status information) to the user. By way of example, the user interface may include displays, lights, speakers, or other output devices.

The lift assembly 14 includes one or more actuators, shown as lift actuators 50. The lift actuators 50 are configured to apply mechanical energy (e.g., a force, a torque, etc.) to raise, lower, translate, or otherwise control the lift assembly 14 to move the implement interface 18. By way of example, lift actuators 50 may include hydraulic actuators (e.g., hydraulic motors, hydraulic cylinders, etc.), pneumatic actuators (e.g., pneumatic motors, pneumatic cylinders, etc.), electric actuators (e.g., electric motors, electric linear actuators, etc.), or other types of actuators. The lift actuators 50 may be powered by the pumps 30, the compressors 32, the generators 34, the energy storage devices 26, and/or other energy sources. Operation of the lift actuators 50 may be controlled by the base controller 40.

The lift assembly 14 further includes one or more sensors, shown as vehicle sensors 52. Although shown as part of the lift assembly 14, the vehicle sensors 52 may be positioned anywhere throughout the lift device 10. The vehicle sensors 52 may provide sensor data indicating the position of the base assembly 12, the lift assembly 14, and/or the implement interface 18 relative to other components of the lift device 10 (e.g., the lift assembly 14 relative to the base assembly 12) and/or the surrounding environment. By way of example, the vehicle sensors 52 may include LIDAR sensors, ultrasonic sensors, contact sensors (e.g., limit switches), potentiometers, optical encoders, or other types of sensors. The sensor data from the vehicle sensors 52 may be used to facilitate closed-loop control over the position of the lift device 10.

The implement interface 18 is configured to couple the implement assembly 16 to the lift assembly 14. In some embodiments, the implement interface 18 removably couples the implement assembly 16 to the lift assembly 14. In other embodiments, the implement interface 18 permanently couples the implement assembly 16 to the lift assembly 14. The implement interface 18 may fixedly couple the implement assembly 16 to a distal end portion of the lift assembly 14. The implement interface 18 may pass data (e.g., electrical signals), electrical energy, hydraulic fluid, compressed gas, or other signals between (a) the base assembly 12 and the lift assembly 14 and (b) the implement assembly 16 to power or control the implement assembly 16. Similarly, the implement interface 18 may pass signals from the implement assembly 16 to the base assembly 12 and/or the lift assembly 14 to control the base assembly 12 and/or the lift assembly 14.

Referring still to FIG. 1, the implement assembly 16 includes a tool, manipulator, or platform, shown as implement 60. The implement 60 may be configured to perform a desired task. In some embodiments, the implement 60 includes a tool that facilitates moving an object. By way of example, the implement 60 may include robotic arms, lift forks, buckets, hooks, suction cups, claws, or other manipulators. In some embodiments, the implement 60 includes a tool that performs a task other than moving material. By way of example, the implement 60 may include pressure washers, spray nozzles, sand blasters, air guns, paint guns, tape guns, welders, applicators for drywall compound, lights, or other tools. In some embodiments, the implement 60 includes an inspection tool. By way of example, the implement 60 may include cameras, temperature sensors, multimeters, contact probes that measure the profile of a surface, or other inspection tools. In some embodiments, the implement includes a work platform (e.g., a basket, an operator platform) that is configured to support one or more operators.

The implement assembly 16 further includes one or more actuators, shown as implement actuators 62, coupled to the implement 60. The implement actuators 62 are configured to reposition (e.g., translate, rotate, raise, lower, etc.) or otherwise move the implement 60 relative to the implement interface 18. By way of example, the implement actuators 62 may include hydraulic actuators, pneumatic actuators, electric actuators, or other types of actuators.

The implement assembly 16 further includes one or more sensors, shown as implement sensors 64. The implement sensors 64 may provide sensor data indicating the position of the implement 60 relative to other components of the lift device 10 (e.g., the implement interface 18) and/or the surrounding environment. By way of example, the implement sensors 64 may include LIDAR sensors, ultrasonic sensors, contact sensors (e.g., limit switches), potentiometers, optical encoders, or other types of sensors. The sensor data from the implement sensors 64 may be used to facilitate closed-loop control over the position of the implement 60.

The implement assembly 16 further includes a control circuit or processing circuit, shown as implement controller 70, coupled to the implement interface 18. The implement controller 70 is operatively coupled to (e.g., in communication with) with the implement 60, the implement actuators 62, and the implement sensors 64. The implement controller 70 may control operation of the components of the implement assembly 16 directly. The implement controller 70 may control operation of the base assembly 12 and the lift assembly 14 indirectly (e.g., through the base controller 40). The implement controller 70 includes a processor 72 and a memory device, shown as memory 74. The memory 74 is configured to store instructions thereon that, when executed by the processor 72, cause the implement controller 70 to perform the various functions described herein.

The implement controller 70 further includes a communication interface 76. The communication interface 76 may be substantially similar to the communication interface 46, except as otherwise specified herein. The communication interface 76 may communicate with the communication interface 46 of the base controller 40 and/or the external devices 47.

The implement assembly 16 further includes an input/output device, shown as user interface 78, coupled to the implement interface 18 and operatively coupled to the implement controller 70. The user interface 78 may be positioned to be accessible by a user positioned on the implement 60 (e.g., on a platform of the implement 60). The user interface 78 may perform similar functions to the user interface 48.

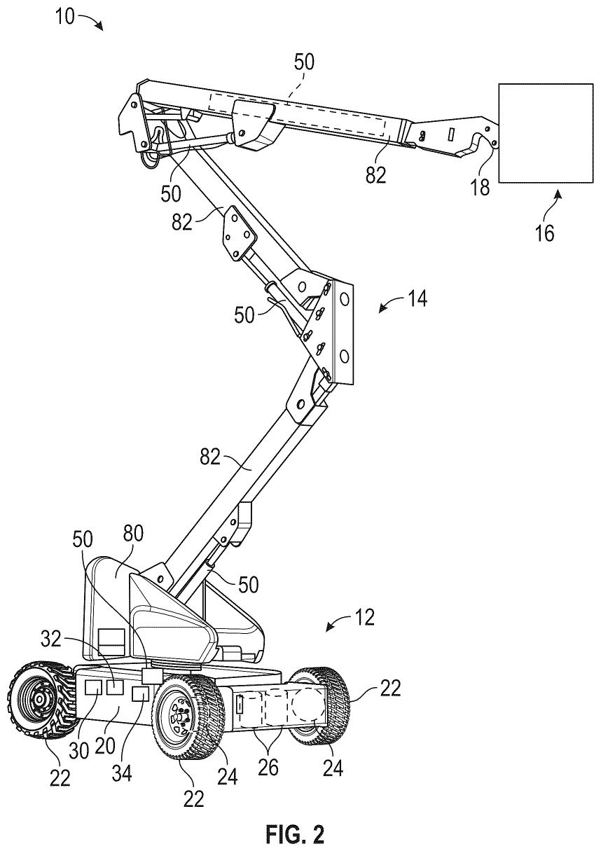

Referring to FIG. 2, the lift device 10 is shown implemented as a boom lift, according to an exemplary embodiment. As shown in FIG. 2, the lift assembly 14 of the lift device 10 includes a rotating portion, shown as turntable 80, and a series of movable portions or boom members, shown as boom sections 82. The turntable 80 is rotatably coupled to the chassis 20. A first lift actuator 50 (e.g., a turntable actuator) is configured to cause the turntable 80 to rotate relative to the chassis 20 about a substantially vertical axis. The boom sections 82 extend between the turntable 80 and the implement interface 18. A first boom section 82 is pivotally coupled to the turntable 80, and one of the lift actuators 50 causes the first boom section 82 to rotate relative to the turntable 80. A second boom section 82 is coupled to the implement interface 18. The other boom sections 82 extend between the first and second boom sections 82. The lift actuators 50 cause the boom sections 82 to rotate and/or translate (e.g., telescope) relative to one another to reposition the implement interface 18 relative to the turntable 80.

### Implement Interface

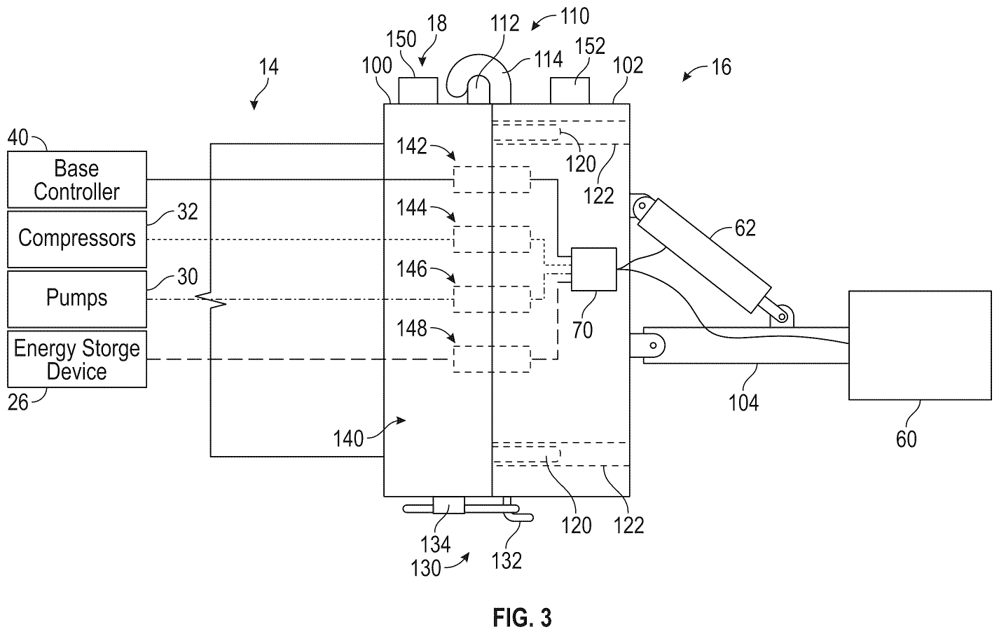

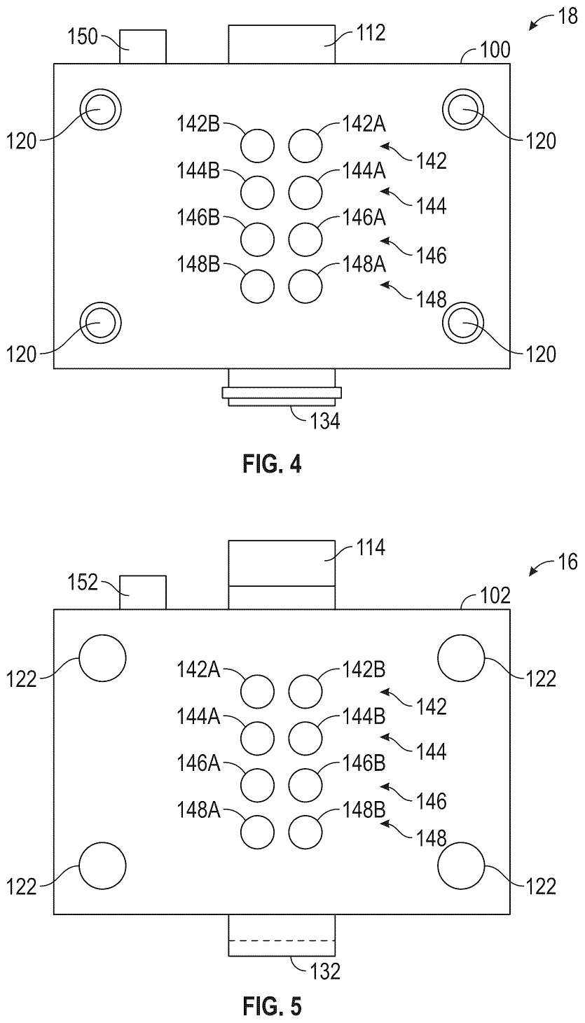

Referring to FIGS. 3-5, the implement assembly 16 and the implement interface 18 are shown according to an exemplary embodiment. Specifically, FIG. 3 illustrates the implement assembly 16 assembled with the implement interface 18, FIG. 4 illustrates a portion of the implement interface 18 that engages the implement assembly 16, and FIG. 5 illustrates a portion of the implement assembly 16 that engages the implement interface 18. The implement interface 18 and the implement assembly 16 include various structures and components that facilitate removably coupling the implement assembly 16 to the lift device 10 and permitting transfer of electrical energy (e.g., power), data (e.g., sensor data, commands, etc.), and fluid to and from the implement assembly 16.

The implement interface 18 includes a structure, chassis, frame, fixture, or mount, shown as mounting plate 100. The mounting plate 100 is coupled to a distal end of the lift assembly 14. The mounting plate 100 may serve as a primary structure to support other components of the implement interface 18. Similarly, the implement assembly 16 includes a structure, chassis, frame, fixture, or mount, shown as mounting plate 102. Various components of the implement assembly 16 may be coupled to the mounting plate 102, such that the mounting plate 102 serves as a base of the implement assembly 16. When the implement assembly 16 is coupled to the implement interface 18, the mounting plate 102 may abut (e.g., extend substantially parallel to) the mounting plate 102.

As shown, the mounting plate 100 and the mounting plate 102 extend in generally vertical planes. The lift assembly 14 extends substantially perpendicular to the mounting plate 100 in a rearward direction. The implement assembly 16 extends substantially perpendicular to the mounting plate 102 in a forward direction. In other configurations and/or other embodiments, the mounting plate 100 and/or the mounting plate 102 are otherwise arranged. By way of example, the orientation of the mounting plate 100 may be varied by the lift assembly 14 throughout operation (e.g., as controlled by the base controller 70 using the lift actuators 50).

The implement 60 is movably coupled to mounting plate 102 by a fixture or coupler, shown as implement arm 104. As shown, the implement arm 104 pivotally couples the implement 60 to the mounting plate 102. In other embodiments, the implement arm 104 otherwise movably couples the implement 60 to the mounting plate 102. An implement actuator 62 is coupled (e.g., pivotally coupled) to the mounting plate 102 and the implement arm 104 and configured to control movement of the implement 60 and the implement arm 104 relative to the mounting plate 102.

As shown, the implement controller 70 is coupled to the mounting plate 102. The implement controller 70 may be fixedly coupled to the mounting plate 102, such that the implement controller 70 is movable with the mounting plate 102 (e.g., when the implement assembly 16 is removed from the implement interface 18).

The implement assembly 16 and the implement interface 18 further include a coupler, mount, or hanger assembly, shown as hook assembly 110. The hook assembly 110 includes a first engagement element or protrusion, shown as hook seat 112, and a second engagement element or receiver, shown as hook 114. As shown, the hook seat 112 is fixedly coupled to the mounting plate 100, and the hook 114 is fixedly coupled to the mounting plate 102. When the implement assembly 16 coupled to the implement interface 18, the hook 114 engages the hook seat 112 to support the implement assembly 16. Specifically, the hook seat 112 is received within the hook 114 to limit both (a) downward movement of the mounting plate 102 relative to the mounting plate 100 and (b) longitudinal movement of the mounting plate 102 away from the mounting plate 100. Accordingly, the hook assembly 110 facilitates coupling the implement assembly 16 to the implement interface 18 and supporting (e.g., hanging) the implement assembly 16 with the implement interface 18.

As shown in FIGS. 3-5, the implement interface 18 includes a series of slides, protrusions, or alignment members, shown as alignment rods 120. The alignment rods 120 are fixedly coupled to the mounting plate 100 and spaced vertically and/or laterally from one another in a rectangular pattern. As shown, an alignment rod 120 is positioned near each corner of the mounting plate 100. The alignment rods 120 extend substantially perpendicular to the mounting plate 100 and substantially parallel to one another. In some embodiments, the distal ends of the alignment rods 120 are chamfered, radiused, or otherwise tapered to facilitate insertion.

The mounting plate 102 of the implement assembly 16 defines a series of apertures, passages, or recesses, shown as alignment passages 122. The alignment passages 122 extend into the mounting plate 102 from a face of the mounting plate 102 that faces the mounting plate 102. The alignment passages 122 may extend partway through the mounting plate 102 (e.g., may be blind holes) or completely through the mounting plate 102 (e.g., may be through holes). The alignment passages 122 are laid out in a similar pattern to the alignment rods 120, such that the alignment rods 120 each align with a corresponding alignment passage 122 when the mounting plate 102 faces the mounting plate 100. In other embodiments, one or more of the alignment rods 120 are coupled to the mounting plate 102, and the mounting plate 100 defines one or more of the alignment passages 122.

When the implement assembly 16 is assembled with the implement interface 18, the alignment rods 120 extend into the alignment passages 122. The alignment rods 120 engage the walls of the alignment passages 122 to limit movement of the mounting plate 102 relative to the mounting plate 102. Specifically, the alignment rods 120 limit lateral and vertical movement of the mounting plate 102 relative to the mounting plate 100. Accordingly, the alignment rods 120 facilitate coupling the implement assembly 16 to the implement interface 18 and supporting (e.g., hanging) the implement assembly 16 with the implement interface 18.

The implement assembly 16 and the implement interface 18 further include a coupler, mount, or lock assembly, shown as latch assembly 130. The latch assembly 130 includes a first engagement element or protrusion, shown as catch 132, and a second engagement element or receiver, shown as latch 134. As shown, the catch 132 is fixedly coupled to the mounting plate 102, and the latch 134 is fixedly coupled to the mounting plate 100. In other embodiments, the catch 132 is fixedly coupled to the mounting plate 100, and the latch 134 is fixedly coupled to the mounting plate 102. In some embodiments, the latch assembly 130 or the alignment rods 120 are omitted.

The latch 134 is configured to engage the catch 132 to selectively limit longitudinal movement of the mounting plate 102 away from the mounting plate 100. The latch 134 is selectively reconfigurable between a latched or locked configuration and an unlatched or unlocked configuration. In the unlocked configuration, the latch 134 is movable, permitting movement of the catch 132 away from the mounting plate 100. In the unlocked configuration, the latch 134 is tightened, limiting (e.g., preventing) movement of the catch 132 away from the mounting plate 100. By way of example, the latch 134 may hold the mounting plate 102 firmly against the mounting plate 100.

In some embodiments, the latch 134 is controlled by the implement controller 70. By way of example, the latch 134 may include an electric actuator (e.g., a solenoid) and/or a hydraulic actuator (e.g., a hydraulic cylinder) that reconfigures the latch 134 between the locked configuration and the unlocked configuration. In some embodiments, the latch 134 is manually operated. By way of example, an operator may manually configure the latch 134 into the unlocked configuration or the locked configuration by moving a lever of the latch 134.

Referring still to FIGS. 3-5, the implement assembly 16 and the implement interface 18 further include a series of fluid, electrical, and data connections, shown as connector assembly 140. A first portion of the connector assembly 140 is coupled to the mounting plate 100, and a second portion of the connector assembly 140 is coupled to the mounting plate 102. When the implement assembly 16 is assembled with the implement interface 18, the first and second portions of the connector assembly 140 engage one another to transfer signals (e.g., data, pressurized fluid such as gas or liquid, electrical signals, etc.) and communicatively couple the implement assembly 16 with the implement interface 18. When the implement assembly 16 is removed from the implement interface 18, the first and second portions of the connector assembly 140 separate from one another to disconnect the implement assembly 16 from the base assembly 12.

The connector assembly 140 includes a first series of signal connectors, shown as data connectors 142. As shown, the data connectors 142 include a pair of supply connectors 142A and a pair of return connectors 142B. A first supply connector 142A and return connector 142B are coupled to the mounting plate 100 and communicatively (e.g., electrically) coupled to the base controller 40. A second supply connector 142A and return connector 142B are coupled to the mounting plate 102 and communicatively (e.g., electrically) coupled to the implement controller 70. The data connectors 142 are positioned such that the supply connectors 142A engage one another and the return connectors 142B engage one another when the implement assembly 16 is coupled with the implement interface 18, forming a closed circuit between the base controller 40 and the implement controller 70. Accordingly, the data connectors 142 facilitate the transfer of information (e.g., data, electrical signals, etc.) between the base controller 40 and the implement controller 70. In other embodiments, the connector assembly 140 includes more or fewer data connectors 142.

The connector assembly 140 includes a second series of signal connectors, shown as gas connectors 144. As shown, the gas connectors 144 include a pair of supply connectors 144A and a pair of return connectors 144B. A first supply connector 144A and return connector 144B are coupled to the mounting plate 100 and communicatively (e.g., fluidly) coupled to one the base assembly 12 (e.g., to the compressors 32). A second supply connector 144A and return connector 144B are coupled to the mounting plate 102 and communicatively (e.g., fluidly) coupled to the implement controller 70. The implement controller 70 may deliver compressed gas from the supply connector 144A to the implement 60 and/or the implement actuator 62. The implement controller 70 may return compressed gas from the implement 60 and/or the implement actuator 62 to the base assembly 12 through the return connectors 144B. Alternatively, the implement controller 70 may permit compressed gas to vent directly to the surrounding atmosphere.

The gas connectors 144 are positioned such that the supply connectors 144A engage one another and the return connectors 144B engage one another when the implement assembly 16 is coupled with the implement interface 18, forming fluid-tight connections between the base assembly 12 and the implement controller 70. Accordingly, the gas connectors 144 facilitate the transfer of compressed gas (e.g., air, nitrogen, etc.) between the base assembly 12 and the implement controller 70. When the mounting plate 100 and the mounting plate 102 separate from one another, the gas connectors 144 may disconnect from one another and disrupt the flow of gas. In some embodiments, the gas connectors 144 are quick disconnect connectors including check valves that automatically close when the gas connectors 144 are disconnected to prevent leakage of gas. In other embodiments, the connector assembly 140 includes more or fewer gas connectors 144.

The connector assembly 140 includes a third series of signal connectors, shown as liquid connectors 146. As shown, the liquid connectors 146 include a pair of supply connectors 146A and a pair of return connectors 146B. A first supply connector 146A and return connector 146B are coupled to the mounting plate 100 and communicatively (e.g., fluidly) coupled to one the base assembly 12 (e.g., to the pumps 30). A second supply connector 146A and return connector 146B are coupled to the mounting plate 102 and communicatively (e.g., fluidly) coupled to the implement controller 70. The implement controller 70 may deliver pressurized liquid from the supply connector 146A to the implement 60 and/or the implement actuator 62. The implement controller 70 may return liquid from the implement 60 and/or the implement actuator 62 to the base assembly 12 through the return connectors 146B.

The liquid connectors 146 are positioned such that the supply connectors 146A engage one another and the return connectors 146B engage one another when the implement assembly 16 is coupled with the implement interface 18, forming fluid-tight connections between the base assembly 12 and the implement controller 70. Accordingly, the liquid connectors 146 facilitate the transfer of pressurized liquid (e.g., hydraulic oil, water, etc.) between the base assembly 12 and the implement controller 70. When the mounting plate 100 and the mounting plate 102 separate from one another, the liquid connectors 146 may disconnect from one another and disrupt the flow of liquid. In some embodiments, the liquid connectors 146 are quick disconnect connectors including check valves that automatically close when the liquid connectors 146 are disconnected to prevent leakage of liquid. In other embodiments, the connector assembly 140 includes more or fewer liquid connectors 146.

The connector assembly 140 includes a fourth series of signal connectors, shown as power connectors 148. As shown, the power connectors 148 include a pair of supply connectors 148A and a pair of return connectors 148B. A first supply connector 148A and return connector 148B are coupled to the mounting plate 100 and communicatively (e.g., electrically) coupled to the generators 34 and/or the energy storage devices 26. A second supply connector 148A and return connector 148B are coupled to the mounting plate 102 and communicatively (e.g., electrically) coupled to the implement controller 70. The power connectors 148 are positioned such that the supply connectors 148A engage one another and the return connectors 148B engage one another when the implement assembly 16 is coupled with the implement interface 18, forming a closed circuit between the base assembly and the implement controller 70. Accordingly, the power connectors 148 facilitate the transfer of electrical energy (e.g., AC power, DC power, etc.) between the base assembly 12 and the implement controller 70. The implement controller 70 may then direct the electrical energy to the implement 60 and/or the implement actuator 62 to power operation of the implement assembly 16. In other embodiments, the electrical energy bypasses the implement controller 70 and passes directly to the implement 60 and/or the implement actuator 62. In other embodiments, the connector assembly 140 includes more or fewer power connectors 148.

Referring still to FIGS. 3-5, the lift assembly 14 includes a sensor (e.g., an implement sensor, an implement locator, etc.), shown as implement sensor 150. As shown, the implement sensor 150 is coupled to the mounting plate 100 and operatively coupled to the base controller 40. The implement sensor 150 is configured to provide sensor data regarding the implement assembly 16. The base controller 40 may utilize the sensor data to determine how or whether to interact with the implement assembly 16.

In some embodiments, the implement assembly 16 includes an indicator, tag, or registration mark, shown as implement tag 152. As shown, the implement tag 152 is coupled to the mounting plate 102. The implement tag 152 may have one or more predetermined features (e.g., a shape and size, a color, a reflectivity (e.g., due to a retroreflective coating, etc.), a bar code or two-dimensional code, etc.). In other embodiments, the implement sensor 150 is onboard the implement assembly 16, and the implement tag 152 is onboard the implement interface 18.

In some embodiments, the sensor data indicates the position and/or orientation (e.g., pose) of the implement assembly 16 relative to the implement interface 18. By way of example, the implement sensor 150 may include a camera, an ultrasonic sensor, a LIDAR sensor, or other type of sensor configured to provide image data indicating a pose of the implement assembly 16. By analyzing the sensor data, the base controller 40 may determine a distance and/or orientation of the implement assembly 16 relative to the implement sensor 150. By way of example, the base controller 40 may analyze image data provided by a camera. The size of the implement assembly 16 in the image data may indicate a distance to the implement assembly 16, and the shape of the implement assembly 16 in the image data may indicate the orientation of the implement assembly 16. The position of the implement sensor 150 on the lift device 10 may be predetermined and stored in the memory 44. Accordingly, by analyzing the sensor data, the base controller 40 may determine the pose (e.g., position and orientation) of the implement assembly 16 relative to the implement interface 18.

The implement tag 152 may facilitate identifying the position and/or orientation of the implement assembly 16. By way of example, the implement tag 152 may include a series of protrusions set at a fixed distance relative to one another that may be observed with a camera of the implement sensor 150. The apparent distance between the protrusions (e.g., a number of pixels between the protrusions in image data captured by the camera) may indicate the distance between the implement assembly 16 and the camera. Similarly, the relative orientations of the protrusions

In some embodiments, the sensor data includes implement identification data. The implement identification data may indicate a type of the implement assembly 16 (e.g., a category that the implement assembly 16 belongs to, a task that the implement assembly 16 is intended to perform or capable of performing, etc.). The implement identification data may include an identifier that uniquely identifies an implement assembly 16 (e.g., a serial number, an owner of the implement, etc.). By way of example, the implement sensor 150 may gather the implement identification data based on a shape of the implement assembly 16 (e.g., a pressure washer assembly having a different shape than a bucket or welding arm). By way of another example, the implement tag 152 may contain the identification data in a format that can be read or otherwise retrieved by the implement sensor 150 (e.g., as text, as a barcode, as two-dimensional code, as an RFID or NFC tag, etc.).

The implement interface 18 may facilitate the use of multiple different implement assemblies 16 with the same lift device 10 by permitting the implement assemblies 16 to be interchanged as desired. By way of example, a single lift device 10 may be provided with multiple different implement assemblies 16, each suitable for a different task or situation. The implement interface 18 includes certain features that interact with corresponding features generic to some or all of the implement assemblies 16, thereby facilitating interchanging the implement assemblies 16 without having to modify the implement interface 18.

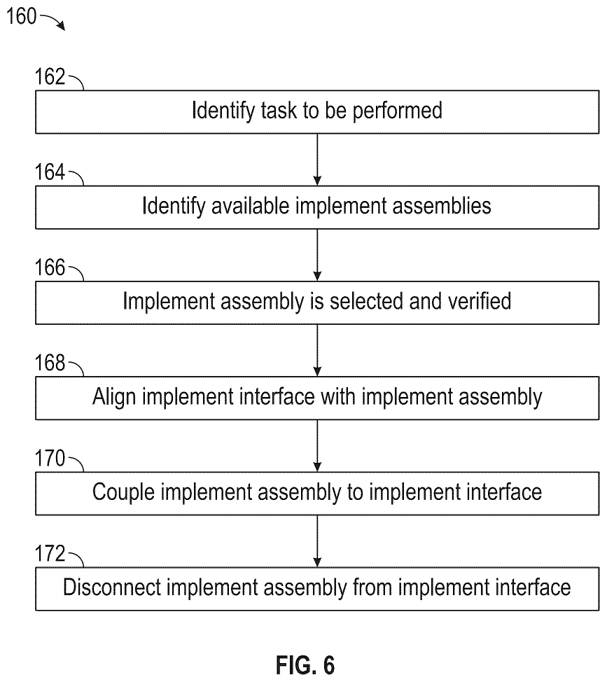

Referring to FIG. 6, a method 160 of operating the lift device 10 utilizing an implement assembly 16 is shown according to an exemplary embodiment. The method 160 includes a step 162 in which a task to be performed is identified. Specifically, the task may be identified by the base controller 40. By way of example, a user may indicate the task to be performed through the user interface 48. By way of another example, the base controller 40 may receive an indication of the task to be performed from a external device 47, such as a server or a user device, through the communication interface 46. The indication of the task to be performed may include capabilities required by an implement assembly 16 that performs the task. By way of example, if the task includes cleaning the exterior of a plane, the indication may require that the implement assembly 16 has the ability to spray water and/or soap. By way of example, if the task includes removing paint from a ship hull, the indication may require that the implement assembly 16 has the ability to spray an abrasive medium that is capable of removing the paint from the ship hull. By way of another example, if the task includes moving a pallet of material, the indication may require that the implement includes forks of sufficient size to support the pallet.

In step 164 of the method 160, one or more available implement assemblies are identified. Specifically, the base controller 40 identifies implement assemblies 16 available to the lift device 10. By way of example, the base controller 40 may use the implement identification data retrieved using the implement sensor 150 to determine which implement assemblies 16 are available. By way of another example, the base controller 40 may receive a listing of available implement assemblies 16 from an external device 47 (e.g., a user device or server). By way of another example, the base controller 40 may communicate wirelessly with the implement controllers 70 of nearby implement assemblies 16 to determine which implement assemblies are available.

In step 166 of the method 160, one of the implement assemblies 16 is selected from the available implement assemblies 16 and verified. The implement assembly 16 may be verified after selection, or all of the available implement assemblies 16 may be verified, and the successfully verified implement assembly 16 may be presented for selection. The selection may be performed manually by a user (from a list provided through an external device 47 or a user interface 48) or automatically (e.g., by the base controller 40). If multiple implement assemblies 16 are available and successfully verified (e.g., capable of performing the task), the base controller 40 may automatically select the implement assembly 16 closest to the lift device 10.

The verification may confirm whether or not an implement assembly 16 is capable of and/or authorized to perform the task to be performed (e.g., a desired action). The verification may be performed by the base controller 40, by an implement controller 70 of one of the available implement assemblies 16, by an external device 47, or by some combination thereof. By way of example, the implement controllers 70 of the available implement assemblies 16 may provide implement identification data to the base controller 40, and the base controller 40 may send that implement identification data to an external device 47 for verification.

In some embodiments, capabilities of a particular implement assembly 16 are predetermined and stored as a list of specifications. The list of specifications may be stored locally (e.g., in the memory 74 of the implement controller 70, in the memory 44 of the base controller 40, etc.). Additionally or alternatively, the list of specifications may be stored on an external device 47 (e.g., on a server). By way of example, the implement controller 70 may transmit implement identification data (e.g., a serial number identifying an implement assembly 16) to the external device 47, and the external device 47 may return a list of specifications for the implement assembly 16.

The specifications my indicate the type of actions that can be performed (e.g., welding, spray painting, sand blasting, pressure washing, etc.) by a given implement assembly 16. The specifications may include additional information describing the capabilities of the implement assembly 16 (e.g., a thickness range of material that can be welded by the implement 60, a type of material that can be welded by the implement 60, the current paint color loaded into the implement 60, a flow rate of fluid that the implement 60 can provide, etc.).

The desired action may be compared with the list of specifications for the implement assembly 16 to determine if the desired action is within the capabilities of the implement assembly 16. By way of example, this comparison may be handled locally (e.g., by the implement controller 70 or the base controller 40) or remotely (e.g., by an external device 47). In response to a determination that the implement assembly 16 is capable of performing the desired action, the implement assembly 16 may be verified successfully. In response to a determination that the desired action falls outside of the capabilities of the implement assembly 16, the implement assembly 16 may not be verified successfully.

In some embodiments, the verification includes determining whether the implement assembly 16 is authorized for use with the lift device 10. The lift device 10 may be authorized for use with a predetermined group of implement assemblies 16. By way of example, a fleet management system of an external device 47 may store a list of authorized implement assemblies 16 for use with each lift device 10.

The authorization may be based on the capabilities of the lift device 10 to use the implement assembly 16. By way of example, each implement assembly 16 may have certain energy electrical requirements (e.g., current, voltage, AC vs DC, etc.), fluid flow requirements (e.g., type of fluid, flow rate, etc.), whether the implement assembly 16 has a layout that can engage the implement interface 18, etc. By way of another example, the authorization may be based on ownership of the implement assembly 16 and/or the lift device 10. In one such example, the lift device 10 is only authorized to use implement assemblies 16 that are owned by the same entity as the lift device 10. Such a configuration may prevent mixing of equipment between two companies at a jobsite.

In response to a determination that the implement assembly 16 is authorized for use with the lift device 10, the implement assembly 16 may be verified successfully. In response to a determination that the implement assembly 16 is not authorized for use with the lift device 10, the implement assembly 16 may not be verified successfully. In order to be verified, an implement assembly 16 may require (a) a determination that the implement assembly 16 is capable of performing a desired action, (b) a determination that the implement assembly 16 is authorized for use with the lift device 10, or (c) both a determination that the implement assembly 16 is capable of performing a desired action and a determination that the implement assembly 16 is authorized for use with the lift device 10.

In step 168 of the method 160, the implement interface 18 is aligned with the implement assembly 16. As shown in FIGS. 3-5, the implement interface 18 may be aligned with the implement assembly 16 when the alignment rods 120 are aligned with the alignment passages 122. In some embodiments, the base controller 40 controls operation of the base assembly 12 and/or the lift assembly 14 to place the implement interface 18 into alignment with the implement assembly 16. In some such embodiments, the base controller 40 utilizes sensor data from the implement sensor 150 to provide position feedback and facilitate the alignment.

In step 170 of the method 160, the implement assembly 16 is coupled to the implement interface 18. As shown in FIGS. 3-5, the implement interface 18 is pressed against the implement assembly 16 to seat the alignment rods 120 into the alignment passages 122. The alignment rods 120 engage the walls of the alignment passages 122 to maintain alignment, limiting lateral and vertical movement of the implement interface 18 relative to the implement assembly 16. Additionally or alternatively, the hook 114 may be engaged with the hook seat 112 to support the implement assembly 16. The latch assembly 130 may then be engaged (e.g., manually or by the base controller 40) to fixedly couple the implement assembly 16 to the implement interface 18 and press the mounting plate 100 against the mounting plate 102. With the mounting plates 100 and 102 pressed against one another, the corresponding connectors of the connector assembly 140 are forced into engagement with one another, forming their respective data, fluid, and/or electrical connections. Accordingly, the implement assembly 16 is fixedly and communicatively coupled to the implement interface 18.

In step 172 of the method 160, the implement assembly 16 is disconnected from the implement interface 18. By way of example, the latch assembly 130 may be disengaged, and the implement interface 18 may be pulled away from the implement assembly 16 to disconnect the implement assembly 16. In response, the connector assemblies 140 may automatically seal to prevent leakage of fluid. Step 172 may be performed, for example, when the task requiring a particular implement assembly 16 has been completed. Steps 162, 164, 166, 168, and 170 may again be performed to connect another implement assembly 16 suitable for a different task.

The arrangement of the alignment passages 122, the connector assembly 140, the hook assembly 110, and the latch assembly 130 may be common across multiple of the implement assemblies 16, such that the implement interface 18 is compatible with all of the implement assemblies 16. By placing these features in common positions across multiple of the implement assemblies 16, the implement interface 18 may quickly switch between engagement with different implement assemblies 16 (e.g., suitable for different tasks) without having to modify the implement interface 18.

If one of the implements does not require one or more of (a) signal, (b) electrical energy, (c) compressed gas, or (d) pressurized liquid, the corresponding connector(s) of the implement assembly 16 may be omitted and replaced with a plug. The base controller 40 may determine which of these are not required (e.g., based on implement identification data) and shut off the corresponding functions of the lift device 10. By way of example, the base controller 40 may open contactors to halt transfer of electrical energy, may close a valve to halt the flow of compressed gas or pressurized liquid, and/or may turn off a pump or compressor.

Beneficially, the lift device 10 may be utilized with a variety of different implement assemblies 16. The implement interface 18 may provide a universal mounting solution that facilitates supporting an implement assembly 16 and transmitting signals, electrical energy, compressed gas, and pressurized liquid. By using a common implement interface 18, multiple implement assemblies 16 may be designed that rely on the same features of the implement interface 18 and are interchangeable with one another depending upon a desired application of the lift device 10.

### Implement Control Over Lift Device

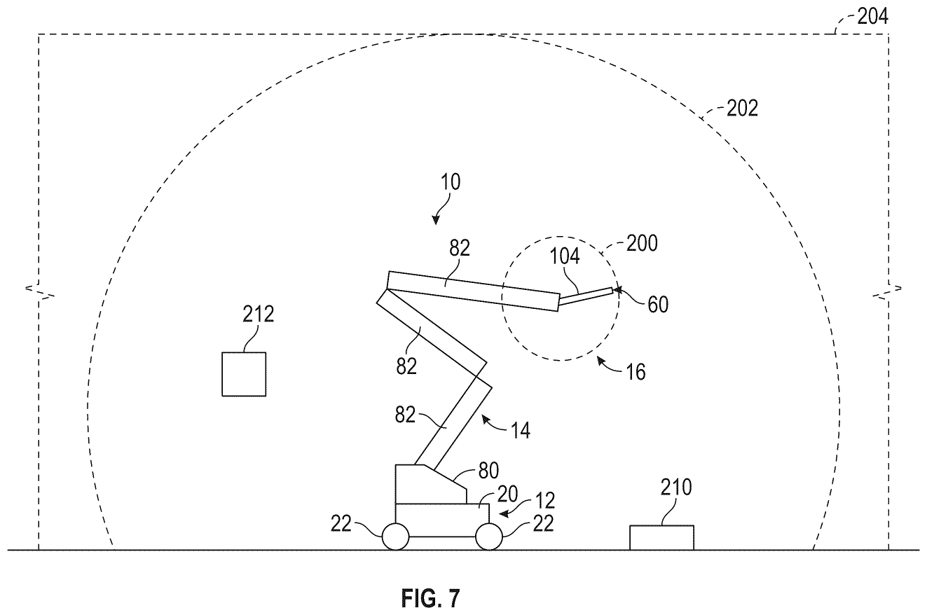

Referring to FIGS. 1 and 7, the base controller 40 and the implement controller 70 may cooperate to control operation of the lift device 10. For example, the implement controller 70 may be configured to control the implement assembly 16 to perform a task (e.g., painting, pressure washing, sand blasting, welding, etc.). If the implement controller 70 were to operate without communicating to the base controller 40, the implement assembly 16 may be held in a substantially constant (e.g., unmoving) position by the lift assembly 14, limiting the operating range of the implement assembly 16 to a relatively small area (e.g., limited by how far the implement actuators 62 are capable of moving the implement 60 relative to the mounting plate 102). However, the implement controller 70 may beneficially cooperate with the base controller 40 to cause the base assembly 12 and/or the lift assembly 14 to reposition the implement assembly 16 as necessary or desired throughout operation, providing for a much larger (e.g., unlimited) range of operation for the implement assembly 16. An example of this is illustrated in detail in FIG. 7.

FIG. 7 illustrates various operating ranges of the lift device 10, according to an exemplary embodiment. A zone or area 200 represents a range of locations that can be accessed by the implement 60 by controlling the implement assembly 16 without moving the base assembly 12 or the lift assembly 14. As shown, the area 200 is generally centered about a distal end of the lift assembly 14 and is relatively small. The size and shape of the area 200 may be defined by the construction of the implement assembly 16 (e.g., the size and movement of the implement arm 104 and the implement actuator 62). In some embodiments, the area 200 is substantially spherical.

Using sensor data from the implement sensors 64, the implement controller 70 may determine a strategy to control the implement actuator 62 to achieve any desired position of the implement 60 within the area 200. By way of example, the implement controller 70 may receive a desired position of the implement 60. The implement controller 70 may determine a current position of the implement 60 based on sensor data from the implement sensors 64 and/or a position of the implement interface 18 (e.g., provided by the base controller 40). Using predetermined relationships (e.g., determined experimentally or geometrically) between the actions of each implement actuator 62 and the resultant movements of the implement 60, the implement controller 70 may determine a set of actions to be performed by the implement actuator 62 to reach the desired position of the implement 60.

A zone or area 202 represents a range of locations that can be accessed by the implement 60 by controlling the implement assembly 16 and the lift assembly 14 without moving the base assembly 12. As shown, the area 202 is generally centered about a proximal end of the lift assembly 14 (e.g., the turntable 80). In some embodiments, the area 200 is substantially spherical. The size and shape of the area 202 may be defined by the construction of the lift assembly 14 (e.g., the size and movement of the turntable 80, the boom sections 82, and the lift actuators 50). As shown, the area 202 is larger than the area 200 and contains the area 200. Accordingly, the use of the lift assembly 14 to reposition the lift assembly 16 significantly increases the size of the operating range of the lift assembly 16.

Using sensor data from vehicle sensors 52 and/or the implement sensors 64, the base controller 40 and/or implement controller 70 may determine a strategy to control the implement actuator 62 and the lift actuators 50 to achieve any desired position of the implement 60 within the area 202. By way of example, the implement controller 70 may receive a desired position of the implement 60. The base controller 40 and/or the implement controller 70 may determine a current position of the implement 60 based on sensor data from the vehicle sensors 52 and/or the implement sensors 64. By way of example, the base controller 40 may use the vehicle sensors 52 to determine the position of the implement interface 18, and the implement controller 70 may use the implement actuator 62 to determine the current position of the implement 60 relative to the implement interface 18. Using predetermined relationships between the actions of the lift actuators 50 and the resultant movement of the implement interface 18, and between the actions of the implement actuators 62 and the resultant movements of the implement 60, the base controller 40 and/or the implement controller 70 may determine a set of actions to be performed by the lift actuators 50 and the implement actuators 62 to reach the desired position of the implement 60. By way of example, the base controller 40 may determine actions of the lift actuators 50 to move the implement interface 18 into a desired position, and the implement controller 70 may determine actions of the implement actuators 62 to move the implement 60 to the desired position when the implement interface 18 is in the corresponding desired position.

A zone or area 204 represents a range of locations that can be accessed by the implement 60 by controlling the base assembly 12, the lift assembly 14, and the implement assembly 16. As shown, the area 204 is approximately the same height as the area 202 and extends infinitely horizontally. In some embodiments, the area 204 has a consistent thickness above the support surface (e.g., the ground). Accordingly, if the support surface is non-planar (e.g., curved), the shape of the area 204 may follow the shape of the support surface. The horizontal dimensions (e.g., the width and length) of the area 204 may be extend until the base assembly 12 encounters an obstacle that would prevent further movement of the base assembly 12 in that direction. The area 204 is wider and longer than the area 202 and contains the area 200 and the area 202. Accordingly, the use of the base assembly 12 to reposition the lift assembly 14 and the implement assembly 16 further increases the size of the operating range of the implement assembly 16.

Using sensor data from vehicle sensors 52 and/or the implement sensors 64, the base controller 40 and/or implement controller 70 may determine a strategy to control the implement actuator 62, the lift actuators 50, and the prime mover 24 to achieve any desired position of the implement 60 within the area 204. By way of example, the implement controller 70 may receive a desired position of the implement 60. The base controller 40 and/or the implement controller 70 may determine a current position of the implement 60 based on sensor data from the vehicle sensors 52 and/or the implement sensors 64. By way of example, the base controller 40 may use the vehicle sensors 52 to determine the position of the implement interface 18, and the implement controller 70 may use the implement actuator 62 to determine the current position of the implement 60 relative to the implement interface 18. Using predetermined relationships between the actions of the lift actuators 50 and the prime mover 24 and the resultant movement of the implement interface 18, and between the actions of the implement actuators 62 and the resultant movements of the implement 60, the base controller 40 and/or the implement controller 70 may determine a set of actions to be performed by the lift actuators 50, the prime mover 24, and the implement actuators 62 to reach the desired position of the implement 60. By way of example, the base controller 40 may determine actions of the lift actuators 50 and the prime mover 24 to move the implement interface 18 into a desired position, and the implement controller 70 may determine actions of the implement actuators 62 to move the implement 60 to the desired position when the implement interface 18 is in the corresponding desired position.

FIG. 7 further includes a pair of objects, obstructions, or obstacles, shown as base obstacle 210 and lift obstacle 212. The base obstacle 210 is positioned to engage the base assembly 12 (e.g., on the ground) and obstructs a path of the base assembly 12. When in contact with the base assembly 12, the base obstacle 210 may prevent further movement of the base assembly 12 in a corresponding direction. Accordingly, the base obstacle 210 may limit the shape and/or size of the area 204. The lift obstacle 212 is positioned to engage the lift assembly 14 (e.g., above the ground) and obstructs a path of the lift assembly 14. When in contact with the lift assembly 14, the lift obstacle 212 may prevent further movement of the lift assembly 14 in a corresponding direction. Accordingly, the lift obstacle 212 may limit the shape and/or size of the area 202 and the area 204.

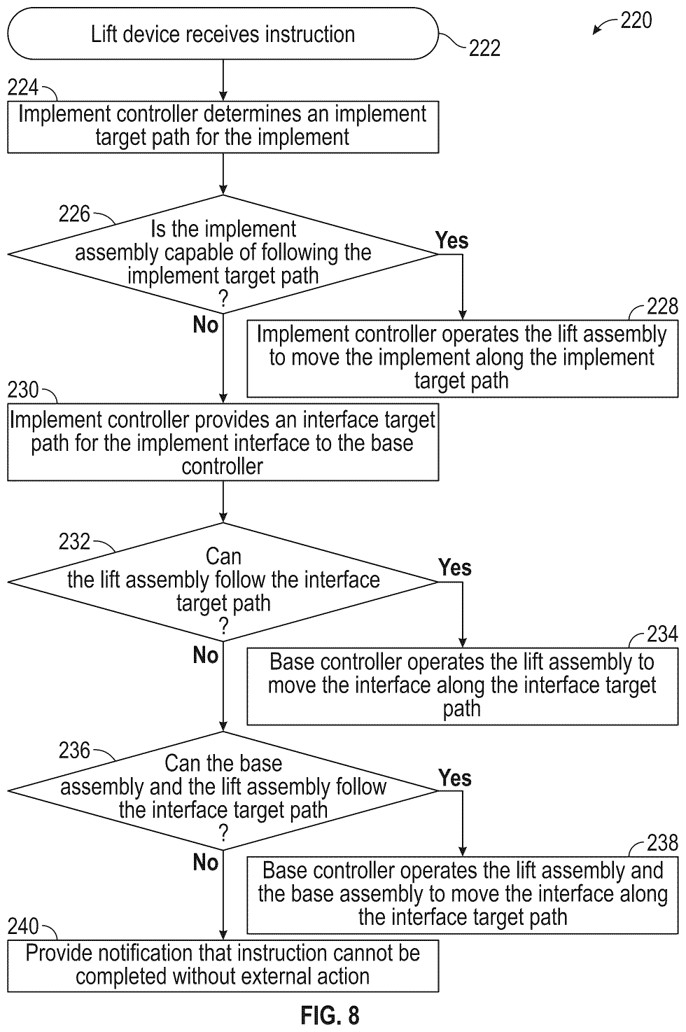

Referring to FIG. 8, a method 220 for operating the lift device 10 is shown according to an exemplary embodiment. The method 220 may include repositioning or otherwise moving the implement 60 to facilitate performing a task. The method 220 may be performed autonomously (e.g., without direct operator input) and/or based on a user input.

In step 222, the lift device 10 receives an instruction. The instruction may request a specific action of the lift device 10. By way of example, the instruction may indicate a requested movement of the implement 60. By way of another example, the instruction may indicate a requested action to be performed by the implement 60.

In some embodiments, the instruction is provided by a user or operator of the lift device 10. By way of example, the user may provide the instruction through the user interface 48 and/or the user interface 78. In some embodiments, the instruction is provided by an external device 47. By way of example, the user may provide the instruction through a user device (e.g., a smartphone, a tablet, etc.). By way of another example, a remote server may generate the instruction (e.g., based on operation of a jobsite management system).

In some embodiments, the instruction requests a specific movement of the implement 60. By way of example, the instruction may provide a requested speed and direction of movement for the implement 60. In one such example, the implement 60 is a platform for supporting an operator, and the operator indicates a desired direction of motion. An operator may provide such an instruction, for example, by pressing a joystick of the user interface 78 toward the desired direction.

By way of another example, the instruction may provide a target location or path for the implement 60. In one such example, a list of desired positions for the implement 60 is provided by a user (e.g., through the user interface 78). In another such example, the implement controller 70 identifies a list of desired positions for the implement 60. The implement controller 70 may utilize sensor data from the vehicle sensors 52 and/or the implement sensors 64 to determine a target path around an object in the surrounding environment. By way of example, the implement controller 70 may use the sensor data to identify a position of an obstacle and generate a target path that avoids the obstacle. By way of another example, the implement controller 70 may use sensor data to identify a nearby surface (e.g., a window, a wall, a ship hull, an aircraft fuselage, etc.) and generate a target path that maintains a constant, predetermined distance between the implement 60 and the surface. By way of another example, the implement controller 70 may receive a model of a surface (e.g., a computer aided design (CAD) model of a building or structure including a surface) and generate a target path that follows the surface.

The instruction may indicate a speed and/or dwell time for one or more target locations. By way of example, the instruction may indicate a speed with which the implement 60 should travel between two target locations. By way of another example, the instruction may indicate a speed that the implement 60 should be traveling at when the implement 60 reaches a target location. By way of another example, the instruction may indicate an amount of time that the implement should remain at a target location (e.g., a dwell time for the target location). In this way, the instruction may indicate the target path of the implement 60, as well as the timing of the implement 60 moving along the target path. When controlling for a dwell time at a target location, the implement controller 70 may control the lift device 10 to maintain the implement 60 at the desired location, even in response to external forces that attempt to move the implement 60. By way of example, the implement controller 70 may control the lift device 10 to counteract deflection from wind, from blowback forces when the implement 60 is spraying, etc.

In some embodiments, the instruction includes a requested action to be performed by the implement 60. The implement controller 70 may determine a target location or path for the implement 60 based on the requested action to be performed. The determined target location or target path may facilitate completion of the requested action.

By way of example, the instruction may include a request for pressure washing an area of a surface (e.g., a plane fuselage, a window, a wall, etc.), and the implement 60 may include a pressure washing nozzle. In such an example, the implement controller 70 may generate a target path for the implement 60 that permits the pressure washing nozzle to clean the indicated area. For example, the implement controller 70 may generate a target path that moves the implement 60 in an oscillating or zig-zag pattern across the area. The speed of the implement 60, the distance between adjacent oscillations of the target path, the distance between the target path of the implement 60 and the surface, and/or other characteristics of the target path may be determined based on predetermined characteristics of the pressure washing nozzle (e.g., a spray angle, an optimal spray distance, etc.).

By way of another example, the instruction may include a request for placing a weld along a component, and the implement 60 may include a welder. In such an example, the implement controller 70 may generate a target path for the implement 60 that causes a distal portion of the welder to move along a desired path for the weld identified in the instruction. The speed of the implement 60, the orientation of the implement 60, the distance between the target path of the implement 60 and the desired path for the weld, and/or other characteristics of the target path may be determined based on predetermined characteristics of the welder (e.g., a feed rate of the welding wire, etc.).

In step 224 of the method 220, the implement controller 70 determines a target path of the implement 60 (i.e., an implement target path). Specifically, the implement controller 70 determines the implement target path based on the instruction for the lift device 10 received in step 222. In some embodiments, the instruction for the lift device 10 provides the implement target path directly. In other embodiments, the implement controller 70 analyzes the instruction to determine the implement target path. By way of example, the instruction may provide a target location, and the implement controller 70 may generate an implement target path that brings the implement to the target location. By way of another example, the instruction may indicate a desired action for the implement 60, and the implement controller 70 may generate an implement target path that facilitates or permits completion of the desired action.

In step 226 of the method 220, the implement controller 70 determines whether the implement assembly 16 is capable of following the implement target path. Specifically, the implement controller 70 may analyze the implement target path and determine whether a range of motion the implement assembly 16 (e.g., the area 200) is capable of following the implement target path without moving the lift assembly 14 or the base assembly 12. If the implement assembly 16 is capable of following the implement target path without moving the lift assembly 14 or the base assembly 12, the implement controller 70 may control the implement assembly 16 to follow the implement target path without communicating with (e.g., providing commands to) the base controller 40.

In some embodiments, the implement controller 70 determines whether the implement assembly 16 is capable of following the implement target path based on a range of motion of the implement assembly 16. By way of example, the range of motion of the implement assembly 16 may be the area 200. The range of motion of the implement assembly 16 may be predetermined and stored in the memory 74. By way of example, the implement controller 70 may determine that the implement assembly 16 is not capable of following the target path without moving the lift assembly 14 or the base assembly 12 in response to a determination that the implement target path extends outside of the area 200.

In some embodiments, the implement controller 70 determines whether the implement assembly 16 is capable of following the implement target path based on detection of an obstacle. By way of example, the sensor data from the vehicle sensors 52 and/or the implement sensors 64 may be used to detect a base obstacle 210 or a lift obstacle 212 positioned to limit movement of the implement assembly 16. For example, the sensor data may indicate a lift obstacle 212 within the area 200 that prevents the implement assembly 16 from reaching a portion of the area 200. The implement controller 70 may determine that the implement assembly 16 is not capable of following the implement target path without moving the lift assembly 14 or the base assembly 12 in response to a determination that the target path extends into the portion of the area 200 that is blocked by the lift obstacle 212.

If the implement controller 70 determines that the implement assembly 16 is capable of following the implement target path, the implement controller 70 determines “yes” in step 226 and proceeds to step 228 of the method 220. In step 228 of the method, the implement controller 70 operates the lift assembly 16 to move the implement 60 along the implement target path. This may include navigating the lift assembly 14 to avoid any base obstacles 210 and/or lift obstacles 212 nearby (e.g., as detected using the vehicle sensors 52 and/or the implement sensors 64). The specific actions of the lift assembly 14 required to avoid the obstacles may be identified by the base controller 40 (e.g., without a determination being made by the implement controller 70). Because the target path falls entirely within the range of motion of the implement assembly 16, the implement controller 70 is capable of controlling the implement assembly 16 to move along the implement target path without requesting movement of the base assembly 12 and/or the lift assembly 14 by the base controller 40.

If the implement controller 70 determines that the implement assembly 16 is incapable of following the implement target path, the implement controller 70 determines “no” in step 226 and proceeds to step 230 of the method 220. In step 230 of the method, the implement controller 70 provides a command to the base controller 40 including a target path for a distal end portion of the lift assembly 14 (e.g., the implement interface 18). For clarity, this target path is referred to as an “interface target path.” Because the implement target path for the implement 60 extends outside of the range of motion of the implement assembly 16, movement of the base assembly 12 and/or the lift assembly 14 by the base controller 40 may be required to complete the movement of the implement 60 along the implement target path.

In step 232 of the method 220, the base controller 40 determines whether the lift assembly 14 is capable of following the interface target path provided by the implement controller 70 without the use of the base assembly 12. Specifically, the base controller 40 may analyze the interface target path and determine whether a range of motion the lift assembly 14 (e.g., the area 202) is capable of following the interface target path without moving the base assembly 12. If the lift assembly 14 is capable of following the interface target path without moving the base assembly 12, the base controller 40 may control the lift assembly 14 to follow the interface target path based on the command.

In some embodiments, the base controller 40 determines whether the lift assembly 14 is capable of following the interface target path without the use of the base assembly 12 based on a range of motion of the lift assembly 14. By way of example, the range of motion of the lift assembly 14 may be the area 202. The range of motion of the lift assembly 14 may be predetermined and stored in the memory 44. By way of example, the base controller 40 may determine that the lift assembly 14 is not capable of following the interface target path without moving the base assembly 12 in response to a determination that the target path extends outside of the area 202.

In some embodiments, the base controller 40 determines whether the lift assembly 14 is capable of following the interface target path without use of the base assembly 12 based on detection of an obstacle. By way of example, sensor data from the vehicle sensors 52 and/or the implement sensors 64 may detect a base obstacle 210 or a lift obstacle 212 positioned to limit movement of the lift assembly 14. For example, the sensor data may indicate a lift obstacle 212 within the area 202 that prevents the lift assembly 14 from reaching a portion of the area 202. The base controller 40 may determine that the lift assembly 14 is not capable of following the interface target path without moving the base assembly 12 in response to a determination that the interface target path extends into the portion of the area 202 that is blocked by the lift obstacle 212.

If the base controller 40 determines that the lift assembly 14 is capable of following the interface target path, the base controller 40 determines “yes” in step 232 and proceeds to step 234 of the method 220. In step 234 of the method, the base controller 40 operates the lift assembly 14 to move the implement interface 18 along the interface target path. Because the interface target path falls entirely within the range of motion of the lift assembly 14, the base controller 40 is capable of controlling the lift assembly 14 to move along the target path without moving the base assembly 12. Throughout this process, the base controller 40 may provide positional feedback (e.g., from the vehicle sensors 52) to the implement controller 70. This feedback may facilitate the implement assembly 16 locating itself in space and may thereby facilitate the implement assembly 16 moving the implement 60 along the implement target path.

If the base controller 40 determines that the lift assembly 14 is incapable of following the interface target path without use of the base assembly 12, the base controller 40 determines “no” in step 232 and proceeds to step 236 of the method 220. Because the interface target path extends outside of the range of motion of the lift assembly 14, movement of the base assembly 12 may be required to complete the movement of the lift assembly 14 along the target path.

In step 236 of the method 220, the base controller 40 determines whether the lift assembly 14 and the base assembly 12 together are capable of following the interface target path provided by the implement controller 70. Specifically, the base controller 40 may analyze the interface target path and determine whether a range of motion the base assembly 12 and the lift assembly 14 (e.g., the area 204) is capable of following the interface target path. If the base assembly 12 and the lift assembly 14 are capable of following the interface target path, the base controller 40 may control the base assembly 12 and the lift assembly 14 to follow the interface target path based on the command.

In some embodiments, the base controller 40 determines whether the base assembly 12 and the lift assembly 14 are capable of following the interface target path based on a range of motion of the base assembly 12 and the lift assembly 14. By way of example, the range of motion of the base assembly 12 and the lift assembly 14 may be the area 204. The range of motion of the base assembly 12 and the lift assembly 14 may be predetermined and stored in the memory 44. By way of example, the base controller 40 may determine that the base assembly 12 and the lift assembly 14 are not capable of following the interface target path in response to a determination that the target path extends outside of the area 204.

In some embodiments, the base controller 40 determines whether the base assembly 12 and the lift assembly 14 are capable of following the interface target path based on detection of an obstacle. By way of example, sensor data from the vehicle sensors 52 and/or the implement sensors 64 may detect a base obstacle 210 or a lift obstacle 212 positioned to limit movement of the base assembly 12 or the lift assembly 14. For example, the sensor data may indicate a base obstacle 210 within the area 204 that prevents the base assembly 12 from reaching a portion of the area 204. The base controller 40 may determine that the base assembly 12 is not capable of following the interface target path in response to a determination that the interface target path extends into the portion of the area 204 that is blocked by the base obstacle 210.

If the base controller 40 determines that the base assembly 12 and the lift assembly 14 are capable of following the interface target path, the base controller 40 determines “yes” in step 236 and proceeds to step 238 of the method 220. In step 238 of the method, the base controller 40 operates the base assembly 12 and the lift assembly 14 to move the implement interface 18 along the interface target path. Because the interface target path falls entirely within the range of motion of the base assembly 12 and the lift assembly 14, the base controller 40 is capable of controlling the base assembly 12 and the lift assembly 14 to move along the interface target path. This may include navigating the base assembly and/or the lift assembly 14 to avoid any base obstacles 210 and/or lift obstacles 212 (e.g., as detected using the vehicle sensors 52 and/or the implement sensors 64). The specific actions of the base assembly 12 and/or the lift assembly 14 required to avoid the obstacles may be identified by the base controller 40 (e.g., without a determination being made by the implement controller 70). Throughout this process, the base controller 40 may provide positional feedback (e.g., from the vehicle sensors 52) to the implement controller 70. This feedback may facilitate the implement assembly 16 locating itself in space and may thereby facilitate the implement assembly 16 moving the implement 60 along the implement target path.

If the base controller 40 determines that the base assembly 12 and the lift assembly 14 are incapable of following the interface target path, the base controller 40 determines “no” in step 236 and proceeds to step 240 of the method 220. In step 240, the lift device 10 (e.g., the base controller 40 and/or the implement controller 70) provide a notification that the instruction received in step 222 cannot be completed without external action. The notification may be provided to the implement controller 70. Additionally or alternatively, the notification may be provided through an external device 47, through a user interface 48, or through another interface. By way of example, the notification may include a text message on a use device. By way of another example, the notification may be a status update to a fleet management system (e.g., on a server) indicating that the lift device 10 is stuck and cannot complete the instruction.

In some embodiments, the notification includes a suggested action that may be performed to facilitate completing the instruction. By way of example, the notification may include a request for an operator or other personnel to remove a base obstacle 210 or a lift obstacle 212. By way of another example, the notification may include alternative suggested path that would avoid a base obstacle 210 or a lift obstacle 212. In response to receiving the notification, the method 220 may return to step 230 and generate another interface target path for the base controller 40 that avoids the base obstacle 210 and/or the lift obstacle 212.

Beneficially, the lift device 10 may be utilized with a variety of different implement assemblies 16. The implement interface 18 may provide a universal mounting solution that facilitates communication between the different implement assemblies 16 and the lift device 10. Throughout operation, the implement controller 70 may simply indicate a desired path for the implement interface 18 to the base controller 40, and the base controller 40 may translate the desired path into specific actions of the base assembly 12 and/or the lift assembly 14. The base controller 40 may continuously provide positional feedback to the implement controller 70 and indicate if a desired movement (e.g., an interface target path) cannot be followed due to an obstacle. The method 220 greatly simplifies the process of controlling the lift device 10 relative to a system where one controller is required determine how to control each actuator of a lift device individually. An organization that manufactures implement assemblies 16 may utilize a lift device 10 with minimal development devoted toward the lift assembly 14 or the base assembly 12, freeing up resources to focus on developing an implement assembly 16 for a specific application (e.g., paint spraying, sand blasting, welding, drywall finishing, etc.).

### Lift Device Configurations

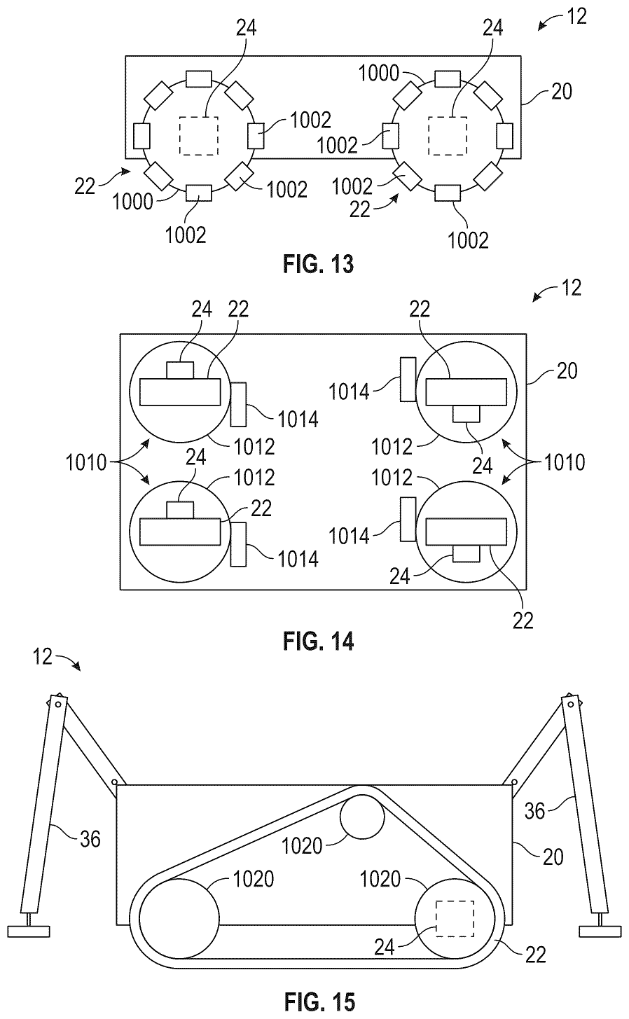

Referring to FIGS. 13-25, the lift device 10 may include base assemblies 12, lift assemblies 14, and/or implement assemblies 16 configured for use in various different applications (e.g., performing different jobs). By way of example, a certain base assembly 12 may be useful for navigating a particular environment. By way of example, a certain lift assembly 14 may be useful for lifting certain types of loads or in certain types of spaces. Different lift assemblies 14 may provide different trajectories for the implement assembly 16 and may move to a desired location with different levels of precision. By way of another example, a certain implement assembly 16 may be useful or required for performing a particular task. Accordingly, the base assembly 12, the lift assembly 14, and/or the implement assembly 16 may be selected based on how and where the lift device 10 is intended to be used. In some embodiments where lifting of the implement assembly 16 is not desired, the lift assembly 14 is omitted, and the implement assembly 16 is directly coupled to the base assembly 12 (e.g., with the implement interface 18).

In some embodiments, the lift device 10 is reconfigurable with different base assemblies 12, lift assemblies 14, and/or implement assemblies 16. The base assemblies 12, lift assemblies 14, and implement assemblies 16 may be removably coupled to one another. A base assembly 12, a lift assembly 14, and/or an implement assembly 16 may be selected based on a desired task (e.g., as part of the method 160) and combined with one another to provide a lift device 10 that is suitable for the desired task. The lift device 10 may utilize any combination of the base assemblies 12, lift assemblies 14, and/or implement assemblies 16 described herein. In some embodiments, a single base assembly 12 is utilized with multiple lift assemblies 14 and/or multiple implement assemblies 16. By way of example, a base assembly 12 may support a first implement assembly 16 (e.g., a platform for an operator) and a second implement assembly 16 (e.g., a sprayer, welder, or other tool) each supported by a different lift assembly 14.

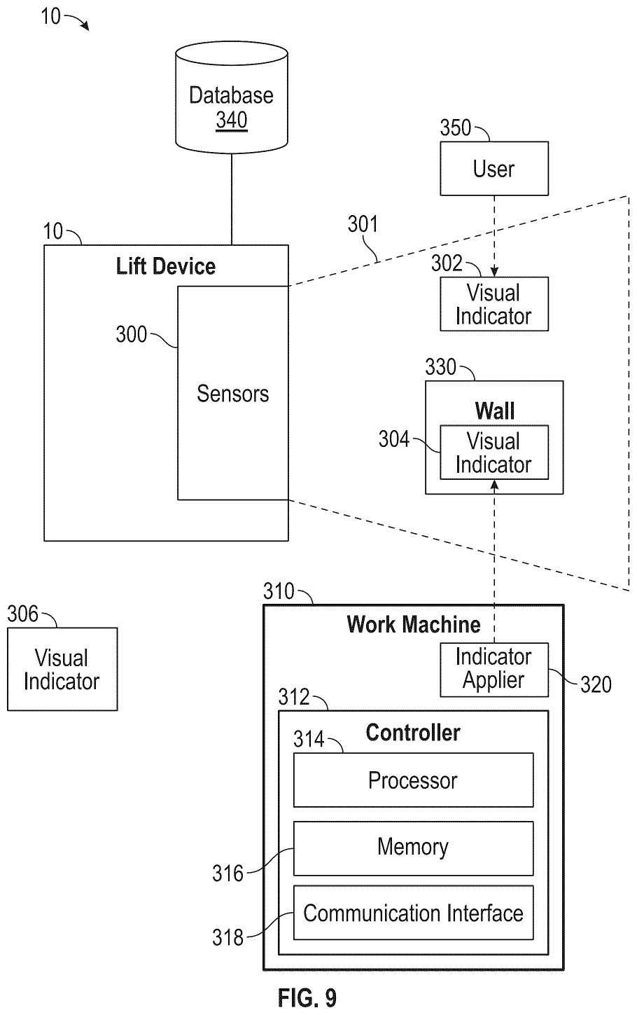

Referring to FIG. 13, a base assembly 12 is shown according to an exemplary embodiment. The base assembly 12 of FIG. 9 includes a series of tractive elements 22 configured as wheels. Each tractive element 22 is coupled to a corresponding prime mover 24, such that each tractive element 22 may be driven independently. The base assembly 12 may utilize skid steering in which the tractive elements 22 on the left and right sides of the chassis 20 are driven at different speeds and/or in different directions to steer the lift device 10.

As shown in FIG. 13, each of the tractive elements 22 is configured as an omni-directional wheel or omni wheel including a base, frame, or central portion, shown as wheel body 1000, and a series of rollers or smaller wheels, shown as rollers 1002. The rollers 1002 are spaced along a circumference of the wheel body 1000 and extend radially outward of the wheel body 1000, such that rollers 1002 contact the ground. The rollers 1002 may be rotatably coupled to the wheel body 1000, such that the rollers 1002 permit lateral movement of the base assembly 12. The rollers 1002 may facilitate turning of the base assembly 12. In some embodiments, the tractive elements 22 are configured as Mecanum wheels including rollers 1002 arranged at a 45 degree angle to the axis of rotation of the wheel body 1000. By controlling each tractive elements 22 independently, the Mecanum wheels may permits controlled lateral movement of the base assembly 12 (e.g., by the tractive elements 22 in opposing directions).

Referring to FIG. 14, a base assembly 12 is shown according to another exemplary embodiment. The base assembly 12 of FIG. 14 includes a series of steerable wheel assemblies, shown as wheel modules 1010. Each wheel module 1010 includes a turntable or steerable portion, shown as wheel frame 1012, a tractive element 22 configured as a wheel, and an actuator shown as steering motor 1014. The wheel frame 1012 is rotatably coupled to the chassis 20 and rotatable about a vertical axis. The rotation of each wheel frame 1012 is controlled by one of the steering motors 1014. A tractive element 22 and a prime mover 24 are coupled to each of the wheel frames 1012. In operation, the base controller 40 may control the steering motors 1014 to adjust the orientations of the tractive elements 22 and steer the base assembly 12. By adjusting the orientations the wheel modules 1010, the base controller 40 may steer the base assembly 12 in any horizontal direction and rotate the base assembly 12 about any vertical axis.

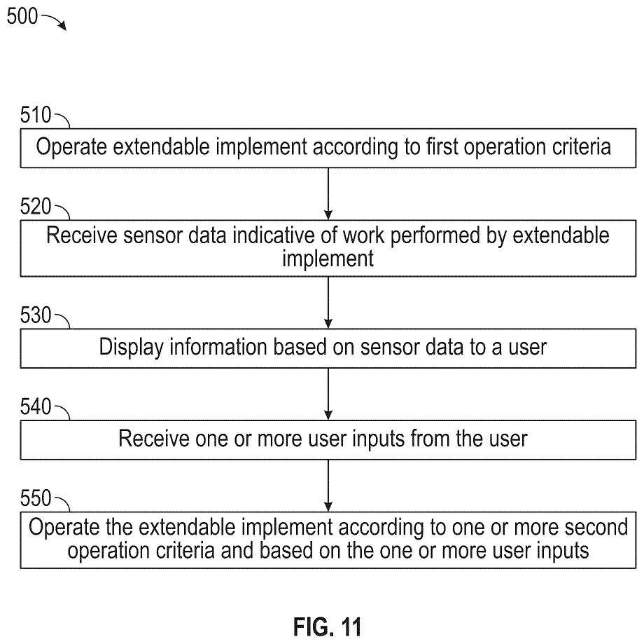

Referring to FIG. 15, a base assembly 12 is shown according to an exemplary embodiment. The base assembly 12 of FIG. 11 includes a pair of tractive elements 22 configured as continuous belts or treads, one on the left and right sides of the chassis 20. A series of rotating members (e.g., wheels, pulleys, sprockets, etc.), shown as wheels 1020, are positioned on an interior side of the treads and rotatably coupled to the chassis 20. Each side of the base assembly 12 includes at least one prime mover 24 to drive the wheels 1020, which in turn cause rotation of the treads. The treads may provide enhanced traction in slick conditions (e.g., on mud, gravel, snow, etc.) compared to tractive elements 22 configured as wheels. As shown, the base assembly 12 further includes a set of outriggers 36 that can be extended outward (e.g., by one or more actuators) to lift the chassis 20 off of the ground and provide a wide, stable base of support.

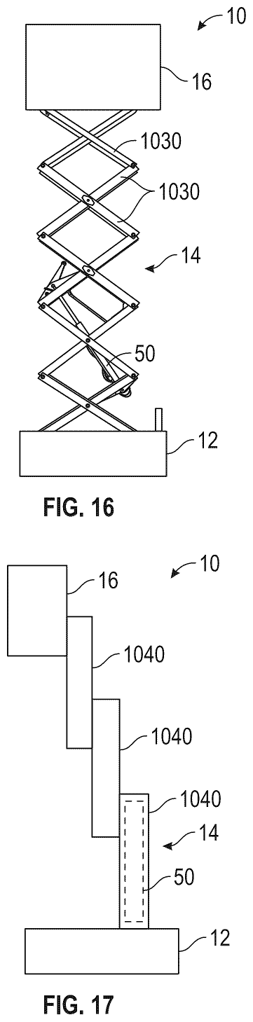

Referring to FIG. 16, the lift device 10 is shown including a lift assembly 14 configured as a scissor lift, according to an exemplary embodiment. The lift assembly 14 includes a series of rotating members, shown as scissor members 1030. The scissor members 1030 are pivotably coupled to one another in a series of crossed or X-shaped layers. The layers are stacked atop one another to form the lift assembly 14. A lift actuator 50 (e.g., a hydraulic cylinder or other linear actuator) is pivotably coupled to scissor members 1030 of two different layers. By extending or retracting the lift actuator 50, the scissor members 1030 are forced to rotate relative to one another and raise or lower the implement assembly 16 relative to the base assembly 12.

Referring to FIG. 17, the lift device 10 is shown including a lift assembly 14 configured as a vertical mast lift, according to an exemplary embodiment. The lift assembly 14 includes a series of sliding members or mast stages, shown as mast members 1040. The mast members 1040 are generally arranged vertically and slidably coupled to one another. The uppermost mast member 1040 is coupled to the implement assembly 16 (e.g., through the implement interface 18), and the lowermost mast member 1040 is coupled to the base assembly 12. Relative movement of the mast members 1040 may be controlled by one or more cables strung along the mast members 1040 by a series of pulleys. A lift actuator 50 (e.g., a hydraulic cylinder or other linear actuator) is pivotably coupled to one or more of the mast members 1040. By extending or retracting the lift actuator 50, the mast members 1040 are forced to slide relative to one another and raise or lower the implement assembly 16 relative to the base assembly 12.

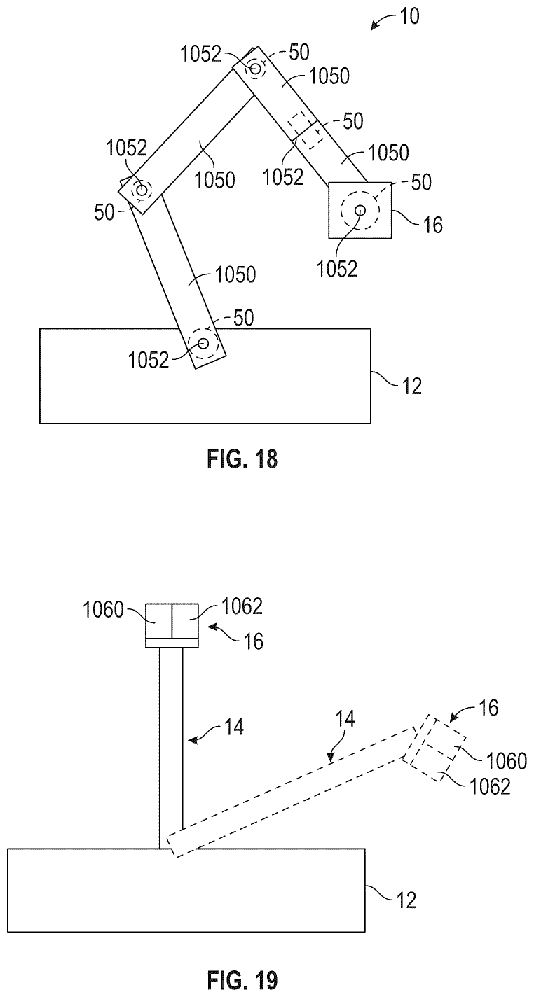

Referring to FIG. 18, the lift device 10 is shown including a lift assembly 14 configured as an articulated arm or robotic arm, according to an exemplary embodiment. The lift assembly 14 includes of pivoting members or arm stages, shown as arm members 1050. The arm members 1050 are generally connected to one another end-to-end at a series of arm joints 1052. The arm members 1050 may pivot relative to one another about the arm joints 1052 as controlled by a series of lift actuators 50. Each lift actuator 50 may control rotation at one of the arm joints 1052. Each arm joint 1052 may permit rotation about a different axis of rotation such that the lift assembly 14 may move the implement assembly 16 to any desired position and desired orientation within a range of motion of the lift assembly 14.

Referring to FIG. 19, the lift device 10 is shown according to an exemplary embodiment. In the lift device 10 of FIG. 19, a lift assembly 14 repositions and reorients an implement assembly 16 relative to a base assembly 12. The base assembly 12, the lift assembly 14, and the implement assembly 16 may represent any of the lift assemblies described herein. The implement assembly 16 includes one or more implements 60, shown as tools 1060, and one or more implement sensors 64, shown as sensors 1062. The sensors 1062 may provide feedback (e.g., sensor data) regarding the operation of the tools 1060. The tools 1060 may include a variety of different tools based on the desired application. The area affected by the tools 1060 may be adjusted by driving the base assembly 12 and/or the lift assembly 14.

In some embodiments, the lift device 10 further includes a secondary implement assembly 16 supported by another lift assembly 14 coupled to the base assembly 12 (e.g., shown in dashed lines in FIG. 19). The second implement assembly 16 may include different types of tools 1060 to perform other tasks. Additionally or alternatively, the secondary implement assembly 16 may include similar tools 1060 such that the lift device 10 is capable of performing multiple tasks in parallel and in different places.

In a spraying configuration, the tools 1060 include a sprayer configured to eject or spray a material toward a target surface. The sprayer may be positioned a distance from the target surface, such that the sprayed material crosses the distance before contacting the target surface. The material may be contained within the implement assembly 16 (e.g., in a reservoir of the tool), may be supplied from the base assembly 12 through the implement interface 18, or may be retrieved from the surrounding atmosphere (e.g., compressed air). The sensors 1062 may provide information regarding the target surface (e.g., where the target surface is relative to the tools 1060, how effective or complete the application of the sprayed material has been, etc.). Depending upon the desired application of the lift device 10, the tools 1060 may spray the material across the entirety of the target surface or across a smaller target area.

In some embodiments, the tools 1060 include a sprayer that sprays paint, chalk, or another type of visually identifiable material. Sprayed material may be used to color the target surface or to provide a protective coating on the target surface. By way of example, the lift device 10 may be used to paint surfaces of ships, automobiles, airplanes, or other equipment. Sprayed material may be used to visually identify a target area to a user or another device (e.g., by drawing a circle around an area of interest).

In some embodiments, the tools 1060 include a sprayer that sprays a material to clean a target surface. By way of example, the sprayer may spray a cleaning solution (e.g., a chemical cleaning solution) or water onto the target surface. By way of example, the sprayer may spray sand or another abrasive material (e.g., the sprayer is a sandblaster) that removes a coating (e.g., rust, paint, oxide, etc.) from the target surface. In such an example, the sprayer may be used to prepare a surface for painting.

In a cleaning configuration, the tools 1060 may include tools that remove debris (e.g., dust, dirt, leaves, grass clippings, plant material, etc.) from a target area to be cleaned. By way of example, the tools 1060 may include a vacuum that creates a negative pressure to draw the debris into the implement assembly 16 (e.g., into a debris reservoir). By way of another example, the tools 1060 may include a brush, scraper, rake, or broom that contacts the target area and pushes or scrapes debris away from the target area. By way of another example, the tools 1060 may include a blower that provides a flow of compressed air to blow the debris away from the target area. The sensors 1062 may be used to verify the efficacy of the cleaning and determine if there are additional debris that require removal.

In a printing configuration, the tools 1060 may include a printer (e.g., a brush, a marker, a spray gun, etc.) that places paint onto a target surface to form a target image. The target image may include a visual indicator (e.g., a one-dimensional or two-dimensional barcode, text, etc.) that visually communicates information to an observer or device (e.g., a camera, a scanner, etc.). By way of example, the printer may print advertisements, instructions (e.g., for tasks to be performed), information about the surroundings (e.g., the location of an emergency exit), or other information. The sensors 1062 may be used to provide positional feedback when printing and to verify the shape and quality of the formed target image.

In an installation configuration, the tools 1060 may be configured to perform various tasks associated with component installation. Such tasks may include installation preparation (e.g., drilling holes, preparing surfaces, etc.), manipulating (e.g., repositioning, reorienting) components, connecting (e.g., fluidly, electrically, mechanically, etc.) components, or other tasks associated with installation. The installation configuration may be used in construction applications. By way of example, the tools 1060 may be used to install electrical conduit, sprinkler pipe, drywall, windows, solar panels, support beams, roofing material, siding, bricks, and other building materials. The installation configuration may be used in manufacturing applications. By way of example, the tools 1060 may be used to assemble automobiles, ships, aircraft, appliances, or other products.

The tools 1060 may include manipulators that facilitate engaging and supporting the components to be installed. By way of example, the manipulators may include suction cups, grabbers, graspers, claws, hooks, magnets, cradles, or other types of manipulators. The manipulators may be used in combination with the lift assembly 14 and the base assembly 12 to place the component into a desired installation position. The lift assembly 14 and the implement assembly 16 may hold the component in the desired installation position while the secondary implement assembly 16 works to secure the component in place.

The tools 1060 may include tools used to prepare an area for installation, such as drills (e.g., to form fastener holes), brushes (e.g., to prepare for the application of welding or adhesive), or applicators (e.g., for applying glue, drywall mudding compound, grout, etc.). The tools 1060 may include tools used to couple components together such as screwdrivers (e.g., to tighten fasteners), riveters, or welders. The tools 1060 may include tools for fluidly or electrically coupling components (e.g., wire strippers, electrical tape applicators, pipe solder applicators, torches, etc.).

In an image capture configuration, the sensors 1062 may include sensors that are capable of capturing image data (e.g., cameras, LiDAR sensors, ultrasonic sensors, etc.). The image data may be used to inspect buildings, bridges, automobiles, planes, ships, or other structures. By way of example, the implement controller 70 or the external device 47 may analyze the image data to identify flaws or points of interest on structures. Alternatively, the image data may be used to capture images and/or video for photography or video applications (e.g., on a movie set for filming a film or television show).

In a lighting configuration, the tools 1060 include one or more light sources that emit light. The light sources may be used to illuminate a target area or target object. In some embodiments, the sensors 1062 are used to detect when the target object has moved and adjust the position of the light source to continue illuminating the target object.

In a trimming configuration, the tools 1060 include one or more cutting implements for trimming vegetation. By way of example, the tools 1060 may include shears, a chainsaw, rotating blades, clippers, or other cutting implements. The tools 1060 may be used to cut, trim, or otherwise shape vegetation (e.g., grass, bushes, trees, etc.). By way of example, the lift assembly 14 may move a cutting implement around a tree or bush to shape the vegetation into a desired shape. By way of another example, the lift assembly 14 and the base assembly 12 may move a cutting implement along a power line to cut away tree branches in close proximity to the power line.

In a material hauling configuration or dumper configuration, the tools 1060 include a bucket or storage device. The position and orientation of the bucket may be adjusted by the base assembly 12, the lift assembly 14, and/or one or more implement actuators 62. The bucket may be configured to contain a volume of material (e.g., dirt, rocks, water, sand, etc.). The bucket may be used to transport the material and reposition (e.g., excavate, stack, dump, etc.) the material.

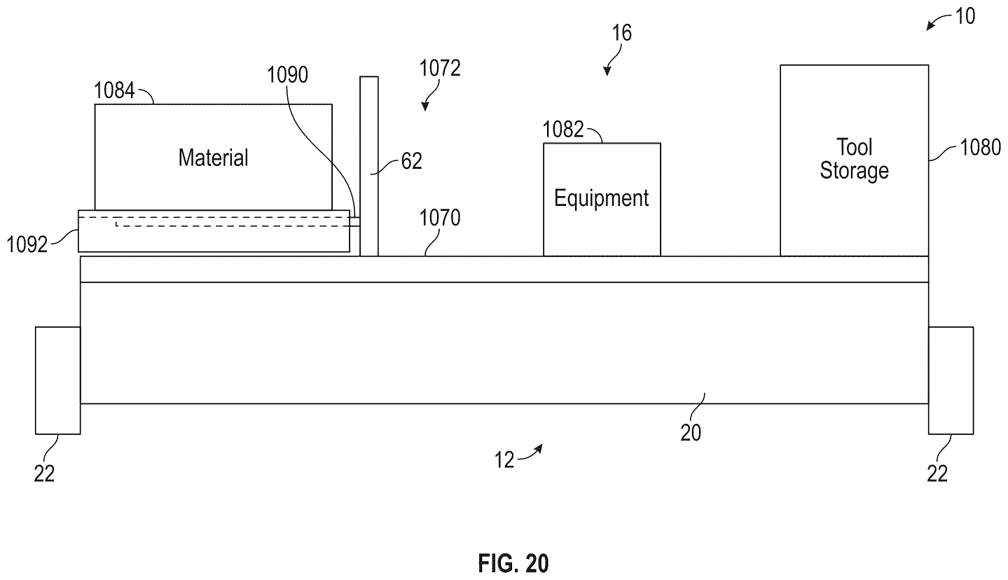

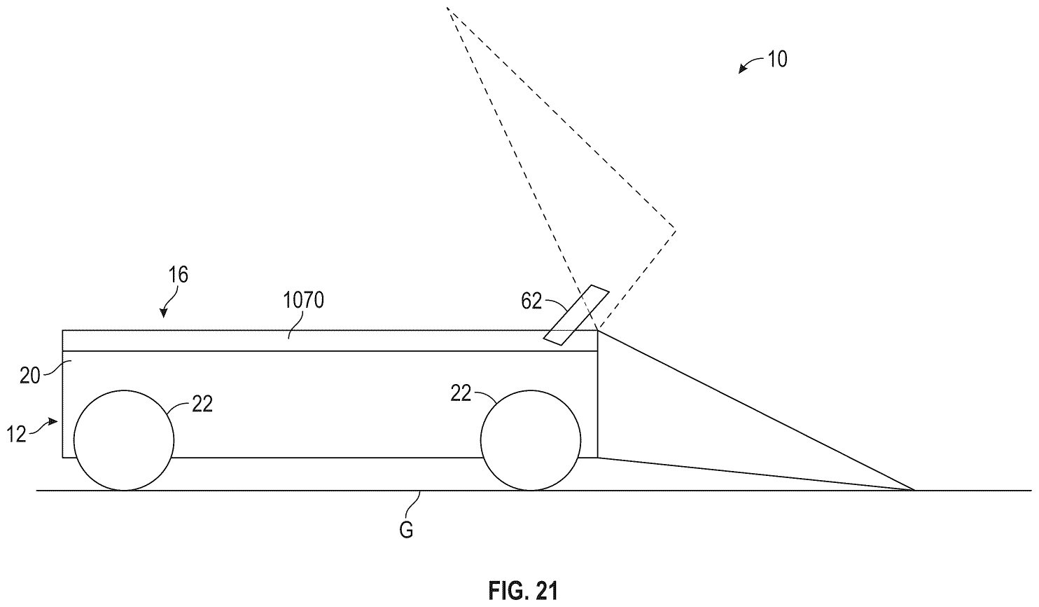

Referring to FIGS. 20 and 21, the lift device 10 is shown in a transport configuration or workbench configuration, according to an exemplary embodiment. In the lift device 10 of FIGS. 16 and 17, the implement assembly 16 includes a bench top, support, or deck, shown as deck 1070. In some embodiments, the deck 1070 extends substantially horizontally. A top surface of the deck 1070 defines a storage volume or work area, shown as work area 1072. The work area 1072 may contain material, tools, and/or equipment for transportation throughout a jobsite. The lift device 10 may facilitate moving those items to a desired destination. Additionally, the deck 1070 may act as a portable work surface for use by one or more operators (e.g., a mobile work table).

The implement assembly 16 includes a storage area or container (e.g., a toolbox, a cabinet, a basket, a shelf, etc.), shown as tool storage 1080. The tool storage 1080 may include one or more tools or implements for use by an operator. By way of example, the tool storage 1080 may contain hand tools (e.g., portable drills, screwdrivers, clamps, vices, hammers, wrenches, wire strippers, etc.). By way of another example, the tool storage 1080 may include tools fixed to the deck 1070 (e.g., vices, band saws, drill presses, lathes, etc.). The tool storage 1080 may contain one or more tools controlled by the implement controller 70 (e.g., a computer numeric control (CNC) mill, a robotic arm, etc.).

The work area 1072 may contain one or more pieces of equipment, shown as equipment 1082. The equipment 1082 may include vehicles and work equipment (e.g., buses, airplanes, automobiles, construction equipment, train cars, lift devices such as scissor lifts or boom lifts, firetrucks, military vehicles, delivery vehicles, refuse vehicles, concrete mixing trucks, etc.). The equipment 1082 may include other products, such as windmill blades. The lift device 10 may transport the equipment 1082 to a desired destination. By way of example, the lift device 10 may transport one or more vehicles from a staging area (e.g., a loading dock) to a jobsite where the vehicles will be used. The vehicles may then be driven off of or otherwise removed from the deck 1070 and placed on a ground surface G. Additionally or alternatively, the lift device 10 may support the equipment 1082 while the equipment 1082 is being assembled or maintained. By way of example, the lift device 10 may be an automated mobile robot that transports a vehicle throughout a factory where the vehicle is assembled. The vehicle may start as a frame and gradually be assembled. By way of another example, the lift device 10 may support a vehicle while the vehicle has an oil change or other maintenance operation performed.

The implement assembly 16 may store and/or support material 1084 for use at a jobsite. The material 1084 may be consumed while performing a task. By way of example, the material 1084 may include building materials (e.g., electrical conduit, sprinkler pipe, drywall, windows, solar panels, support beams, roofing material, siding, bricks, wire, insulation, wood, etc.) or materials used in manufacturing (e.g., raw materials such as metal or plastic, fasteners, lubricants, fuels, etc.). Beneficially, the lift device 10 may transport the material 1084 to a desired location where the material 1084 will be used. This transportation may be performed autonomously, such that an operator is not required to pause a task to retrieve additional material.

As shown in FIG. 20, the implement assembly 16 includes a lift interface, shown as pallet forks 1090, that are configured to selectively engage a support structure, shown as pallet 1092. The pallet forks 1090 may be lifted relative to the deck 1070 by an implement actuator 62. As shown, the pallet 1092 supports the material 1084. Accordingly, the implement actuator 62 may engage the pallet forks 1090 with the pallet 1092 and lift the pallet forks 1090 to bring the material 1084 and the pallet 1092 onto the deck 1070. Other pallets 1092 may be used to transport tools and/or equipment 1082. Accordingly, the pallet forks 1090 may facilitate lifting material, tools, and equipment onto the deck 1070 for transport.

Referring to FIG. 21, the implement assembly 16 includes a deployable ramp assembly, shown as ramp 1094. The ramp 1094 is movably coupled to the deck 1070 and repositionable between a stored position (shown in dashed lines) and a deployed position (shown in solid lines) by an implement actuator 62. Specifically, the ramp 1094 is shown to be pivotable about a lateral axis between the stored position and the deployed position. In the deployed position, the ramp 1094 extends from the deck 1070 to a position near the ground surface G. The ramp 1094 may provide a sloped surface that facilitates rolling tools, equipment 1082, and/or material 1084 onto the deck 1070. In the stored position, the ramp 1094 may be elevated to prevent intended contact with the ground surface G while the lift device 10 is driving.

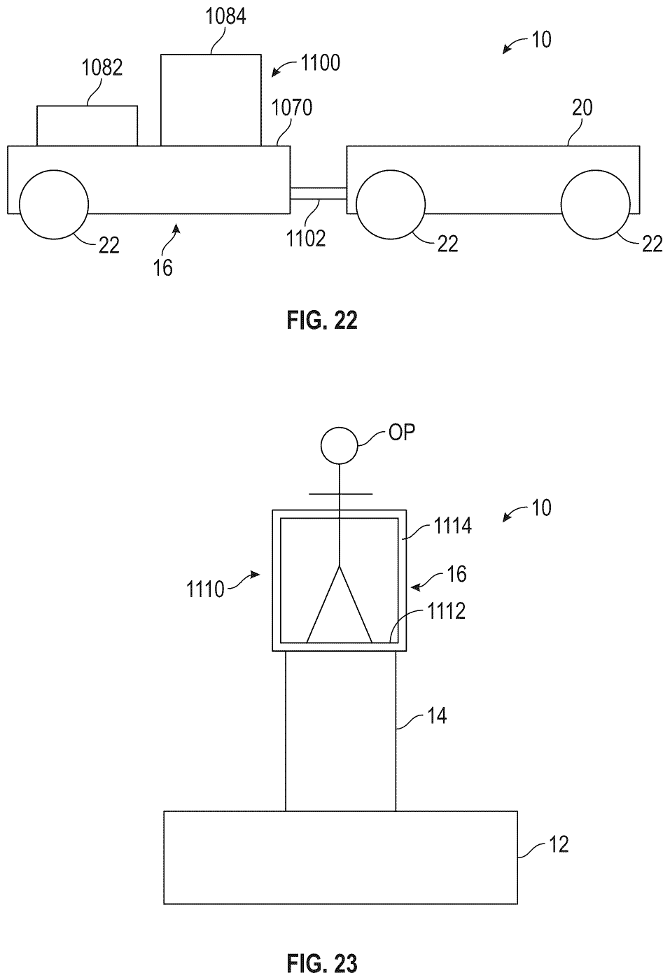

Referring to FIG. 22, implement assembly 16 of the lift device 10 includes a trailed implement, shown as trailer 1100. The trailer 1100 may provide an additional deck 1070 to support more tools, equipment 1082, and/or material 1084. The trailer 1100 may include a plurality of tractive elements 22 to support the trailer 1100. The trailer 1100 is coupled to the chassis 20 of the base assembly 12 by a coupler or trailer hitch, shown as hitch 1102. The hitch 1102 may permit the trailer 1100 to pivot relative to the chassis 20 to facilitate turning. In some embodiments, the trailer 1100 is coupled to the vehicle 10 of FIG. 20, such that FIGS. 20, 21, and 22, all represent a single embodiment.

Referring to FIG. 23, the lift device 10 is configured in a personnel transport or personnel lift (e.g., a scissor lift, a vertical mast lift, a boom lift, a fire truck, etc.). The implement assembly 16 includes a work platform, basket, cockpit, or operator area, shown as work platform 1110. The work platform 1110 includes a support platform, shown as operator platform 1112, and a railing assembly, shown as railing 1114. The operator platform 1112 extends substantially horizontally and supports an operator OP. The railing 1114 extends upward from the operator platform 1112 and surrounds the operator platform 1112, providing an enclosed space for the operator OP to stand. Accordingly, the lift device 10 may support, lift, and transport the operator OP to a desired position.

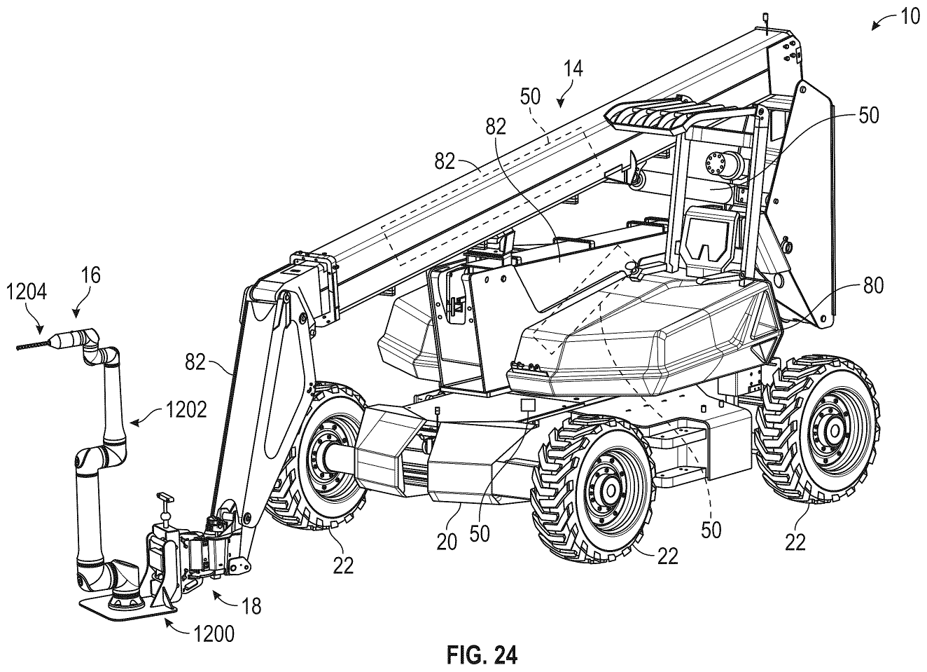

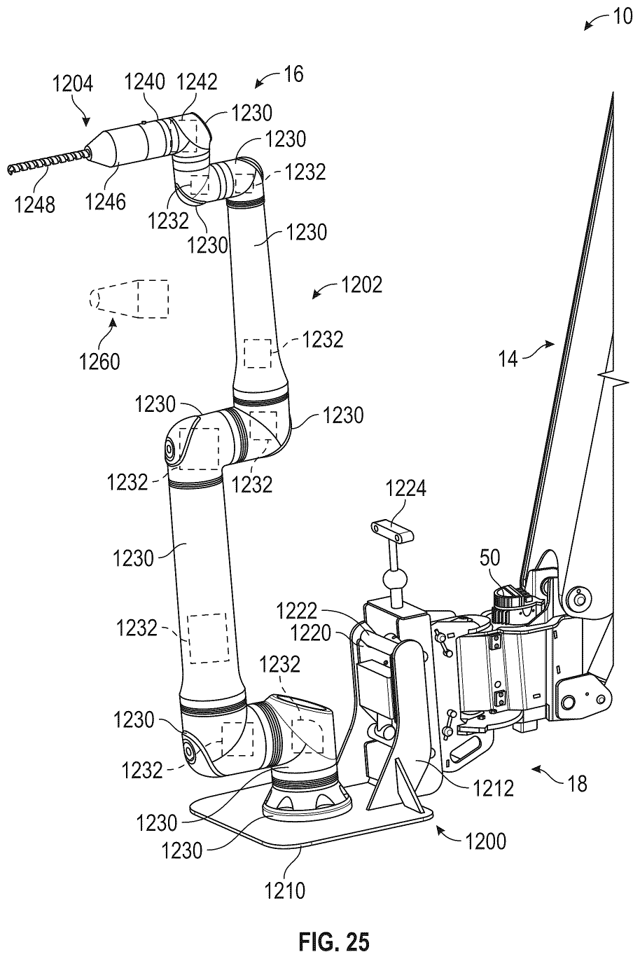

Referring to FIGS. 24 and 25, the lift device 10 is configured as a boom lift. As shown in FIG. 24, the lift assembly 14 of the lift device 10 includes a rotating portion, shown as turntable 80, and a series of movable portions or boom members, shown as boom sections 82. The turntable 80 is rotatably coupled to the chassis 20. A first lift actuator 50 (e.g., a turntable actuator) is configured to cause the turntable 80 to rotate relative to the chassis 20 about a substantially vertical axis. The boom sections 82 extend between the turntable 80 and the implement interface 18. A first boom section 82 is pivotally coupled to the turntable 80, and one of the lift actuators 50 causes the first boom section 82 to rotate relative to the turntable 80. A second boom section 82 is coupled to the implement interface 18. The other boom sections 82 extend between the first and second boom sections 82. The lift actuators 50 cause the boom sections 82 to rotate and/or translate (e.g., telescope) relative to one another to reposition the implement interface 18 relative to the turntable 80. A lift actuator 50 (e.g., a platform rotator) near a distal end of the lift assembly 14 causes the implement interface 18 to rotate relative to the uppermost boom section 82 about a substantially vertical axis.

Referring to FIGS. 24 and 25, the lift device 10 is coupled to and supports an

implement assembly 16. The implement assembly 16 includes a coupling portion or base frame, shown as implement frame 1200, an articulated arm, lift assembly, or robotic arm, shown as arm 1202, and an implement 60 or tool, shown as drill 1204. The implement frame 1200 is removably coupled to the lift assembly 14 through the implement interface 18. The arm 1202 extends upward from the implement frame 1200 and couples the drill 1204 to the implement frame 1200. The arm 1202 may reposition the drill 1204 to a desired position. The drill 1204 is configured to perform a task (e.g., drilling holes). The lift device 10 is shown including a lift assembly 14 configured as an articulated arm or robotic arm, according to an exemplary embodiment. The lift assembly 14 includes of pivoting members or arm stages, shown as arm members 1050. The arm members 1050 are generally connected to one another end-to-end at a series of arm joints 1052. The arm members 1050 may pivot relative to one another about the arm joints 1052 as controlled by a series of lift actuators 50. Each lift actuator 50 may control rotation at one of the arm joints 1052. Each arm joint 1052 may permit rotation about a different axis of rotation such that the lift assembly 14 may move the implement assembly 16 to any desired position and desired orientation within a range of motion of the lift assembly 14.

### Visual Communication of Commands to Work Machine

Referring generally to the figures, autonomous and semi-autonomous work machines (e.g., lift devices, vehicles, etc.) may be used at a worksite. To facilitate the autonomous or semi-autonomous operation of the work machines, visual indicators including commands may be positioned throughout the worksite, either by a user or by a separate autonomous and/or semi-autonomous work machine. Each work machine includes one or more sensors (e.g., cameras) to identify the visual indicators in the workspace. The work machine then determines the command represented by the visual indicator and automatically operates based on the command. Beneficially, providing commands to the autonomous and/or semi-autonomous vehicles via the visual indicators allows an operator to provide a command with out the need for to select a specific work machine to carry out the command, allows an operator to quickly leave a plurality of commands in predetermined locations for a plurality of work machines to detect and operate according to, and otherwise facilitates interaction between the autonomous and/or semi-autonomous work machines and a user through a simpler human machine interface and without the need for a user to operate a remote device wirelessly coupled to each of the work machines. In some embodiments, each work machine includes an implement assembly (e.g., welding assembly, painting assembly, sandblasting assembly, etc.), and one or more sensors to detect the visual indication. In some embodiments, each work machine, after detecting a visual indicator determines, either with reference to an internal database or a remote database, whether the work machine should implement the command represented by the visual indicator.

### Communication of Visual Indicators

The lift device 10 may perform autonomous or semi-autonomous functions. The lift device 10 may drive, move, turn, reverse, move the lift assembly 14 or control the implement 16 (e.g., lift, translate, pivot, rotate, etc.), or perform any other function or carry out a task autonomously or semi-autonomously. Visual commands may be provided to guide the lift device 10 through visual indicators positioned around a worksite. As shown in FIG. 9, the lift device 10 includes the one or more sensors 300 with a field of view (FOV) 301 to read (e.g., observe, scan, register, detect etc.) visual commands within a worksite or other location. The sensors 300 are configured to send and receive information (e.g., data, commands, signals, etc.) with the communication interface 46. While the following description is with reference to the communication interface 46, it should be understood that the sensors 300 may additionally and/or alternatively communicate in the same way with the communication interface 76. The sensors 300 may communicate with the communication interface 46 through a wired connection (e.g., a CAN bus, an ethernet connection, etc.) and/or wirelessly (e.g., using Bluetooth, radio, Wi-Fi, cellular networks, etc.). The sensors 300 and the communication interface 46 may communicate with the other components of the lift device 10. The sensors 300 and the communication interface 46 may also communicate with components outside of the lift device 10 (e.g., user devices such as smartphones or laptops, networks such as the Internet, servers, etc.).

Still referring to FIG. 9, a visual indicator 302 may be used to direct or guide the lift device 10. The visual indicator 302 visually represents one or more commands which can be read by the lift device 10. The visual indicator 302 may one of a plurality of different types of visual indicators. For example, the visual indicator 302 may be paint or other coloring, chemicals or other substances (e.g., soap, etc.), light (e.g., a laser pointer, a spotlight, a colored light, etc.), a sticker or other adhesive, a marking (e.g., a shape, a symbol, a letter, a number, a word, a picture, etc.), a scannable tag (e.g., a quick-response (QR) code, an AprilTag, etc.), a code, etc. In some embodiments, multiple visual indicators of different types are positioned within a worksite. The visual indicator 302 may be placed manually by a user or autonomously or semi-autonomously by a work machine 10 equipped with an indicator applier 320 (e.g., printer, paint sprayer, marker, applier, etc.). For example, an operator may place the visual indicator 302, or the lift device 10 or another machine or device such as work machine 10 may place the visual indicator 302 in a location (e.g., on a wall, on the floor, on a surface, etc.) or near a location indicating work needing to be performed (e.g., indicating an object, a target, etc.).

The lift device 10 is configured to use sensors 300 to detect a visual indicator and then lift device 10 determines if the lift device 10 should follow the one or more commands, and if so, operate autonomously based on the one or more commands. The lift device 10 may determine if a command is intended for the lift device 10 based on one or more aspects of the visual indicator (e.g., shape, size, color, location, symbol, etc.), the content of the command, and/or with reference to an internal or remote database. As shown in FIG. 9, the lift device 10 detects a first visual indicator 302 and a second visual indicator 304 within the FOV 301 of the lift device. A third visual indicator 306 is outside the FOV of the sensors 300 of the lift device 10 and is not detected.

The visual indicator 302 may contain the one or more commands, or the visual indicator 302 may point to an external data source (e.g., a website, a database entry ID, etc.) where commands are stored. The visual characteristics of the visual indicator 302 may indicate the command or type of function to be performed by the lift device 10, as well as a location or other details of work to be performed (e.g., the visual indicator 302 may be a set of coordinates, the visual indicator 302 may communicate a size or shape of a target, the visual indicator 302 may act as a positional registration mark, etc.). The command or type of function to be performed may also be based on a shape, color, reflectivity, etc. of the visual indicator 302. In some embodiments, the visual indicator 302 may be directionary (e.g., the lift device 10 is configured to follow the visual indicator). In such embodiments, the lift device 10 is configured to keep one or both of a minimum or maximum distance to the visual indicator. For example, the visual indicator may be a laser pointer controlled by a user, and the lift device 10 is configured to follow the laser pointer and keep within a maximum distance from the laser pointer, such that as the laser pointer moves away from the lift device 10, the lift device follows it. The lift device 10 may also be configured to seek to maintain a minimum distance to the laser point, e.g., 1 inch, 6 inches, 1 foot, etc.

The work machine 310 of FIG. 3 may include a control circuit or processing circuit, shown as controller 312. The controller 312 is operatively coupled to (e.g., in communication with) components of the work machine 310 and the controller 312 may control operation of the components of the work machine 310 directly or indirectly. The controller 312 includes a processor 314 and a memory device, shown as memory 316. The memory 316 is configured to store instructions thereon that, when executed by the processor 314, cause the controller 312 to perform the various functions described herein. The controller 312 further includes a network interface, shown as communication interface 318. The communication interface 318 is configured to send and receive information (e.g., data, commands, signals, etc.). The communication interface 318 may communicate through a wired connection (e.g., a CAN bus, an ethernet connection, etc.) and/or wirelessly (e.g., using Bluetooth, radio, Wi-Fi, cellular networks, etc.). The communication interface 318 may communicate with the other components of the work machine 310. The communication interface 318 may communicate with components outside of the work machine 310 (e.g., user devices such as smartphones or laptops, networks such as the Internet, servers, etc.).

Referring still to FIG. 9, the work machine 310 has applied the second visual indicator 304 to a wall, surface, or object shown as wall 330 at a worksite. In some embodiments, a user such as user 350 may apply the indicator 304 to the wall 330. The second visual indicator may be any shape or of any type (e.g., an X shape, a swatch of paint, a section indicating the lift device 10 should fill in the rest of the wall, etc.). The second visual indicator 304 represents a command to pain the wall 330. The second visual indicator 304 may have a color, and the color may correspond to the color in which the wall must be painted. In some embodiments, the second visual indicator 304 may be an indication-specific color wherein the color signifies a general command to paint without referring to a color paint which must be used. After the second visual indicator 304 has been placed on the wall 330, the lift device 10 autonomously moves to a position adjacent to or near the wall 330. The sensors 300 of the lift device 10 may observe and process the second visual indicator 304 and may thereby receive the command to paint the wall. The implement assembly 16 of the lift device 10 may be outfitted with the necessary painting supplies prior to moving into a position to observe the second visual indicator 304, such that once the second visual indicator 304 is processed and the command to paint is received, the lift device 10 may begin to paint the wall. In another example, upon observation and processing of the second visual indicator 304 and receiving the command to paint the wall, the lift device 10 may then proceed to a station to connect to an appropriate implement assembly 16 for the task indicated in the command. In some embodiments, there are a plurality of implement assemblies 16 at a worksite for the lift device 10. The lift device 10 is configured to select at least one implement assembly 16 from the plurality of implement assemblies 16 based on the command represented by the visual indicator (e.g., second visual indicator 304) to operate according to the command. In some embodiments, the lift machine 10 uses more than one lift assembly 16 to carry out a command.

In other embodiments, the visual indicator 302 may be an object. For example, the visual indicator may be a bar of soap (e.g., soap, liquid soap, soap powder, colored soap, cleaning solution, chemical cleaner, etc.). The lift device 10 detects the soap with the sensors 300 and determines the command represented by the soap is to clean the surface the soap is placed on. In some embodiments, the lift device 10 determines the command with reference to an internal and/or external database, shown as database 340, which includes a command for each visual indication detected by the lift device 10. The database 340 can be periodically updated to change the command associated with a particular visual indicator. In some embodiments, the command associated with a particular visual indicator is changed after a predetermined period of time has elapsed. In some embodiments, the command is changed after a work machine queries the database 340 for the command, such that once a command is distributed to a work machine once, the next work machine detecting the visual indicator and requesting the command associated with the visual indicator from the database is provided with a new, different command. In some embodiments, the command associated with the visual indicator is dependent on one or more characteristics of the work machine 10 requesting the command (e.g., type, size, location, implement assembly attached, etc.) or another factor (e.g., time of day, location of indicator, number of times indicator has been scanned, etc). Returning again to the soap example upon observation and processing of the visual indicator 302, the lift device 10 queries the database 340 for the command associated with the soap visual indicator and receives the command to clean the surface. The lift device 10 may begin to clean the surface, or may proceed to a station to receive the necessary cleaning supplies (e.g., implement assembly 16) before returning to the surface to begin cleaning. In some embodiments, the visual indicator 302 may be, for example, drywall mud (e.g., joint compound, gypsum mixture, plaster, etc.) placed (e.g., smeared, applied in a shape or pattern, etc.) on a wall requiring drywalling. Upon observation and processing of the visual indicator 302, the lift device 10 receives the command to perform drywalling on the wall. The lift device 10 may begin to drywall the wall, or may proceed to a station to receive the necessary drywalling supplies before returning to the wall to begin drywalling. Accordingly, the visual indicator may be an object which is consumed by the work machine 10 operating under the command. In some embodiments, therefore, the visual indicator is removed by the work machine 10 after the work machine 10 has completed the command represented by the visual indicator (e.g., painted over, consumed, destroyed, etc.).

The implement assembly 16 may be any implement necessary for performing a function (e.g., step, task, job, etc.). The implement interface 18 is configured to couple various types of implements to the lift device 10, such that the implement assembly 16 coupled to the lift device 10 may be configurable or customizable depending upon the function needed to be performed by the lift device 10. For example, the implement assembly 16 may be a painting assembly, a cleaning assembly, a drywalling assembly, a sandblasting assembly, a maintenance or repair assembly, a deconstruction assembly, etc. The implement interface 18 may pass data (e.g., electrical signals), electrical energy, hydraulic fluid, compressed gas, or other signals between (a) the base assembly 12 and the lift assembly 14 and (b) the implement assembly 16 to power or control the implement assembly 16. The data or signals may include one or more commands received by the lift device 10 upon observation and processing of the visual indicator 302 by the sensors 300 of the lift device 10.

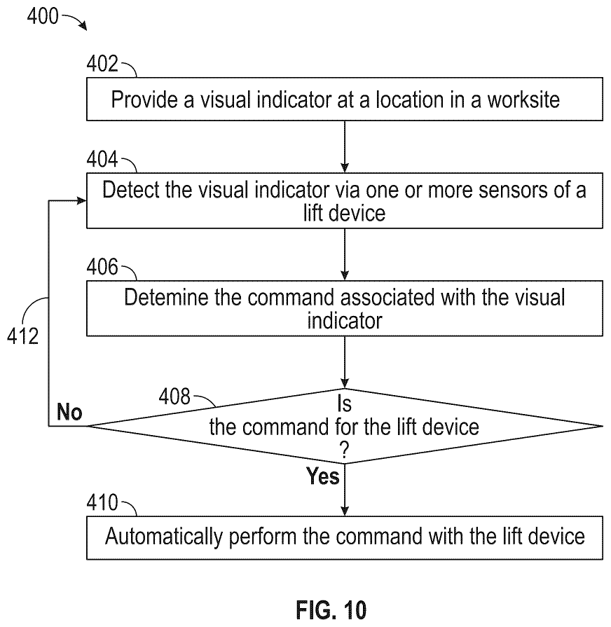

Referring now to FIG. 10, a process 400 for a lift device (e.g., lift device 10) detecting a visual indication and operating according to a command represented by the visual indication is shown. At step 402, a visual indicator is provided at a worksite. The visual indicators 302 may be placed in predetermined locations based on the function to be performed (e.g., the target of the work, etc.). More than one type of the visual indicators 302 may be in use at the same time. For example, in a worksite, a floor may need to be painted, a work surface may need to be cleaned, and a wall may need to be drywalled. The indication system may paint an X shape on the floor, pour cleaning solution on the work surface, and smear drywall mud on the wall.

In some embodiments, the visual indicator is provided by a user (e.g., user 350). In some embodiments, the visual indicator is provided by a work machine (e.g., work machine 310). The work machine provided the visual indicators may include an indicator applier configured to apply the indicator to one or more surfaces in the worksite. In some embodiments, the work machine providing the visual indicator is autonomous. In some embodiments, the work machine is controlled by a user. Beneficially, by controlling the work machine to provide the visual indicators representing one or more commands, a user need only interface, connect to, and interact with a single work machine, but can control or direct the activities of multiple work machines who detect the visual indicator. This can help to recue the amount of data that a user must send, the power consumed by a remote device of the users communicating with the work machine, etc. In some embodiments, a worksite may be fully or partially autonomous.

At step 404, the lift device operating in the worksite detects the visual indicator via one or more sensors of the lift device. The lift device 10 may roam the worksite autonomously, searching for any of the visual indicators 302. Once the lift device 10 locates one of the visual indicators 302, the sensors 300 of the lift device 10 may process the visual indicator 302 to receive the assigned command and perform the function directed by the command. In some embodiments, more than one of the lift devices 10 may be in use at the same time. Each of the lift devices 10 may utilize a different implement assembly 16 and may detect a different visual indicator. In some embodiments, one or more lift devices 10 may detect the same visual indicator.

At step 406, the lift device determines the command associated with the visual indicator. The command may include instructions and/or requirements. The instructions may include movement instructions, task instructions, position instructions, etc. The requirements may include a work machine type requirement, an implement assembly type requirement, a time of day requirement, a location requirement, an autonomous requirement, a semi-autonomous requirement, etc. For example, each type of lift device 10 may be assigned to a different type of visual indicator 302. For example, one of the lift devices 10 may have a implement assembly 16 including painting assembly and may be assigned to commands associated with a paint symbol.

At step 408, the lift device determines if the command is for the lift device. In some embodiments, the lift device 10 references an internal lookup table or database to determine if the command is a command for the lift device 10. In some embodiments, the lift device 10 references an external database such as database 340.

If the lift device 10 determines the command is not for the lift device 10, then along path 412 the process 400 returns to step 404 for the lift device 10 to detect another visual indicator in the work site. For example, when each type of lift device 10 is associated with a different command, when the lift device 10 detects a visual indicator representing a command for a different type of lift device 10, the lift device 10 can ignore the command and proceed with its previously determine actions. For example the lift device 10 including the painting assembly may roam the worksite, only in search of the visual indicators 302 having a command to paint (e.g., a painted X shape, a paint swatch, etc.). The lift device 10 including the painting assembly may roam the worksite and ignore the work surface needing cleaning having the visual indicator 302 comprising the poured cleaning solution, as well as ignore the wall needing drywalling having the visual indicator 302 comprising the smear of drywall mud. If the lift device 10 determines the command is for the lift device 10, the lift device 10 proceeds to step 410 to automatically perform the command represented by the visual indicator. For example the lift device 10 including the painting assembly may continue to roam the worksite until the visual indicator 302 comprising the painted X shape on the floor is found by the sensors 300 of the lift device 10. The lift device 10 including the painting assembly may then proceed to paint the floor. Other of the lift devices 10, one or more each including a cleaning assembly and a drywalling assembly, may also roam the worksite in search of the visual indicator 302 comprising the poured cleaning solution and the visual indicator 302 comprising the smear of drywall mud, in order to receive the respective commands to the corresponding lift device 10 to clean the work surface and drywall the wall.

In other embodiments, one or more lift devices 10 may be in use, wherein each of the lift devices 10 is configured for a general purpose and can be outfitted for any function or task. For example, one of the lift devices 10 may be employed in a worksite and may be tasked with searching for any of the visual indicators 302. Upon location of one of the visual indicators 302, for example, the X shape painted on the floor needing to be painted, the lift device 10 may process the visual indicator 302 and receive the command to paint the floor. The lift device 10 may then proceed to a station to be outfitted with a painting assembly, before returning to paint the floor. After painting the floor, the lift device 10 may continue to roam about the worksite in search of other of the visual indicators 302. The sensors 300 of the lift device 10 may locate a different one of the visual indicators 302, for example, the poured cleaning solution on the work surface needing to be cleaned. The lift device 10 may then proceed to a station to be outfitted with a cleaning assembly, before returning to clean the work surface.

In addition to location information, the visual indicators 302 may provide further detail on the task to be performed by the lift device 10. For example, a machine having a printer may move around a worksite (e.g., work machine 310). The work machine 310 may move to predetermined locations where work needs to be performed. The work machine 310 may paste a QR code on a wall. When the sensors 300 of the lift device 10 scans the QR code, the lift device 10 receives a command to cut a hole in the wall, including a size, shape, and position of the hole. As another example, the QR code may comprise instructions to sandblast a particular area or object, and may include the dimensions and positioning of the area or the shape and location of the object.

In some embodiments, the lift device 10 may be configured for a particular purpose to perform a specific task. For example, the lift device 10 may be configured for maintenance or repair and may be coupled to a tool assembly. At a worksite, one or more of the visual indicators 302 may comprise a laser light pointed at an object (e.g., a machine, etc.). The sensors 300 of the lift device 10 may observe the laser light, process the visual indicator 302, and receive a command to perform maintenance on the object. The lift device 10 may proceed to perform predetermined, specified, or general maintenance on the object (e.g., change a part, tighten a screw, conduct a performance check, etc.).

### Operator Ride Along

Referring generally to the figures, a work machine can be configured for automated, or semi-automated, operation, including operation that is substantially automated while still receiving input from a user to the work machine, which may control the operation of the work machine, or upon which the operation of the work machine may be based.

Stated differently, a work machine can be a partially autonomous work machine, which may include an extendable implement and may support an operator of the work machine. The work machine may be configured to permit operation of the work machine (and the implement), with certain aspects of its operation controlled autonomously, and/or without direct user input, while one or more other aspects of its operation may be controlled based on user input(s) (e.g., by an operator of the work machine). In some embodiments, the work machine can operate one or more implements (as described below) autonomously while one or more additional implements are operated (e.g., simultaneously) by a user (e.g., an operator of the work machine). In some embodiments, the work machine can operate one or more implements autonomously according to first operation criteria, receive user input, and may further operate autonomously according to second operation criteria, which are based on the received user input.

### Semi-Autonomous Work Machine

Referring generally to the figures, a work machine 10 can be configured for automated, or semi-automated, operation, including operation that is substantially automated while still receiving input from a user, which may control the operation of the work machine 10, or upon which the operation of the work machine 10 may be based. Stated differently, a work machine 10 can be a partially autonomous work machine, which may include an extendable implement (e.g., implement assembly 16) and a user support (e.g., a platform for an operator of the work machine 10). The work machine 10 may be configured to permit operation of the work machine 10 (and/or the implement 60) with certain aspects of its operation controlled autonomously, and/or without direct user input, while one or more other aspects of its operation may be controlled based on user input(s) (e.g., by an operator of the work machine). In some embodiments, the work machine can operate one or more implements (as described below) autonomously while one or more additional implements are operated (e.g., simultaneously) by a user (e.g., an operator of the work machine). In some embodiments, the work machine can operate one or more implements autonomously according to first operation criteria, receive user input, and may further operate autonomously according to second operation criteria, which are based on the received user input. In some embodiments, the work machine can operate the base assembly autonomously while a user can operate the lift assembly and/or the implement assembly manually.

In some embodiments, a work machine 10 supports an operator, or user, and may be configured to permit hybrid operation of the work machine 10, which may include a mix of both autonomous operation of the work machine 10 and operation based on one or more inputs from the user to directly control one or more aspects of the work machine 10 and/or its operation (e.g., operation of implement 60).

For example, in some embodiments, the work machine 10 may autonomously operate the lift assembly 14 and the implement interface 18 according to first operation criteria (e.g., to raster the position of a user support platform across a vertical surface and allow a user (e.g., a user located proximate to an implement) to operate a pressure washer, paint sprayer, or other implement 60, as the user support platform, and/or lift assembly 14, is moved by the work machine 10) (e.g., a first mode of operation).

In some embodiments, the work machine 10 can be operated in the first mode of operation (e.g., a hybrid manual-autonomous mode) in which the work machine 10 autonomously performs one or more portions of an overall action to be completed, while other portions of the overall actions are performed by a user. For example, any of the implement controller 70, the implement controller 670, the base controller 40, or the base controller 640 can operates the lift assembly 614 (e.g., the lift actuators 650) such that the implement assembly 616 is moved along a predetermined path, at a predetermined speed, and dwells at predetermined points for a specific amount of time. The movement of the implement assembly 616 provides a first portion of an overall action, while a user can operate one of a first implement 660A or a second implement 660B to perform another portion of the overall action. In a first example, the overall action may be a painting action and the implement assembly 616 or the implement assembly 16 can be swept in a back and forth motion (e.g., left to right or up and down) and upwards and downwards (or left to right) at ends of the sweep such that a user can apply paint by operating the implement 60. Likewise, for a pressure washing operation, the implement assembly 616 can be swept in the back and forth motion along the predetermined path, but at a different speed, or with different dwell times at locations identified to require additional cleaning. Similarly, for a welding operation, the predetermined path may follow a specific joint that requires welding at a slower speed such that the user can lay a weld to join two pieces of metal by operating the implement 60 (e.g., a welder). It should be understood that the various autonomous sweeping operations described herein (e.g., the movements of the implement assembly 16 or the implement assembly 616 along the predetermined path) can be initiated by the user via a user interface. Further, the user may adjust various parameters (e.g., the path, the speed at which to travel along the path, dwell times at various locations, etc.) as desired for the overall action. In some embodiments, the predetermined path, the speed at which to traverse the predetermined path, the dwell times, and at which locations to dwell are preset for specific operations and the user can select the overall action (e.g., welding action, painting action, cleaning action, etc.) via a user interface of the lift device 10.

In another example, the work machine 10 may be configured to operate the implement 60 and/or the lift assembly 14 together (e.g., to perform a task, such as painting a vertical surface) while a user is located on the ground and/or is not otherwise proximate to the implement 60 as it is autonomously operated by the work machine 10 (e.g., a second mode of operation). For example, the work machine 10 may automatically perform a task via the implement 60 and may present one or more aspects of the performed task (e.g., a painted surface) to the user for user review and/or related user input(s). The user may, as a result of the information presented by the work machine 10, provide one or more inputs that may be used to further operate the work machine 10, lift assembly 14, and/or implement 60 (e.g., to re-paint one or more user-identified portions of a previously painted vertical surface).

In some examples, the work machine 10 may perform a portion of a task, or operate according to one or more parameters, and the user (e.g., operator) may monitor the operation of the work machine 10, including work performed by the implement 60 (e.g., a third mode of operation). The user may identify when the work machine 10, and/or the implement 60, does not operate as intended or a modification in the operation of the work machine 10 is otherwise desirable (e.g., to skip painting of one or more portions of a surface and/or to re-paint one or more portions of a surface that may have been missed or where an insufficient amount of paint has been applied by the implement 60). The user may instruct the work machine 10 (e.g., provide, via user interface 78, one or more user inputs to the work machine 10) to repeat one or more operations (or portions thereof) and/or may flag a task for the user to complete manually (e.g., create a ticket or note in a work tracking system and/or to pause operation of the work machine 10 to manually operate the implement 60 at substantially the same time a defect is identified).

Additionally, in some embodiments, the work machine 10 can be configured to autonomously inspect a surface or other aspect of a worksite (e.g., a fourth mode of operation). During an inspection the work machine 10 may identify, via implement sensors 64 and/or one or more controllers (e.g., implement controller 70 and/or base controller 40) one or more potential defects to be presented to a user for review. Stated differently, in some examples, the work machine 10 performs an automatic inspection of a surface (e.g., completing one or more pre-programmed inspection routines, etc.), and a user reviews any potential defects identified by the machine (e.g., as information presented to the user via user interface 78). The automated inspection performed by the work machine 10 can reduce an operator's workload (e.g., reduce the number of tasks performed manually at a jobsite by one or more users) and may allow the users to focus on other aspects of a jobsite where user input (e.g., specialized efforts of a user) are needed.

FIG. 11 is an example method 500 for operating a semi-autonomous work machine, according to one embodiment of the present disclosure. The method 500 can be performed by at least the implement controller 70 and/or base controller 40 of the system work machine 10 depicted in FIG. 1, but is not limited thereto. In some implementations, one or more of the steps of the method 500 may be performed by a different processor, server, or any other computing device (e.g., a user devices and/or remote devices). For instance, one or more of the steps may be performed via a cloud-based service including any number of servers, which may be in communication with a processor of the work machine 10 and/or an associated control system.

Although the steps are shown in FIG. 11 having a particular order, the steps may be performed in any order. In some instances, some of these steps may be optional. The method 500 may be executed to improve the operation of one or more vehicles, including vehicles operating autonomously, and/or semi-autonomously, within a manufacturing environment.

In some implementations, the method 500 can include operating a partially autonomous work machine (e.g., work machine 10), which can include one or more sensors (e.g., implement sensors 64), an extendable implement (e.g., implement 60, including implement interface 18 and lift assembly 14), a support platform (e.g., a platform or user support included in implement assembly 16 and/or lift assembly 14) physically coupled to the extendable implement, a display (e.g., user interface 78) coupled to the support platform, and a control system (e.g., implement controller 70 and/or base controller 40).

Some implementations of the method 500 can include operating 510 the extendable implement according to one or more first operation criteria. For example, in some embodiments, the work machine 10 may autonomously operate the lift assembly 14 and the implement interface 18 according to first operation criteria (e.g., movement pattern, task instructions, to raster the position of a user support platform across a vertical surface and allow a user (e.g., a user located proximate to an implement) to operate a pressure washer, paint sprayer, or other implement 60, as the user support platform, and/or lift assembly 14, is moved by the work machine 10).

In another example, the work machine 10 may be configured to operate the implement 60 and/or the lift assembly 14 together (e.g., to perform a task, such as painting a vertical surface) while a user is located on the ground and/or is not otherwise proximate to the implement 60 as it is autonomously operated by the work machine 10. For example, the work machine 10 may automatically perform a task via the implement 60 and may present one or more aspects of the performed task (e.g., a painted surface) to the user for user review and/or related user input(s). The user may, as a result of the information presented by the work machine 10, provide one or more inputs that may be used to further operate the work machine 10, lift assembly 14, and/or implement 60 (e.g., to re-paint one or more user-identified portions of a previously painted vertical surface).

Some implementations of the method 500 can include receiving 520 sensor data from the one or more sensors, wherein the sensor data is indicative of work performed by the extendable implement. For example, in some embodiments, the work machine 10 can be configured to autonomously inspect a surface or other aspect of a worksite. During an inspection the work machine 10 may identify, via implement sensors 64 and/or one or more controllers (e.g., implement controller 70 and/or base controller 40) one or more potential defects to be presented to a user for review. Stated differently, in some examples, the work machine 10 performs an automatic inspection of a surface (e.g., completing one or more pre-programmed inspection routines, etc.), and a user reviews any potential defects identified by the machine (e.g., as information presented to the user via user interface 78). The automated inspection performed by the work machine 10 can reduce an operator's workload (e.g., reduce the number of tasks performed manually at a jobsite by one or more users) and may allow the users to focus on other aspects of a jobsite where user input (e.g., specialized efforts of a user) are needed.

Some implementations of the method 500 can include providing 530 via the display, information to a user, the information based on the sensor data. For example, as described previously, in some embodiments the work machine 10 may present (e.g., via the user interface 78) one or more potential defects, or other areas of interest, at a worksite to a user for review (e.g., displaying one or more irregularities detected in a surface painted by an autonomously operating work machine 10). The information presented to the user may be substantially similar to the information collected by the one or more sensors of the work machine 10. Alternatively, or in addition, the information presented to the user may be a refined and/or processed version of the sensor data, including, for example, one or more images, one or more coordinates, and/or an average quality score for a particular task performed by an autonomous work machine 10.

Accordingly, some implementations of the method 500 can include receiving 540 one or more user inputs from the user. For example, the user may be positioned proximate to the implement 60, including during its operation and may provide one or more inputs to indicate a response, or lack thereof, to one or more potential defects identified by the work machine 10. Alternatively, or in addition, the user input may indicate that the user will manually resolve and/or address the one or more potential defects identified by the autonomous work machine 10.

Some implementations of the method can include operating 550 the extendable implement according to one or more second operation criteria, the one or more second operation criteria based on the one or more user inputs. For example, in some implementations, the work machine 10 can operate the lift assembly 14, implement interface 18, and implement 60 to repaint only one or more areas of a painted surface identified as defects by the user (e.g., one or more regions presented to, and selected by, the user via the user interface 78).

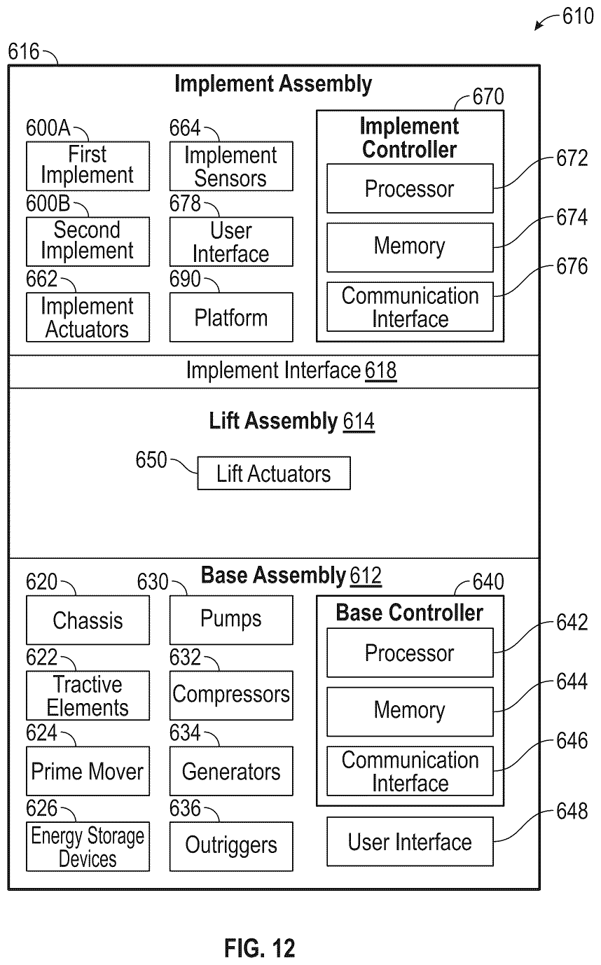

FIG. 12 is a vehicle, work machine, lifting apparatus, or lift device is shown as lift device 610 according to an exemplary embodiment. By way of example, the lift device 610 may be or include a mobile elevating work platform (MEWP), a telehandler, a boom lift, a vertical lift, a scissor lift, a firetruck, or any other type of machine capable of moving (e.g., lifting) material or people to a desired position. The lift device 610 may be human operated, partially autonomous, or completely autonomous.

For example, the lift device 610 may include more than one implement, including an autonomous, or semi-autonomous, implement (e.g., first implement 660A, described below) and a manual, or partially non-autonomous, implement (e.g., second implement 660B, described below). In some embodiments, the first (e.g., autonomous) implement may be controlled, or substantially controlled, by the lift device 610 and the second, (e.g., manual) implement may be manually operated (e.g., controlled by a user), as described in greater detail below. In some embodiments, operation according to the first mode further comprises operating the first implement 660A as another portion of the overall action while an operator or user operates the second implement 660B. For example, one of the implements 660A or 660B can include an air compressor, sprayer, or grinder that is operated to autonomously clean or prepare a surface as the implement assembly 616 is moved along the predetermined path while the user manually operates the other of the implements 660A or 660B (e.g., a painter, a welder, a pressure washer, etc.) to perform their respective portion of the overall action to the cleaned or prepared surface.

Stated differently, the vehicle 610 enables a user to be stationed onboard the lift device (e.g., onboard, and/or supported by, the platform 690) to control an implement, including the second implement 660B, and/or to otherwise provide commands to the machine 610 (e.g., via the user interface 678).

The first implement 660A can be controlled by the lift device 610 (e.g., the first element 660A can be controlled by the implement actuators 662 and according to the implement controller 670 and may be based on input(s) from one or more of the implement sensors 664).

In some embodiments, the implement assembly 616 may include platform 690 (e.g., user support, implement platform, chair, bucket, etc.) that can support an operator (e.g., a user of the machine 610 and/or one or more of the first and second implements 660A and 660B), the platform 690 being repositionable by the lift device (e.g., via the implement interface 618, the lift assembly 614, and/or the lift actuators 650, as described above with reference to analogous components of FIGS. 1 and 2).

In some embodiments, the second implement 660B can be manually controlled (e.g., configured for manual control) by the operator (e.g., the user) who is supported by the platform 690, including, for example, as the platform 690 is repositioned by the lift assembly 614. The user interface 678 may be configured to permit the operator supported by the platform 690 (e.g., configured via its position and physical configuration to be accessible by the operator during operation of the machine 610 and/or the implements 660A, 660B) to provide commands to operate the lift device 610, including the implement assembly 616 and/or the implements 660A, 660B.

In one embodiment, the implement assembly 616 may, therefore, include a platform 690 and two or more implements (e.g., the first implement 660A and the second implement 660B). The machine 610 can be configured to autonomously control the first implement 660A, and the user may be permitted to stand on, or be supported by, the platform 690 and observe the autonomous operation of the first implement 660A. If necessary, the user may intervene in the operation of the machine 610 by providing commands through the user interface 678 to adjust the operation of the first implement 660A and/or the user may manually control the second implement 660B to address whatever circumstances caused the user to intervene, including, for example, to address one or more potential defects missed by the autonomously controlled first implement 660A.

As shown, the lift device 610 includes a base assembly 612 (e.g., a base, a support assembly, a drivable support assembly, a support structure, a chassis, etc.), a lift assembly 614 (e.g., a boom, a boom lift assembly, a lifting apparatus, an articulated arm, a scissor lift, a ladder, a telescoping assembly, etc.), and an implement assembly 616 (e.g., an assembly with one or more tools, manipulators, a platform, etc.). A coupler or interface, shown as implement interface 618, that couples the implement assembly 616 (e.g., including platform 690, which may support a user and allow the user to manually operate one or more implements, including, for example, the second implement 660B) to the lift assembly 614.

The base assembly 612 is configured to support the other components of the lift device 610 and propel the lift device 610 on the ground. The lift assembly 614 is configured to move (e.g., lift, translate, pivot, rotate, etc.) the implement interface 618 and the corresponding implement assembly 616 relative to the base assembly 612. The implement assembly 616 is configured to perform one or more tasks (e.g., moving material, manipulating material by welding, cutting, etc., supporting one or more operators, etc.).

As shown in FIG. 12, the base assembly 612 includes a frame or chassis, shown as chassis 620, that supports the other components of the base assembly 612. A series of tractive elements (e.g., wheels, tracks, etc.), shown as tractive elements 622, are coupled to the chassis 620. The tractive elements 622 engage a support surface (e.g., the ground) to support the lift device 610. One or more actuators, shown as prime mover 624, are configured to drive the tractive elements 622 to steer and/or propel the lift device 610. By way of example, the prime mover 624 may be or include an electric motor and/or an internal combustion engine that receive stored energy and provide rotational mechanical energy to operate various functions of the lift device 610. The base assembly 612 further includes one or more energy storage devices 626 coupled to the chassis 620. The energy storage devices 626 may include batteries, capacitors, fuel tanks, fuel cells, and/or other energy storage devices. The energy storage devices 626 are configured to store energy (e.g., chemically) and provide the stored energy to the prime mover 624 and/or other components of the lift device 610.

Referring still to FIG. 12, the base assembly 612 includes one or more pumps 630, compressors 632, and/or generators 634 coupled to the chassis 620. The pumps 630 may receive rotational mechanical energy (e.g., from the prime mover 624) and provide a supply of pressurized liquid (e.g., hydraulic oil, water, etc.). The compressors 632 may receive rotational mechanical energy (e.g., from the prime mover 624) and provide a supply of pressurized gas (e.g., air, refrigerant, etc.). The generators 634 may receive rotational mechanical energy (e.g., from the prime mover 624) and provide a supply of electrical energy (e.g., to be stored in an energy storage device 626). The pressurized liquid, the pressurized gas, and/or the electrical energy may be supplied to various components of the lift device 610 to facilitate operation of the lift device 610.

The base assembly 612 further includes one or more deployable supports (e.g., outriggers, downriggers, etc.), shown as outriggers 636, coupled to the chassis 620. The outriggers 636 may be selectively repositionable between a stored position and a deployed position. In the stored position, the outriggers 636 are retracted toward the chassis 620 and away from a support surface (e.g., the ground). In the deployed position, the outriggers 636 extend outward and engage the support surface and support the base assembly 612. The outriggers 636 may be used to level the chassis 620 and/or increase the stability of the vehicle (e.g., when the lift assembly 614 is extended).

The base assembly 612 further includes a control circuit or processing circuit, shown as base controller 640, coupled to the chassis 620. The base controller 640 is operatively coupled to (e.g., in communication with) components of the base assembly 612 and the lift assembly 614. The base controller 640 may control operation of the components of the base assembly 612 and the lift assembly 614 directly. The base controller 640 may control operation of the implement assembly 616 indirectly (e.g., through the implement controller 670). Alternatively, the implement controller 670 may be omitted, and the base controller 640 may control operation of the entire lift device 610. The base controller 640 includes a processor 642 and a memory device, shown as memory 644. The memory 644 is configured to store instructions thereon that, when executed by the processor 642, cause the base controller 640 to perform the various functions described herein.

The base controller 640 further includes a network interface, shown as communication interface 646. The communication interface 646 is configured to send and receive information (e.g., data, commands, signals, etc.). The communication interface 646 may communicated through a wired connection (e.g., a CAN bus, an ethernet connection, etc.) and/or wirelessly (e.g., using Bluetooth, radio, Wi-Fi, cellular networks, etc.). The communication interface 646 may communicate with the other components of the lift device 610. The communication interface 646 may communicate with components outside of the lift device 610 (e.g., user devices such as smartphones or laptops, networks such as the Internet, servers, etc.).

The base assembly 612 further includes an input/output device, shown as user interface 648, coupled to the chassis 620 and operatively coupled to the base controller 640. The user interface 648 may be positioned to be accessible by a user positioned on the ground and/or on the base assembly 12. The user interface 648 may be configured to receive information (e.g., commands) from the user. By way of example, the user interface may include touch screens, buttons, switches, knobs, or other input devices. The user interface 648 may be configured to provide information (e.g., status information) to the user. By way of example, the user interface may include displays, lights, speakers, or other output devices.

The lift assembly 614 includes one or more actuators, shown as lift actuators 650. The lift actuators 650 are configured to apply mechanical energy (e.g., a force, a torque, etc.) to raise, lower, translate, or otherwise control the lift assembly 614 to move the implement interface 618. By way of example, lift actuators 650 may include hydraulic actuators (e.g., hydraulic motors, hydraulic cylinders, etc.), pneumatic actuators (e.g., pneumatic motors, pneumatic cylinders, etc.), electric actuators (e.g., electric motors, electric linear actuators, etc.), or other types of actuators. The lift actuators 650 may be powered by the pumps 630, the compressors 632, the generators 634, the energy storage devices 626, and/or other energy sources. Operation of the lift actuators 650 may be controlled by the base controller 640.

The implement interface 618 is configured to couple the implement assembly 616 to the lift assembly 614. In some embodiments, the implement interface 618 removably couples the implement assembly 616 to the lift assembly 614. In other embodiments, the implement interface 618 permanently couples the implement assembly 616 to the lift assembly 614. The implement interface 618 may fixedly couple the implement assembly 616 to a distal end portion of the lift assembly 614. The implement interface 618 may pass data (e.g., electrical signals), electrical energy, hydraulic fluid, compressed gas, or other signals between (a) the base assembly 612 and the lift assembly 614 and (b) the implement assembly 616 to power or control the implement assembly 616.

Referring still to FIG. 12, the implement assembly 616 includes one or more tools, manipulators, etc. shown as implements 660A, 660B. The implement 660A may be configured to perform a desired task. In some embodiments, the implements 660A, 660B each include a tool that facilitates moving an object. By way of example, the implements 660A and 660B may include robotic arms, lift forks, buckets, hooks, suction cups, claws, or other manipulators. In some embodiments, the implements 660A, 660B can include tools that perform a task other than moving material. By way of example, the implements 660A, 660B may include pressure washers, spray nozzles, sand blasters, air guns, paint guns, tape guns, welders, lights, or other tools. In some embodiments, the implements 660A, 660B include one or more inspection tools. By way of example, the implement 660A (a may include cameras, temperature sensors, multimeters, contact probes that measure the profile of a surface, or other inspection tools. In some embodiments, the implement includes a work platform (e.g., a basket, an operator platform) that is configured to support one or more operators.

The implement assembly 616 further includes one or more actuators, shown as implement actuators 662, coupled to the implements 660A, 660B. The implement actuators 662 are configured to reposition (e.g., translate, rotate, raise, lower, etc.) or otherwise move the implement 660A relative to the implement interface 618. By way of example, the implement actuators 662 may include hydraulic actuators, pneumatic actuators, electric actuators, or other types of actuators.

The implement assembly 616 further includes one or more sensors, shown as implement sensors 664. The implement sensors 664 may provide sensor data indicating the position of the implement 660A relative to other components of the lift device 610 (e.g., the implement interface 618) and/or the surrounding environment. By way of example, the implement sensors 664 may include LIDAR sensors, ultrasonic sensors, contact sensors (e.g., limit switches), potentiometers, optical encoders, or other types of sensors. The sensor data from the implement sensors 664 may be used to facilitate closed-loop control over the position of the implement 660A.

The implement assembly 616 further includes a control circuit or processing circuit, shown as implement controller 670, coupled to the implement interface 618. The implement controller 670 is operatively coupled to (e.g., in communication with) with the implement 660A, the implement actuators 662, and the implement sensors 665. The implement controller 670 may control operation of the components of the implement assembly 616 directly. The implement controller 670 may control operation of the base assembly 612 and the lift assembly 614 indirectly (e.g., through the base controller 640). The implement controller 670 includes a processor 672 and a memory device, shown as memory 674. The memory 674 is configured to store instructions thereon that, when executed by the processor 672, cause the implement controller 670 to perform the various functions described herein.

The implement controller 670 further includes a communication interface 676. The communication interface 676 may be substantially similar to the communication interface 646, except as otherwise specified herein. The communication interface 676 may communicate with the communication interface 646 of the base controller 640.

The implement assembly 616 further includes an input/output device, shown as user interface 678, coupled to the implement interface 618 and operatively coupled to the implement controller 670. The user interface 678 may be positioned to be accessible by a user positioned on the implements 660A and/or 660B (e.g., on the platform 690 of the implement assembly 616 and coupled to, and/or supported by, the implement interface 618). The user interface 678 may perform similar functions to the user interface 648.

### Lift Device with Disconnect Interface

Referring generally to the FIGURES, a lift device is shown, according to various exemplary embodiments. The lift device includes a chassis, a lift assembly, and an implement interface. The lift assembly is coupled to the chassis and the implement interface. The implement interface is configured to be removably coupled to one of a plurality of possible implements. The lift device also includes an implement sensor. The lift device also includes a controller configured to receive information from the implement sensor and adjust operation of the lift assembly. The implement sensor is configured to detect whether the implement is coupled to the implement interface. The lift assembly is configured to extend or retract the implement interface relative to the chassis.

The controller includes one or more processors communicably connected to memory. The controller is configured to adjust operation of the lift device dependent on the sensor information received from various sensors on the lift device. The controller may also operate a user interface to display information.

Advantageously, removably coupling one of a plurality of implements to the lift device increases the functionality of the lift device as a variety of implements may be coupled to the lift device. An operator of the lift device may couple the implement to the lift device depending on the desired usage. The operation of the lift assembly is adjusted dependent on the implement type by the controller.

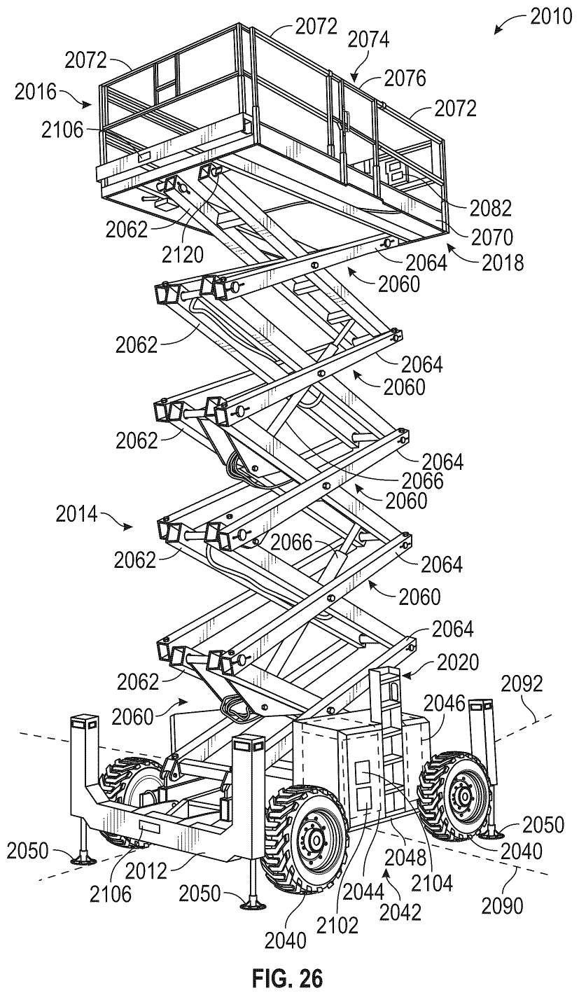

According to the exemplary embodiment shown in FIG. 26, a lift device (e.g., a scissor lift, an aerial work platform, a boom lift, a telehandler, etc.), shown as a lift device 2010, includes a chassis, frame assembly, etc., shown as a chassis 2012. A lift assembly (e.g., a scissor assembly, a boom assembly, etc.), shown as a lift assembly 2014, couples a chassis 2012 to an implement interface, disconnect platform, disconnect interface, etc., shown as an implement interface 2018. The chassis 2012 supports the lift assembly 2014 and the implement interface 2018, both of which are disposed directly above the chassis 2012. In use, the lift assembly 2014 extends and retracts to raise and lower the implement interface 2018 relative to the chassis 2012 between a lowered position and a raised position. The lift device 2010 includes an access assembly, shown as an access assembly 2020, that is coupled to the chassis 2012 and configured to facilitate access to the implement interface 2018 from the ground by an operator when the implement interface 2018 is in the lowered position. In some implementations, the lift device 2010 may be the lift device 10.

As shown in FIG. 26, the chassis 2012 defines a horizontal plane having a lateral axis 2090 and a longitudinal axis 2092. In some embodiments, the chassis 2012 is rectangular, defining lateral sides extending parallel to the lateral axis 2090 and longitudinal sides extending parallel to the longitudinal axis 2092. In some embodiments, the chassis 2012 is longer in a longitudinal direction than in a lateral direction. In some embodiments, the lift device 2010 is configured to be stationary or semi-permanent (e.g., a system that is installed in one location at a work site for the duration of a construction project). In such embodiments, the chassis 2012 may be configured to rest directly on the ground and/or the lift device 2010 may not provide powered movement across the ground. In other embodiments, the lift device 2010 is configured to be moved frequently (e.g., to work on different tasks, to continue the same task in multiple locations, to travel across a job site, etc.). Such embodiments may include systems that provide powered movement across the ground.

As shown in FIG. 26, the lift device 2010 is supported by a plurality of tractive assemblies 2040, each including a tractive element (e.g., a tire, a track, etc.), that are rotatably coupled to the chassis 2012. The tractive assemblies 2040 may be powered or unpowered. As shown in FIG. 26, the tractive assemblies 2040 are configured to provide powered motion in the direction of longitudinal axis 2092. One or more of the tractive assemblies 2040 may be turnable to steer the lift device 2010. In some embodiments, the lift device 2010 includes a powertrain system 2042. In some embodiments, the powertrain system 2042 includes a primary driver 2044 (e.g., an engine). A transmission may receive the mechanical energy and provide an output to one or more of the tractive assemblies 2040. In some embodiments, the powertrain system 2042 includes a pump 2046 configured to receive mechanical energy from the primary driver 2044 and output a pressurized flow of hydraulic fluid. The pump 2046 may supply mechanical energy (e.g., through a pressurized flow of hydraulic fluid) to individual motive drivers (e.g., hydraulic motors) configured to facilitate independently driving each of the tractive assemblies 2040. In other embodiments, the powertrain system 2042 includes an energy storage device (e.g., a battery, capacitors, ultra-capacitors, etc.) and/or is electrically coupled to an outside source of electrical energy (e.g., a standard power outlet). In some such embodiments, one or more of the tractive assemblies 2040 include an individual motive driver (e.g., a motor that is electrically coupled to the energy storage device, etc.) configured to facilitate independently driving each of the tractive assemblies 2040. The outside source of electrical energy may charge the energy storage device or power the motive drivers directly. The powertrain system 2042 may additionally or alternatively provide mechanical energy (e.g., using the pump 2046, by supplying electrical energy, etc.) to one or more actuators of the lift device 2010 (e.g., leveling actuators 2050, lift actuators 2066, stair actuator, etc.), shown as actuators 2052. One or more components of the powertrain system 2042 may be housed in an enclosure, shown as a housing 2048. The housing 2048 is coupled to the chassis 2012 and extends from a side of the lift device 2010 (e.g., a left or right side). The housing 2048 may include one or more doors to facilitate access to components of the powertrain system 2042.

In some embodiments, the chassis 2012 is coupled to one or more actuators, shown in FIG. 26 as leveling actuators 2050. The lift device 2010 includes four leveling actuators 2050, one in each corner of the chassis 2012. The leveling actuators 2050 extend and retract vertically between a stored position and a deployed position. In the stored position, the leveling actuators 2050 are raised and do not contact the ground. In the deployed position, the leveling actuators 2050 contact the ground, lifting the chassis 2012. The length of each of the leveling actuators 2050 in their respective deployed positions may be varied to adjust the pitch (i.e., rotational position about the lateral axis 2090) and the roll (i.e., rotational position about the longitudinal axis 2092) of the chassis 2012. Accordingly, the lengths of the leveling actuators 2050 in their respective deployed positions may be adjusted such that the chassis 2012 is leveled with respect to the direction of gravity, even on uneven or sloped terrains. The leveling actuators 2050 may additionally lift the tractive elements of the tractive assemblies 2040 off the ground, preventing inadvertent driving of the lift device 2010.

As shown in FIG. 26, the lift assembly 2014 includes a number of subassemblies, shown as scissor layers 2060, each including a first member, shown as inner member 2062, and a second member, shown as outer member 2064. In each scissor layer 2060, the outer member 2064 receives the inner member 2062. The inner member 2062 is pivotally coupled to the outer member 2064 near the centers of both the inner member 2062 and the outer member 2064. Accordingly, the inner member 2062 pivots relative to the outer member 2064 about a lateral axis. The scissor layers 2060 are stacked atop one another to form the lift assembly 2014. Each inner member 2062 and each outer member 2064 has a top end and a bottom end. The bottom end of each inner member 2062 is pivotally coupled to the top end of the outer member 2064 immediately below it, and the bottom end of each outer member 2064 is pivotally coupled to the top end of the inner member 2062 immediately below it. Accordingly, each of the scissor layers 2060 are coupled to one another such that movement of one scissor layer 2060 causes a similar movement in all of the other scissor layers 2060. The bottom ends of the inner member 2062 and the outer member 2064 belonging to the lowermost of the scissor layers 2060 are coupled to the chassis 2012. The top ends of the inner member 2062 and the outer member 2064 belonging to the uppermost of the scissor layers 2060 are coupled to the implement interface 2018. The inner members 2062 and/or the outer members 2064 are slidably coupled to the chassis 2012 and the implement interface 2018 to facilitate the movement of the lift assembly 2014. The scissor layers 2060 may be added to or removed from the lift assembly 2014 to increase or decrease, respectively, the maximum height that the implement interface 2018 is configured to reach.

One or more actuators (e.g., hydraulic cylinders, pneumatic cylinders, motor-driven leadscrews, etc.), shown as lift actuators 2066, are configured to extend and retract the lift assembly 2014. As shown in FIG. 26, the lift assembly 2014 includes a pair of lift actuators 2066. The lift actuators 2066 are pivotally coupled to an inner member 2062 at one end and pivotally coupled to another inner member 2062 at the opposite end. These inner members 2062 belong to a first scissor layer 2060 and a second scissor layer 2060 that are separated by a third scissor layer 2060. In other embodiments, the lift assembly 2014 includes more or fewer lift actuators 2066 and/or lift actuators 2066 are otherwise arranged. The lift actuators 2066 are configured to actuate the lift assembly 2014 to selectively reposition the implement interface 2018 between the lowered position, where the implement interface 2018 is proximate to the chassis 2012, and the raised position, where the implement interface 2018 is at an elevated height. In some embodiments, extension of the lift actuators 2066 moves the implement interface 2018 vertically upward (extending the lift assembly 2014), and retraction of the linear actuators moves the implement interface 2018 vertically downward (retracting the lift assembly 2014). In other embodiments, extension of the lift actuators 2066 retracts the lift assembly 2014, and retraction of the lift actuators 2066 extends the lift assembly 2014. In some embodiments, the outer members 2064 are approximately parallel and/or contacting one another when with the lift assembly 2014 in a stored position. The lift device 2010 may include various components to drive the lift actuators 2066 (e.g., pumps, valves, compressors, motors, batteries, voltage regulators, etc.).

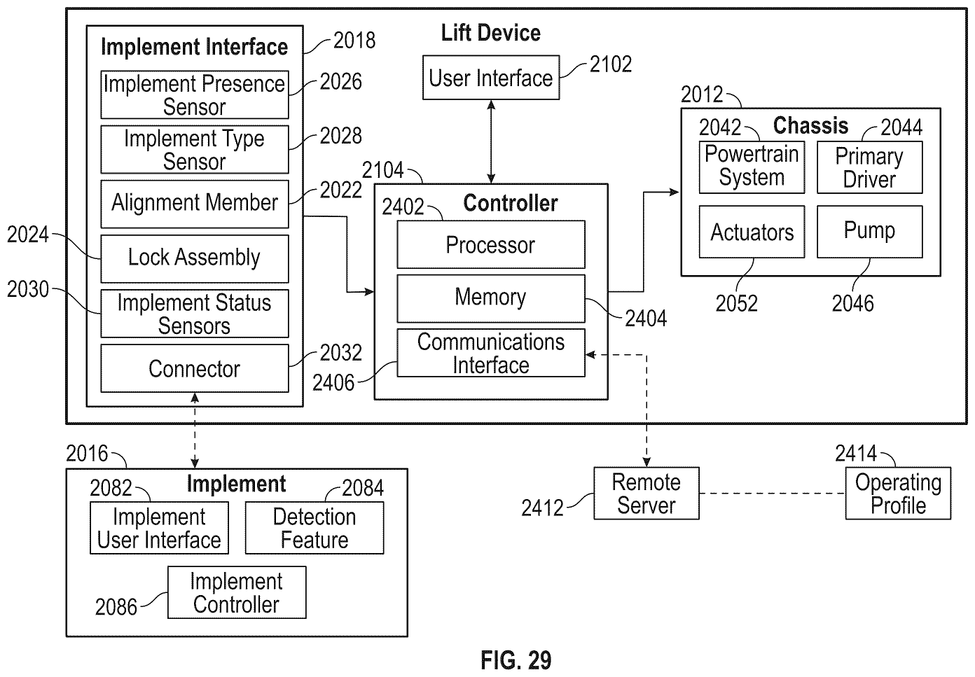

As shown in FIGS. 28 and 29, the implement interface 2018 is configured to be removably coupled to one of a plurality of implements (e.g., a platform, material lift, dumper, forklift, etc.), shown as an implement 2016. In some embodiments, the implement interface 2018 may be removably coupled to more than one implement 2016.

The implement interface 2018 is coupled to the lift assembly 2014 at an end. As shown in FIGS. 28 and 29, the implement interface 2018 includes one or more alignment members (e.g., a latch, a peg, etc.), shown as an alignment member 2022. The alignment member 2022 facilitates secure connection of the implement 2016 to the implement interface 2018 and limits movement of the implement 2016 relative to the implement interface 2018. The implement 2016 may include corresponding aperture to receive the alignment member 2022 to ensure the alignment of the implement 2016 to the implement interface 2018. For example, the alignment member 2022 may be pegs and the implement 2016 may include slots for pegs to fit into. As shown in FIG. 28, the implement interface 2018 may include more than one alignment member 2022. The alignment member 2022 may be positioned anywhere on the implement interface 2018.

As shown in FIGS. 28 and 29, the implement interface 2018 includes lock assembly (e.g., a latch, a switch, a buckle, etc.), shown as a lock assembly 2024. The lock assembly 2024 is configured to ensure the implement 2016 is not detached from the implement interface 2018 until desired by operator. The lock assembly 2024 selectively fixedly couples the implement 2016 to the implement interface 2018. The lock assembly 2024 may automatically couple the implement 2016 to the implement interface 2018 or require manual labor for coupling the implement 2016 to the implement interface 2018. In some embodiments, the implement interface 2018 may include an aperture that functions as both the alignment member 2022 and the lock assembly 2024.

As shown in FIGS. 28 and 29, the implement interface 2018 includes one or more sensors (e.g., an implement sensor, implement presence sensor, etc.), shown as an implement presence sensor 2026. The implement presence sensor 2026 is configured to detect if the implement 2016 is coupled to the implement interface 2018. Operating features (e.g., load sensing system, power requirements, etc.) are overridden when the implement 2016 is not detected by the implement interface 2018 and/or the implement 2016 is removed from the implement interface 2018. The implement presence sensor 2026 may be switch actuated by an implement 2016 when coupling to the implement interface 2018. The implement presence sensor 2026 may be a resistance sensor configured to detect an change in resistance in an electric circuit of the vehicle 2010 when the implement 2016 is coupled. The implement presence sensor 2026 may similarly be current sensor, a voltage sensor, a photodiode, a proximity sensor, etc. configured to detect the implement 2016.

As shown in FIGS. 28 and 29, the implement interface 2018 includes a sensor (e.g., a second implement sensor, an implement type sensor, an implement detection sensor, etc.), shown as an implement type sensor 2028. The implement type sensor 2028 is configured to detect type (e.g., work platform, forklift, material lift, etc.) of the implement 2016 coupled to the implement interface 2018 when the implement presence sensor 2026 detects the presence of the implement 2016. In some embodiments, the implement type sensor 2028 includes a variety of apertures (e.g., camera, tag, etc.) to assist in detecting type of the implement 2016. In some embodiments, the implement presence sensor 2026 and the implement type sensor 2028 may be one sensor. The implement type sensor 2028 may detect a type of the implement 2016 from a plurality of possible implement 2016 types based on a sensed resistance, weight, signal provided by the implement 2016, which sensors 2026, 2028 of a plurality of sensors 2026, 2028 are active or sensing etc. For example, indicator presence sensors 2026 may be positioned at various points on the implement interface 2018, and depending on which implement presence sensors 2026 detect the presence of the implement 2016, the type of implement 2016 may be determined. In some embodiments, the implement 2016 may include a electronic tag (e.g., Bluetooth tag, NFC tag, etc.) or a visual tag (e.g., QR code, unique visual insignia, etc.) or provide a signal to which indicates the type of the implement 2016. As shown in FIGS. 28 and 29, the implement interface 2018 includes implement status sensors (e.g., load sensors 2120, weight sensor, strain gauge, orientation sensors 2106, extension sensor, etc.), shown as implement status sensors 2030. The implement status sensors 2030 are configured to measure one or more properties (e.g., distance, orientation, load, weight, etc.) to receive information on the status of the lift device 2010. In some embodiments, the implement presence sensor 2026, the implement type sensor 2028, and the implement status sensors 2030 are within one, two, or three separate sensors.

As shown in FIGS. 28 and 29, the implement interface 2018 includes connectors 2032. The implement 2016 includes connection points for the connector 2032 to connect to when coupling the implement 2016 to the implement interface 2018. The connector 2032 may transfer one or more of data, power, or hydraulic pressure between the chassis 2012 and the implement 2016. Data transferred may include commands for controlling actuators 2052 or actuators of the implement 2016, signals from a user interface of the implement 2016, etc. The connector 2032 is also configured to transfer electrical energy between the chassis 2012 and the implement 2016. The powertrain system 2042 may include a battery, fuel cell, pump 2046, internal combustion engine with a generator, etc. that is configured to supply power/energy to the implement 2016 and the chassis 2012. Dependent on type of the implement 2016, the connector 2032 may also transfer fluid (e.g., hydraulic fluid, compressed air, etc.). In some embodiments, the implement interface 2018 may include more connectors 2032 than number of connection points on the implement 2016 and the implement 2016 only connects with the connectors 2032 matching with connection points.

As shown in FIG. 26, the lift device 2010 includes a user interface (e.g., a human machine interface, a user input device, etc.), shown as a user interface 2102. The user interface 2102 includes any number of buttons, levers, knobs, switches, etc., or any other user input devices configured to receive an input from the operator of the lift device 2010. The user interface 2102 may include any number of screens, displays, etc., configured to display imagery, information, data, operational information, etc., regarding the lift device 2010 and the implement 2016. In some embodiments, the user interface 2102 is disposed at the chassis 2012. In some embodiments, the implement 2016 has an implement user interface 2082 disposed at the implement 2016 such that the operator at the implement 2016 uses the implement user interface 2082 to operate the lift device 2010. Any methods discussed, may be applied to the user interface 2102, the implement user interface 2082, or any combinations of both. In some embodiments, the user interface 2102 includes a touch screen (e.g., a resistive touch screen, a capacitive touch screen, etc.) configured to display various information to the operator as well as receive user inputs from the operator.

Lift device 2010 includes a controller 2104. As shown in FIG. 29, the controller 2104 includes one or more processors 2402 communicably connected to memory 2404. The processors 2402 may be implemented as a general purpose processor, an application specific integrated circuit (ASIC), one or more field programmable gate arrays (FPGAs), a group of processing components, or other suitable electronic processing components.

The memory 2404 (e.g., memory, memory unit, storage device, etc.) includes one or more devices (e.g., RAM, ROM, Flash memory, hard disk storage, etc.) for storing data and/or computer code for completing or facilitating the various processes, layers and modules described in the present application. The memory 2404 may be or include volatile memory or non-volatile memory. The memory 2404 may include database components, object code components, script components, or any other type of information structure for supporting the various activities and information structures described in the present application. According to some embodiments, the memory 2404 is communicably connected to the processors 2402 and includes computer code for executing (e.g., by the processors 2402) one or more processes described herein.

The controller 2104 is configured to receive sensor information from various sensors of the lift device 2010 (e.g., the implement status sensors 2030, the implement presence sensor 2026, the implement type sensor 2028, etc.), user inputs from the user interface 2102, feedback from any pups, engines, actuators 2052, etc., of the lift device 2010, and operate any controllable elements (e.g., operate the tractive assemblies 2040 to drive the lift device 2010, operate the lift actuators 2066 to raise or lower the implement 2016, operate the lock assembly 2024, etc.) based on any of the sensory inputs, user inputs, etc. In some embodiments, the controller 2104 is configured to operate the user interface 2102 to display any received sensory information, operational information, calculated properties, etc., of the lift device 2010. For example, the controller 2104 may operate the user interface 2102 to display a current height (e.g., a current overall length of the lift assembly 2014) to the operator. The controller 2104 operates any controllable elements of the lift device 2010 by generating and providing control signals to the controllable elements. The controller 2104 operates the user interface 2102 (or any other display screens, visual alert devices, aural alert devices, user interfaces, etc.) by generating and providing display/control signals to the user interface 2102. The controller 2104 may be disposed at the chassis 2012 (as shown in FIG. 26) or at the user interface 2102. The controller 2104 may be positioned anywhere on the lift device 2010.

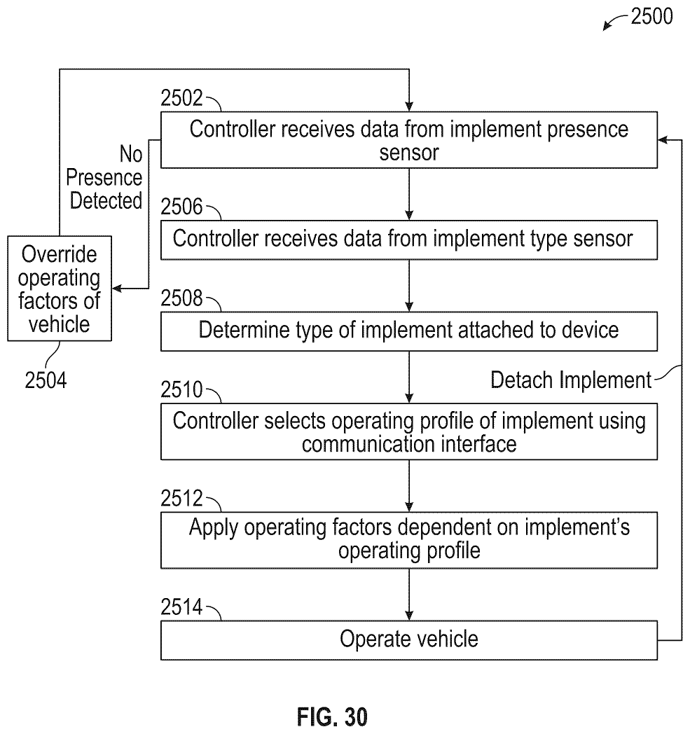

The controller 2104 determines whether the implement 2016 is coupled to the lift device 2010. As shown in FIG. 30, the controller 2104 receives sensory data from the implement presence sensor 2026 disposed at the implement interface 2018 to determine whether the implement 2016 is coupled to the lift device 2010. The controller 2104 overrides operating factors of the lift device 2010 when the implement 2016 is not detected on the lift device 2010. The implement presence sensor 2026 provides the controller 2104 real time information on presence of the implement 2016. For example, when the implement 2016 is detached from the lift device 2010, the controller 2104 receives sensor data and can override operating factors of the lift device 2010.

The controller 2104 is configured to determine type of the implement 2016 attached to the lift device 2010. As shown in FIGS. 29 and 30, the controller 2104 receives sensor data from the implement type sensor 2028 disposed at the implement interface 2018 to determine type of the implement 2016 coupled to the lift device 2010. Each type of implement 2016 has its own operating profile (e.g., load ratings, power and data requirements, etc.), shown in FIG. 29 as an operating profile 2414. The operating profile 2414 affects the operation of the lift device 2010 (e.g., limiting maximum height of the lift device 2010, movement of the tractive assemblies 2040, maximum load on the implement 2016), and the implement type sensor 2028 and the controller 2104 allow for type of the implement 2016 coupled to be recognized and received.

As shown in FIG. 29, the controller 2104 may include a communications interface 2406. The communications interface 2406 may facilitate communication between the controller 2104 and external systems, devices, sensors, etc. for control, monitoring, adjustment to any of the communicable connected devices, displays, sensors, systems, primary movers, etc. The communications interface 2406 may also facilitate communications between the controller 2104 (e.g., a touch screen, a display screen, a personal computer, etc.) and the user interface 2102 or with a network. The processors 2402 and the memory 2404 are communicably coupled to the communications interface 2406 such that the processors 2402 and the memory 2404 send and receive data via the communications interface 2406.

The communications interface 2406 may include wired or wireless communications interfaces (e.g., jacks, antennas, transmitters, receivers, transceivers, wire terminals, etc.) for conducting data communications with sensors, devices, systems, etc., of the lift device 2010 or other external systems or devices (e.g., an administrative device). In various embodiments, communications via the communications interface 2406 is direct (e.g., local wired or wireless communications) or via a communications network (e.g., a WAN, the Internet, a cellular network, etc.). For example, the communications interface 2406 may include an Ethernet card and port for sending and receiving data via an Ethernet-based communications link or network. In another example, the communications interface may include a Wi-Fi transceiver for communicating via a wireless communications network. In some embodiments, the communications interface 2406 is or includes a power line communications interface. In other embodiments, the communications interface 2406 is or includes an Ethernet interface, a USB interface, a serial communications interface, a parallel communications interface, a cellular interface, etc.

As shown in FIG. 29, the communications interface 2406 is communicably coupled to a remote server (e.g., the Internet, a cellular network, a local wired device, etc.), shown as a remote server 2412. The remote server 2412 communicates information to the communications interface 2406 for the controller 2104 to use for operation of the lift device 2010. The remote server 2412 may include the operating profile 2414 for the implement 2016. The controller 2104 determines type of the implement 2016 coupled to the lift device 2010 using the implement type sensor 2028 and receives the operating profile 2414 of the implement 2016. The operating profile 2414 includes information on the implement 2016 such as load ratings, power and data requirements, fluid requirements, a Rosetta stone to translate signals, etc. In some embodiments, the controller 2104 includes the a plurality of operating profiles 2414 in memory 2404 and retrieves the appropriate operating profile 2414 based on the information related to the implement 2016.

The controller 2104 receives the operating profile 2414 and information is sent to the chassis 2012 to adjust operation of the lift device 2010 based on the implement 2016 and its operating profile 2414. For example, threshold (e.g., load threshold, height threshold, speed threshold, etc.) changes based on the operating profile 2414 of the implement 2016 coupled to the implement interface 2018. The controller 2104 receives sensory information from the implement status sensors 2030 and additional sensors on the lift device 2010 to display information on the user interface 2102 and adjust operation based on the operating profile 2414. For example, the implement status sensors 2030 may include the orientation sensors 2106 that provides the controller 2104 with real-time orientation information of the lift device 2010. The controller 2104 may determine a maximum allowable height of the implement 2016 using the operating profile 2414 and restrict the lift assembly 2014 from raising the implement 2016 above the maximum allowable height. This information may be displayed on the user interface 2102 to provide an operator with an indication regarding whether the maximum allowable height is reached.

As shown in FIG. 29, the implement 2016 includes a detection feature (e.g., a radio frequency identification tag, near-field communication, quick-response (QR) code, etc.), shown as a detection feature 2084. The detection feature 2084 communicates information on type of the implement 2016 to the implement type sensor 2028, which is received by the controller 2104. In various embodiments, the implement interface 2018 may include a device (e.g., reader, camera, etc.) to receive information on the detection feature 2084. For example, the implement interface 2018 may include a camera to read a QR code on the implement 2016.

As shown in FIG. 29, along with the implement user interface 2082, the implement 2016 may include an implement controller 2086. The implement controller 2086 includes one or more processors communicably connected to memory. Methods and systems discussed for the controller 2104 may be applied to the implement controller 2086 or any combination of the controller 2104 and the implement controller 2086. When the implement 2016 does not have the implement user interface 2082 and/or the implement controller 2086, the lift device 2010 and the implement 2016 may be controlled remotely with a user device (e.g., smartphone, desktop computer, etc.). The user device is communicably coupled to the lift device 2010 via the controller 2104.

In various embodiments, more than one implement 2016 are coupled to the lift device 2010 at the implement interface 2018. The lift device 2010 may have more than one implement interface 2018 or the implement interface 2018 may have multiple alignment member 2022 and/or lock assembly 2024 to facilitate coupling of more than one implement 2016. In such embodiments, the user interface 2102 and/or the user device are configured for operations of multiple implements 2016 coupled to the lift device 2010. For example, the user interface 2102 may have multiple displays to operate multiple implements 2016 separately or together.

As shown in FIG. 30, a process 2500 for operating a lift device (e.g., lift device 2010, a scissor lift) includes steps 502-514, according to an exemplary embodiment.

Process 2500 includes a controller receiving data from an implement presence sensor (step 2502). The implement presence sensor detects whether an implement (e.g., a platform, a subframe, etc.) is coupled to an implement interface on a lift device (e.g., the lift device 2010), and information is sent to the controller. When no presence of the implement is detected, operating factors of vehicle are overridden (step 2504). Step 2502 may be performed by the implement presence sensor 2026 and the controller 2104.

Process 2500 includes a controller receiving data from an implement type sensor (step 2506). The implement type sensor detects the type of implement coupled to the lift device, and information is sent to the controller. The controller then determines type of implement attached to the lift device using the information (step 2508) The implement type sensor may be a single sensor or a part of the implement presence sensor. Step 2506 and step 2508 may be performed by the implement type sensor 2028 and the controller 2104.

Process 2500 includes a controller selecting operating profile of implement using a communication interface within the controller (step 2510). The operating profile may be located in a remote server that communicably communicates with the communication interface. Dependent on type of implement determined in step 2508, the controller selects corresponding operating profile of implement. Step 2510 may be performed by the controller 2104 and the communications interface 2406. In some embodiments, step 2510 is also performed by the remote server 2412 (e.g., the communications interface 2406 receiving the operating profile from the remote server 2412).

Process 2500 includes a controller applying operating factors (e.g., load ratings, power and data requirements, fluid requirements, etc.) onto the lift device using the selected operating profile (step 2512). The operating factors are applied to a chassis on the lift device and the implement; therefore, operation of the lift device is adjusted dependent on the implement. Step 2512 may be performed by the controller 2104, the chassis 2012, the implement 2016, and the operating profile 2414. Using the applied operating factors, the lift device is operated (step 2514). For example, the lift device may be operated by the user interface 2102 or the user device.

When the implement is detached, as is shown in FIG. 30, the controller receives information from the implement presence sensor. Operating factors of vehicle are then overridden as presence of implement is no longer detected.

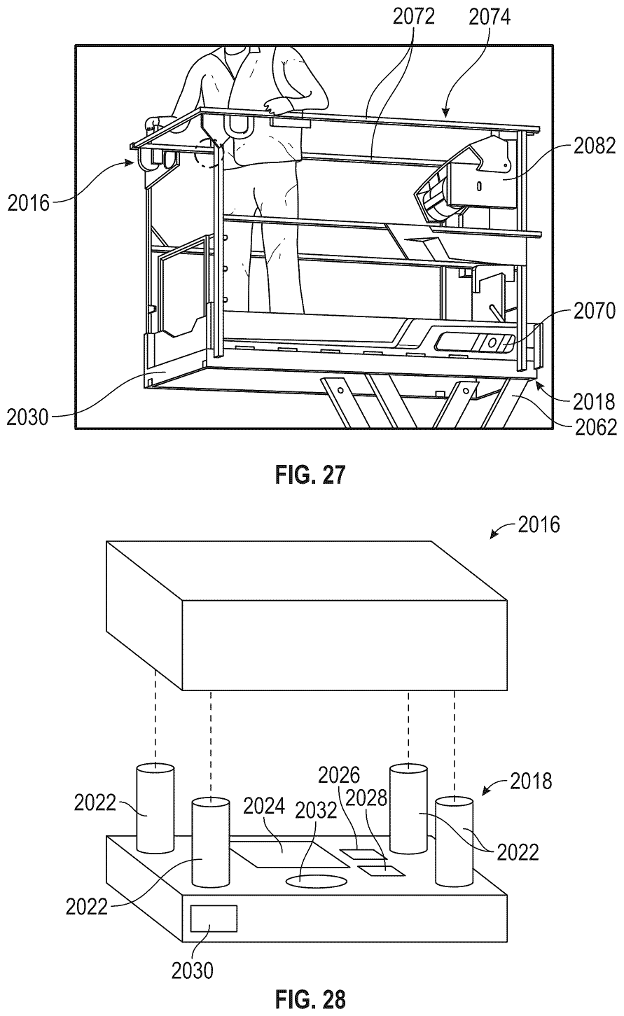

FIG. 27 shows the implement 2016 of FIG. 26, according to an exemplary embodiment. In this embodiment, the implement 2016 is a work platform for one or more people. The implement 2016 is coupled to the implement interface 2018. As shown in FIG. 26 and FIG. 27, the implement 2016 includes a support surface, shown as a deck 2070, configured to support operators and/or equipment. A bottom surface of the deck 2070 is removably coupled to the implement interface 2018.

Shown in FIG. 26 and FIG. 27, the implement 2016 includes a number of guards or railings, shown as guard rails 2072, that extend upwards from deck 2070. The guard rails 2072 extend around an outer perimeter of the deck 2070, partially or fully enclosing a supported area on the deck 2070. The guard rails 2072 provide a stable support for the operators to hold and facilitate containing the operators and equipment within the supported area. The guard rails 2072 define one or more openings 2074 through which the operators use to access the deck 2070. The openings 2074 may be a space between two guard rails 2072 along the perimeter of the deck 2070, such that the guard rails 2072 do not extend over the openings 2074. In some embodiments, as is shown in FIG. 26, the implement 2016 includes a door 2076 that selectively extends across the openings 2074 to decide movement through the openings 2074. In the closed position, the door 2076 prevents movement through the openings 2074. In the open position, the door 2076 facilitates movement through the openings 2074.

In this exemplary embodiment, as shown in FIG. 27, the implement 2016 includes the implement user interface 2082. The implement user interface 2082 is configured to allow a user to control and move the lift device 2010. The implement user interface 2082 may also display information related specifically to the implement 2016.

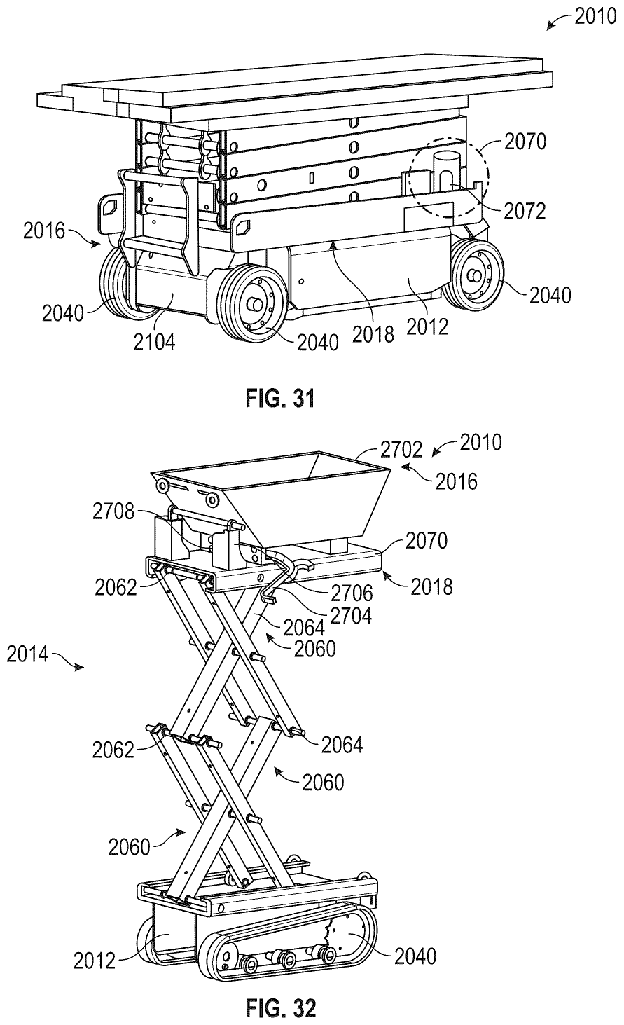

FIG. 31 shows the lift device 2010 of FIG. 26, according to an exemplary embodiment. In this embodiment, the implement 2016 is configured as a material lift platform. The implement 2016 includes a support surface, shown as the deck 2070, configured to support material. A bottom surface of the deck 2070 is removably coupled to the implement interface 2018. The implement 2016 also includes guard railings, shown as the guard rails 2072, that extend upwards from the deck 2070. The guard rails 2072 extend around an outer perimeter of the deck 2070, partially enclosing a supported area on the deck 2070. The guard rails 2072 provide support for materials being contained within the deck 2070. The implement 2016 as shown in FIG. 31 does not include the implement user interface 2082 and may be operated by the user interface 2102 of the lift device 2010, or by the user device.

FIG. 32 shows the lift device 2010 of FIG. 26, according to an exemplary embodiment. In this embodiment, the implement 2016 is configured as a dumper. The implement 2016 may be used to load, move, and dump material. The implement 2016 includes a support surface, shown as the deck 2070. A bottom surface of the deck 2070 is removably coupled to the implement interface 2018. A top surface of the deck 2070 is removably coupled to a bucket 2702 configured to contain material.

The implement 2016 includes bucket arms 2704, which are coupled to the bucket 2702 and the deck 2070. The bucket 2702 rotates between positions (e.g., in level with the deck 2070 as shown in FIG. 32, in an elevated position to dump material, etc.) by means of the bucket arms 2704. The bucket arms may be coupled to one or more actuators, shown as bucket actuators 2706. The bucket actuators 2706 may be used to rotate or otherwise move the bucket arms 2704. The bucket actuators 2706 may be used and may include hydraulic cylinders, linear actuators, electric motors, and/or pneumatic cylinders. The bucket actuators 2706 may be positioned on the deck 2070 or on the bucket 2702.

The implement 2016 includes one or more actuators, shown as dump actuators 2708 coupled to the bucket 2702. The dump actuators 2708 are actuated to extend and/or retract so as to position the bucket 2702 in a desired position for dumping, moving, loading, etc.

In some embodiments, as is shown in FIG. 32, the tractive assemblies 2040 are structured as tracks. The tractive assemblies 2040 may be any, or a combination of structures, including wheels, treads, and/or tracks. The implement 2016 as shown in FIG. 32 does not include the implement user interface 2082 and may be operated by the user interface 2102 of the lift device 2010, or by the user device.

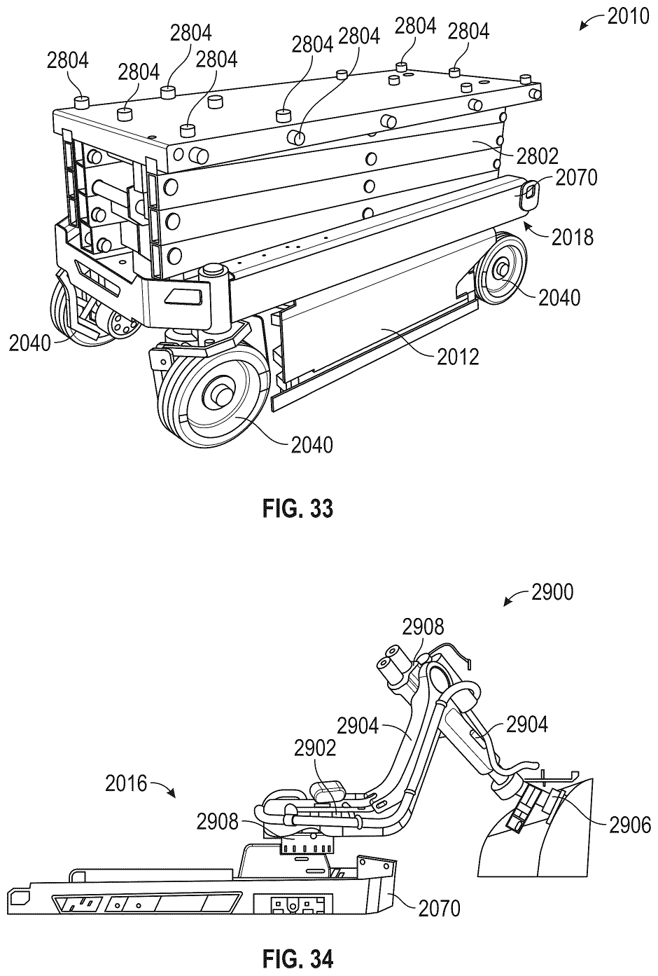

FIG. 33 shows the lift device 2010 of FIG. 26, according to an exemplary embodiment. In this embodiment, the implement 2016 includes the deck 2070. The deck 2070 is coupled to a platform, support, lift, etc., shown as platform 2802. The deck 2070 is configured to support the platform 2802. A number of attachment points, shown as attachment point 2804 are coupled to the platform 2802. The attachment point 2804 may be for a paint sprayer, pressure washer, etc. The implement 2016 as shown in FIG. 33 does not include the implement user interface 2082 and may be operated by the user interface 2102 of the lift device 2010, or by the user device.

FIG. 34 shows an implement that is coupled to the lift device 2010 of FIG. 26, according to an exemplary embodiment. The implement 2016 is configured as an arm, robotic arm, etc. The implement 2016 includes a deck 2070 which supports the arm, robotic arm, etc. shown as an arm 2900. The implement 2016 may include a motor (e.g., an electric motor, a hydraulic motor, etc.), shown as motor 2902 that is configured to provide energy to drive operation of the implement 2016. The arm 2900 includes a number of sections, shown as arm sections 2904 that are rotatable relative to one another via the motor 2902. Positioned at the distal end of the arm 2900 is a tool, implement, etc., shown as a tool 2906. The tool 2906 may be a powered brush, a window cleaner, a drill, a chain saw, a nail gun, a scraper, a claw, a grabber, a blower, etc. The motor 2902 may provide energy to the tool 2906 to drive its operation. The implement 2016 may include one or more actuators, shown as arm actuators 2908. The one or more arm actuators 2908 are actuated to extend and/or retract the arm sections 2904 to position the implement 2016 in a desired position. The implement 2016 as shown in FIG. 34 does not include the implement user interface 2082 and may be operated by the user interface 2102 of the lift device 2010, or by the user device.

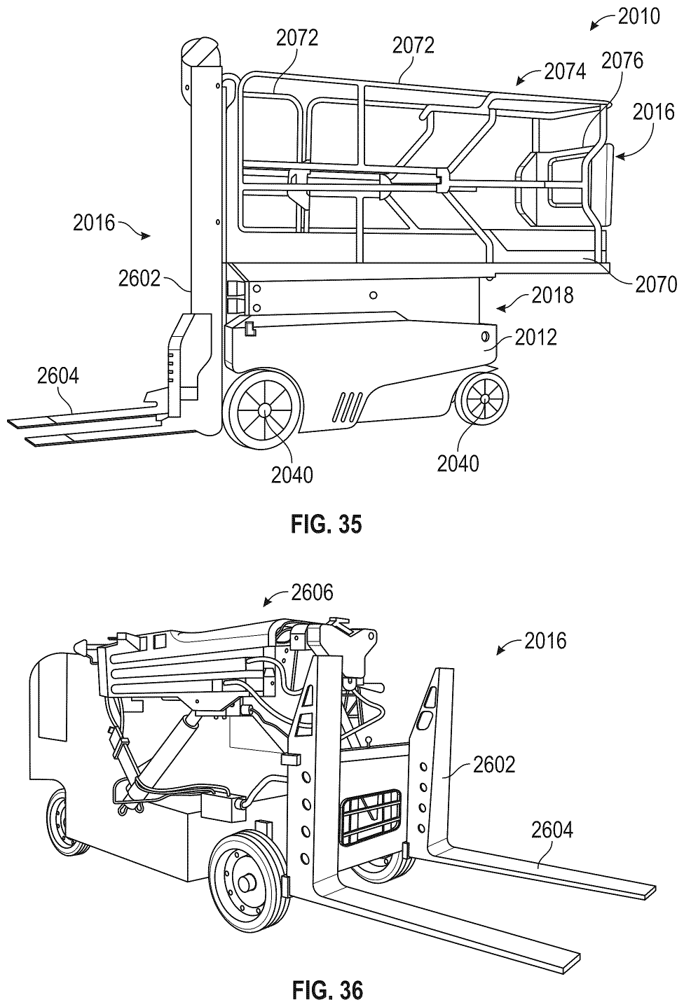

FIG. 35 shows the lift device 2010 of FIG. 26, according to an exemplary embodiment. In this embodiment, there are two implements 2016 coupled to the implement interface 2018. The implement 2016 on a first end of the implement interface 2018 is configured as a work platform for one or more people. The implement 2016 includes a support surface, shown as the deck 2070, configured to support operators and/or equipment. The implement 2016 also includes a number of guards or railings, shown as the guard rails 2072, that extend upwards from deck 2070. The guard rails 2072 define one or more openings 2074 through which the operators use to access the deck 2070. The implement 2016 includes a door 2076 that selectively extends across the openings 2074 to decide movement through the openings 2074.

The implement 2016 on a second end of the implement interface 2018 is configured as a forklift forks assembly, material handler, telehandler, etc., shown as forklifts 2602. The forklifts 2602 includes a lift assembly (e.g., lift forks, lift platform, etc.), shown as lift forks 2604. The lift forks 2604 are raised and lowered relative to the lift device 2010.

FIG. 36 shows an implement that is coupled to the lift device 2010 of FIG. 26, according to an exemplary embodiment. In this embodiment, the implement 2016 is configured as a forklift forks assembly, material handler, telehandler, etc., shown as forklifts 2602 with a boom assembly, shown as boom assembly 2606. The forklifts 2602 includes a lift assembly (e.g., lift forks, lift platform, etc.), shown as lift forks 2604. The lift forks 2604 are raised and lowered relative to the lift device 2010 by the boom assembly 2606.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X; Y; Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the fire apparatus 10 and the systems and components thereof as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

1. A lift device comprising:
a chassis;
an implement interface configured to be removably coupled to an implement;
a lift assembly coupled to the chassis and the implement interface and configured to raise the implement interface relative to the chassis;
an implement sensor coupled to the implement interface and configured to detect whether the implement is coupled to the implement interface; and
a controller operatively coupled to the lift assembly and the implement sensor and configured to adjust operation of the lift device in response to the implement sensor detecting that the implement is coupled to the implement interface.

2. The lift device of claim 1, further comprising a second implement sensor coupled to the implement interface, the second implement sensor to detect a type of the implement coupled to the implement interface, and wherein the controller is configured to adjust operation of the lift device in response to the second implement sensor.

3. The lift device of claim 1, wherein the controller is configured to adjust operation of the lift device by adjusting a load threshold for the lift assembly.

4. The lift device of claim 1, further comprising one or more implement status sensors coupled to the implement interface, the one or more implement status sensors configured to measure properties of the implement, and wherein the controller is configured to adjust operation of the lift device in response to the one or more implement status sensors.

5. The lift device of claim 4, wherein the one or more implement status sensors include at least one of a load sensor, a weight sensor, a strain gauge, an orientation sensor, or an extension sensor.

6. The lift device of claim 4, wherein the properties include at least one of orientation, load, or weight.

7. The lift device of claim 1, wherein the implement comprises a user interface, the user interface communicatively coupled to the controller upon coupling of the implement to the implement interface.

8. The lift device of claim 1, wherein the controller further comprises a communications interface, the communications interface communicably coupled to a remote server that comprises an operating profile, the operating profile including operating requirements of the implement.

9. The lift device of claim 8, wherein the controller is configured to receive the operating profile of the implement and adjust operation of the lift device based on the operating profile.

10. The lift device of claim 9, wherein the operating profile defines a load threshold for the lift assembly.

11. The lift device of claim 1, wherein the implement interface comprises an alignment member configured to limit movement of the implement relative to the implement interface.

12. The lift device of claim 1, wherein the implement interface comprises a lock assembly configured to selectively fixedly couple the implement to the implement interface.

13. The lift device of claim 12, wherein the lock assembly is configured to automatically couple the implement to the implement interface.

14. The lift device of claim 1, wherein the implement interface is configured to be removably coupled to more than one implement at once.

15. The lift device of claim 1, further comprising a second implement interface configured to be removably coupled to a second implement.

16. The lift device of claim 1, wherein the implement interface further comprises connectors, the connectors to supply power and data transmission between the lift device and the implement.

17. The lift device of claim 1, wherein the implement includes at least one of a platform, a material lift, a minidumper, or a forklift.

18. An implement interface for a lift device, the implement interface comprising:
an implement sensor configured to detect whether an implement is coupled to the implement interface or a type of the implement coupled to the implement interface;
an alignment member configured to limit movement of the implement relative to the implement interface; and
a lock assembly configured to selectively fixedly couple the implement to the implement interface.

19. The implement interface of claim 18, wherein the implement interface further comprises a camera to assist in detecting the implement.

20. A lift device comprising:
a chassis;
an implement interface configured to be removably coupled to an implement;
a lift assembly coupled to the chassis and the implement interface and configured to raise the implement interface relative to the chassis;
a plurality of implement sensors coupled to the implement interface and configured to detect at least one of whether the implement is coupled to the implement interface or a type of implement coupled to the implement interface; and
a controller operatively coupled to the lift assembly and the plurality of implement sensors and configured to a load threshold of the lift device in response to the plurality of implement sensors.
